(19) United States
(12) Patent Application Publication
(10) Pub. No.: US 2014/0288074 A1
(43) Pub. Date: Sep. 25, 2014

(54) FUNGICIDAL PYRAZOLES

(71) Applicant: E I DU PONT DE NEMOURS AND COMPANY, Wilmington, DE (US)

(72) Inventors: ANDREW EDMUND TAGGI, Newark, DE (US); Jeffrey Keith Long, Wilmington, DE (US); Moumita Kar, Hyderabad (IN)

(73) Assignee: E I DU PONT DE NEMOURS AND COMPANY, Wilmington, DE (US)

(21) Appl. No.: 14/221,326

(22) Filed: Mar. 21, 2014

Related U.S. Application Data
(60) Provisional application No. 61/804,233, filed on Mar. 22, 2013.

(51) Int. Cl. A01N 43/56; A01N 43/84

(52) U.S. Cl. CPC A01N 43/56; A01N 43/84
USPC 514/236.5; 548/371.4; 514/407; 548/366.1; 514/406; 548/376.1; 548/365.7; 544/140

(57) ABSTRACT

Disclosed are compounds of Formula 1, including all stereoisomers, N-oxides, and salts thereof, fungicides:

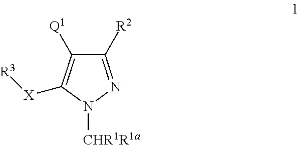

wherein
Q¹, R¹, R^{1a}, R², R³ and X are as defined in the disclosure.

Also disclosed are compositions containing the compounds of Formula 1 and methods for controlling plant disease caused by a fungal pathogen comprising applying an effective amount of a compound or a composition of the invention.

### FIELD OF THE INVENTION

This invention relates to certain fungicidal pyrazoles, their N-oxides, salts and compositions, and methods of their use as fungicides.

### BACKGROUND OF THE INVENTION

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new compounds which are more effective, less costly, less toxic, environmentally safer or have different sites of action.

PCT Patent Publications WO 2009/137538, WO 2009/137651, WO 2010/101973, WO 2012/023143 and WO 2012/031061 disclose pyrazole derivatives and their use as fungicides.

### SUMMARY OF THE INVENTION

This invention is directed to compounds of Formula 1 (including all stereoisomers), N-oxides, and salts thereof, agricultural compositions containing them and their use as fungicides:

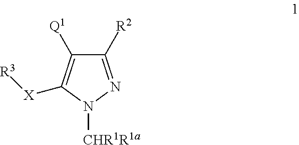

wherein
Q¹ is C₃-C₆ cycloalkyl or C₃-C₆ cycloalkenyl, wherein up to 3 carbon atoms are selected from C(═O), each optionally substituted with up to 2 substituents independently selected from halogen, cyano, nitro, hydroxy, C₁-C₃ alkyl, C₁-C₃ haloalkyl, C₁-C₃ alkoxy and C₁-C₃ haloalkoxy; or a phenyl ring or a naphthalenyl ring system, each ring or ring system optionally substituted with up to 5 substituents independently selected from R⁴; or a 5- to 6-membered fully unsaturated heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon ring members are independently selected from C(═O) and C(═S), and the sulfur atom ring members are independently selected from S(═O)ᵤ(═NR²⁸)ᵥ, each ring or ring system optionally substituted with up to 5 substituents independently selected from R⁴ on carbon atom ring members and selected from cyano, C₁-C₃ alkyl, C₂-C₃ alkenyl, C₂-C₃ alkynyl, cyclopropyl, C₂-C₃ alkoxyalkyl, C₁-C₃ alkoxy, C₂-C₃ alkylcarbonyl, C₂-C₃ alkoxycarbonyl, C₂-C₃ alkylaminoalkyl and C₃-C₄ dialkylaminoalkyl on nitrogen atom ring members;
X is O, S(═O)ₘ, NR⁵, CR^{6a}OR^{6b}, CR^{6a}SR^{6b} or CR^{6a}NR^{6b}R^{6c};
R¹ is H, cyano, halogen, C₁-C₆ alkyl, C₁-C₆ haloalkyl, C₂-C₆ alkenyl, C₂-C₆ alkynyl, C₃-C₆ cycloalkyl, C₂-C₆ alkoxyalkyl, C₁-C₆ alkoxy, C₁-C₆ haloalkoxy, C(═O)OR⁷ or C(═O)NR⁸R⁹;
R^{1a} is H; or
R^{1a} and R¹ are taken together with the carbon atom to which they are attached to form a cyclopropyl ring optionally substituted with up to 2 substituents independently selected from halogen and methyl;
R² is H, cyano, halogen, C₁-C₃ alkyl, C₁-C₃ haloalkyl, C₂-C₃ alkenyl, C₂-C₃ haloalkenyl, C₂-C₃ alkynyl, C₁-C₃ cyanoalkyl, C₁-C₃ hydroxyalkyl, C₁-C₃ alkoxy or C₁-C₃ alkylthio; or cyclopropyl optionally substituted with up to 2 substituents independently selected from halogen and methyl;
R³ is C₁-C₈ alkyl, C₁-C₈ haloalkyl, C₂-C₈ alkenyl, C₂-C₈ haloalkenyl, C₂-C₈ alkynyl, C₂-C₈ haloalkynyl, C₂-C₈ cyanoalkyl, C₁-C₈ hydroxyalkyl, C₁-C₈ nitroalkyl, C₃-C₈ cycloalkyl, C₃-C₈ halocycloalkyl, C₃-C₈ cycloalkenyl, C₄-C₁₀ alkylcycloalkyl, C₄-C₁₀ cycloalkylalkyl, C₄-C₁₀ halocycloalkylalkyl, C₅-C₁₀ alkylcycloalkylalkyl, C₂-C₈ alkoxyalkyl, C₂-C₈ haloalkoxyalkyl, C₄-C₁₀ cycloalkoxyalkyl, C₃-C₈ alkoxyalkoxyalkyl, C₂-C₈ alkylthioalkyl, C₂-C₈ haloalkylthioalkyl, C₂-C₈ alkylsulfinylalkyl, C₂-C₈ haloalkylsulfinylalkyl, C₂-C₈ alkylsulfonylalkyl, C₂-C₈ haloalkylsulfonylalkyl, C₃-C₈ alkylcarbonylalkyl, C₃-C₈ haloalkylcarbonylalkyl, C₃-C₈ alkoxycarbonylalkyl, C₃-C₈ haloalkoxycarbonylalkyl, C₂-C₈ alkylaminoalkyl, C₂-C₈ haloalkylaminoalkyl, C₃-C₈ dialkylaminoalkyl, C₃-C₈ alkylaminocarbonylalkyl, C₄-C₁₀ dialkylaminocarbonylalkyl, C₄-C₁₀ cycloalkylaminoalkyl or C(R^{10a}R^{10b})ₙW¹;
W¹ is a 5- to 6-membered fully unsaturated heterocyclic ring containing ring members selected from carbon atoms and 1 to 4 heteroatoms independently selected from up to 2 O, up to 2 S and up to 4 N atoms, the ring optionally substituted with up to 3 substituents independently selected from halogen, cyano, C₁-C₂ alkyl, C₁-C₂ haloalkyl, C₁-C₂ alkoxy and C₁-C₂ haloalkoxy on carbon atom ring members and cyano, C₁-C₂ alkyl and C₁-C₂ alkoxy on nitrogen atom ring members; or a 3- to 7-membered fully saturated ring containing ring members selected from carbon atoms and up to 4 heteroatoms independently selected from up to 2 O, up to 2 S and up to 4 N atoms, wherein up to 3 carbon atom ring members are independently selected from C(═O) and C(═S), the ring optionally substituted with up to 3 substituents independently selected from halogen, cyano, C₁-C₄ alkyl, C₁-C₄ haloalkyl, C₁-C₄ alkoxy and C₁-C₄ haloalkoxy on carbon atom ring members and cyano, C₁-C₄ alkyl and C₁-C₄ alkoxy on nitrogen atom ring members;
each R⁴ is independently amino, cyano, halogen, hydroxy, nitro, C₁-C₈ alkyl, C₁-C₈ haloalkyl, C₂-C₈ alkenyl, C₂-C₈ haloalkenyl, C₂-C₈ alkynyl, C₂-C₈ haloalkynyl, C₁-C₈ nitroalkyl, C₂-C₈ nitroalkenyl, C₃-C₈ cycloalkyl, C₃-C₈ halocycloalkyl, C₄-C₈ cycloalkylalkyl, C₅-C₈ cycloalkylalkenyl, C₅-C₁₂ cycloalkylalkynyl, C₄-C₈ alkylcycloalkyl, C₁-C₈ alkylthio, C₁-C₈ haloalkylthio, C₁-C₈ alkylsulfinyl, C₁-C₈ haloalkylsulfinyl, C₁-C₈ alkylsulfonyl, C₁-C₈ haloalkylsulfonyl, C₁-C₈ alkoxy, C₁-C₈ haloalkoxy, C₃-C₈ cycloalkoxy, C₁-C₈ alkylsulfonyloxy, C₁-C₄ haloalkylsulfonyloxy, C₂-C₈ alkenyloxy, C₂-C₈ haloalkenyloxy, C₂-C₈ alkynyloxy, C₃-C₈ haloalkynyloxy, C₄-C₈ cycloalkylalkoxy, C₃-C₁₂ halocycloalkoxy, C₅-C₁₂ cycloalkylalkenyloxy, C₅-C₁₂ cycloalkylalkynyloxy, C₆-C₁₂ cycloalkylcycloalkyl, C₂-C₈ alkylcarbonyloxy, C₂-C₈ alkylcarbonyl, C₁-C₈ alkylamino, C₂-C₈ dialkylamino, C₂-C₈ alkylcarbonylamino, C₃-C₁₂ trialkylsilyl, C₄-C₁₂ trialkylsilylalkoxy, C₄-C₁₂, trialkylsilylalkyl, —CH(═O), NHCH(═O), SF₅, SC≡N, —C(═S)NR^{11a}R^{11b}, —CR^{12a}═NOR^{12b}, —CR^{12c}═NNR^{11a}R^{11b}, —NR^{11a}N═CR^{13a}R^{13b}; —ON═CR^{13a}R^{13b} or —U—V-T; or
each R⁴ is independently -A(CR^{14a}R^{14b})ₙW²;
each A is independently O or a direct bond;
each W² is independently a 3- to 7-membered heterocyclic ring containing ring members selected from carbon atoms and 1 to 4 heteroatoms independently selected from up to 2 O, up to 2 S and up to 4 N atoms, wherein up to 3 carbon atom ring members are independently selected from C(═O) and C(═S), the ring optionally substituted with up to 3 substituents independently selected from R¹⁵ on carbon atom ring members and R¹⁶ on nitrogen atom ring members;
R⁵ is H, amino, C₂-C₆ alkenyl, C₃-C₆ alkynyl, C₃-C₆ cycloalkyl, —CH(═O), S(═O)ₘR¹⁷, S(═O)₂OM, C(═Z)R¹⁸ or OR¹⁹; or C₁-C₆ alkyl or C₁-C₆ haloalkyl, each optionally substituted with up to 2 substituents independently selected from R^{20a}; or
R³ and R⁵ are taken together with the nitrogen atom to which they are attached to form a 4- to 8-membered fully saturated heterocyclic ring containing ring members, in addition to the connecting nitrogen atom, selected from carbon atoms and up to 4 heteroatoms independently selected from up to 2 O, up to 2 S and up to 4 N atoms, wherein up to 3 carbon atom ring members are independently selected from C(═O) and C(═S), and the sulfur atom ring members are independently selected from S(═O)ᵤ(═NR²⁸)ᵥ, the ring optionally substituted with up to 4 substituents independently selected from halogen, cyano, C₁-C₃ alkyl, C₁-C₃ haloalkyl, C₁-C₃ alkoxy and C₁-C₃ haloalkoxy on carbon atom ring members and cyano, C₁-C₃ alkyl and C₁-C₃ alkoxy on nitrogen atom ring members;
R^{6a} is H or C₁-C₆ alkyl;
R^{6b} is H, —CH(═O), C₁-C₆ alkyl, C₂-C₆ alkenyl, C₃-C₆ alkynyl, C₁-C₆ haloalkyl, C₃-C₆ cycloalkyl, C₃-C₆ halocycloalkyl, C₂-C₆ alkoxyalkyl, C₂-C₆ cyanoalkyl, C₂-C₆ alkylcarbonyl, C₂-C₆ alkoxycarbonyl, C₂-C₆ (alkylthio)carbonyl, C₄-C₈ cycloalkylcarbonyl, C₄-C₈ cycloalkoxycarbonyl, C₄-C₈ (cycloalkylthio)carbonyl, C₂-C₆ alkoxy(thiocarbonyl) or C₄-C₈ cycloalkoxy(thiocarbonyl);
R^{6c} is H or C₁-C₄ alkyl;
R⁷ is H, C₁-C₆ alkyl or C₁-C₆ haloalkyl;
R⁸ and R⁹ are each independently H, C₁-C₆ alkyl, C₁-C₆ haloalkyl, C₃-C₈ cycloalkyl, C₄-C₈ cycloalkylalkyl or C₄-C₈ alkylcycloalkyl; or
R⁸ and R⁹ are taken together with the nitrogen atom to which they are attached to form a 4- to 7-membered nonaromatic heterocyclic ring containing ring members, in addition to the connecting ring nitrogen atom, selected from carbon atoms and up to 1 ring member selected from O, S(═O)ₘ and NR²¹;
R^{10a} is H, cyano or C₁-C₄ alkyl;
R^{10b} is H or C₁-C₄ alkyl;
each R^{11a} and R^{11b} is independently H or C₁-C₄ alkyl;
each R^{12a} is independently H, C₁-C₃ alkyl or C₁-C₃ haloalkyl;
each R^{12b} and R^{12c} is independently H, C₁-C₃ alkyl, C₁-C₃ haloalkyl, C₂-C₄ alkenyl, C₂-C₄ haloalkenyl, C₂-C₄ alkynyl, C₃-C₅ cycloalkyl, C₃-C₅ halocycloalkyl or C₄-C₈ cycloalkylalkyl;
each R^{13a} and R^{13b} is independently H, C₁-C₃ alkyl or C₁-C₃ haloalkyl;
each R^{14a} is independently H, halogen, cyano or C₁-C₄ alkyl;
each R^{14b} is independently H or C₁-C₄ alkyl;
each R¹⁵ is independently halogen, cyano, C₁-C₂ alkyl, C₁-C₂ haloalkyl, C₁-C₂ alkoxy or C₁-C₂ haloalkoxy;
each R¹⁶ is independently cyano, C₁-C₂ alkyl or C₁-C₂ alkoxy;
R¹⁷ is C₁-C₆ alkyl or C₁-C₆ haloalkyl;
R¹⁸ is C₁-C₆ alkyl, C₂-C₆ alkoxyalkyl, C₂-C₆ alkylaminoalkyl, C₂-C₆ dialkylaminoalkyl, C₁-C₆ alkoxy, C₁-C₆ alkylthio or C₂-C₆ alkylthioalkyl;
R¹⁹ is H, —CH(═O), C₃-C₆ cycloalkyl, S(═O)₂OM or C(═Z)R²²; or C₁-C₆ alkyl or C₁-C₆ haloalkyl, each optionally substituted with up to 2 substituents independently selected from R^{20b};
each R^{20a} and R^{20b} is independently cyano, C₃-C₆ cycloalkyl, C₁-C₆ alkoxy, C₁-C₆ haloalkoxy, C₁-C₆ alkylthio, C₁-C₆ alkylsulfinyl or C₁-C₆ alkylsulfonyl;
R²¹ is H, C₁-C₃ alkyl or C₂-C₃ haloalkyl;
R²² is C₁-C₆ alkyl, C₂-C₆ alkoxyalkyl, C₂-C₆ alkylaminoalkyl, C₂-C₆ dialkylaminoalkyl, C₁-C₆ alkoxy, C₁-C₆ alkylthio or C₂-C₆ alkylthioalkyl;
each U is independently O, S(═O)ₘ, NR²³ or a direct bond;
each V is independently C₁-C₆ alkylene, C₂-C₆ alkenylene, C₃-C₆ alkynylene, C₃-C₆ cycloalkylene or C₃-C₆ cycloalkenylene, wherein up to 3 carbon atoms are independently selected from C(═O), each optionally substituted with up to 5 substituents independently selected from halogen, cyano, nitro, hydroxy, C₁-C₆ alkyl, C₁-C₆ haloalkyl, C₁-C₆ alkoxy and C₁-C₆ haloalkoxy;
each T is independently cyano, NR^{24a}R^{24b}, OR²⁵ or S(═O)ₘR²⁶;
each R²³ is independently H, C₁-C₆ alkyl, C₁-C₆ haloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R^{24a} and R^{24b} is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl); or
a pair of R^{24a} and R^{24b} attached to the same nitrogen atom are taken together with the nitrogen atom to form a 3- to 6-membered heterocyclic ring, the ring optionally substituted with up to 5 substituents independently selected from R²⁷;
each R²⁵ and R²⁶ is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₄-C₈ cycloalkylcarbonyl, C₄-C₈ cycloalkoxycarbonyl, C₄-C₈ (cycloalkylthio)carbonyl, C₂-C₆ alkoxy(thiocarbonyl) or C₄-C₈ cycloalkoxy(thiocarbonyl);
each R²⁷ is independently halogen, C₁-C₆ alkyl, C₁-C₆ haloalkyl or C₁-C₆ alkoxy;
each R²⁸ is independently H, cyano, C₁-C₃ alkyl or C₁-C₃ haloalkyl;
Z is O or S;
M is K, Na or Li;
each m is independently 0, 1 or 2;
each n is 0, 1, 2 or 3; and
each u and v are independently 0, 1 or 2 in each instance of S(═O)ᵤ(═NR²⁸)ᵥ;
   provided that:
(a) the sum of u and v is 0, 1 or 2; and
(b) when n is 1, 2, or 3, then W¹ is linked through a carbon atom to the remainder of Formula 1.

More particularly, this invention pertains to a compound of Formula 1 (including all stereoisomers), an N-oxide or a salt thereof.

This invention also relates to a fungicidal composition comprising (a) a compound of the invention (i.e. in a fungicidally effective amount); and (b) at least one additional component selected from the group consisting of surfactants, solid diluents and liquid diluents.

This invention also relates to a fungicidal composition comprising (a) a compound of the invention; and (b) at least one other fungicide (e.g., at least one other fungicide having a different site of action).

This invention further relates to a method for controlling plant diseases caused by fungal plant pathogens comprising applying to the plant or portion thereof, or to the plant seed, a fungicidally effective amount of a compound of the invention (e.g., as a composition described herein).

### DETAILS OF THE INVENTION

As used herein, the terms “comprises,” “comprising,” “includes,” “including,” “has,” “having,” “contains,” “containing,” “characterized by,” or any other variation thereof, are intended to cover a non-exclusive inclusion, subject to any limitation explicitly indicated. For example, a composition, mixture, process, method, article, or apparatus that comprises a list of elements is not necessarily limited to only those elements but may include other elements not expressly listed or inherent to such composition, mixture, process, method, article, or apparatus.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As referred to in the present disclosure and claims, “plant” includes members of Kingdom Plantae, particularly seed plants (Spermatopsida), at all life stages, including young plants (e.g., germinating seeds developing into seedlings) and mature, reproductive stages (e.g., plants producing flowers and seeds). Portions of plants include geotropic members typically growing beneath the surface of the growing medium (e.g., soil), such as roots, tubers, bulbs and corms, and also members growing above the growing medium, such as foliage (including stems and leaves), flowers, fruits and seeds.

As referred to herein, the term “seedling”, used either alone or in a combination of words means a young plant developing from the embryo of a seed.

As referred to herein, the term “broadleaf” used either alone or in words such as “broadleaf crop” means dicot or dicotyledon, a term used to describe a group of angiosperms characterized by embryos having two cotyledons.

As used herein, the term “alkylating agent” refers to a chemical compound in which a carbon-containing radical is bound through a carbon atom to leaving group such as halide or sulfonate, which is displaceable by bonding of a nucleophile to said carbon atom. Unless otherwise indicated, the term “alkylating” does not limit the carbon-containing radical to alkyl; the carbon-containing radicals in alkylating agents include the variety of carbon-bound substituent radicals specified for R³ and R⁵.

Generally when a molecular fragment (i.e. radical) is denoted by a series of atom symbols (e.g., C, H, N, O, S) the implicit point or points of attachment will be easily recognized by those skilled in the art. In some instances herein, particularly when alternative points of attachment are possible, the point or points of attachment may be explicitly indicated by a hyphen (“-”).

In the above recitations, the term “alkyl”, used either alone or in compound words such as “alkylthio” or “haloalkyl” includes straight-chain or branched alkyl such as methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkylene” denotes a straight-chain or branched alkanediyl. Examples of “alkylene” include CH₂, CH₂CH₂, CH(CH₃), CH₂CH₂CH₂, CH₂CH(CH₃), and the different butylene, pentylene or hexylene isomers. “Alkenylene” denotes a straight-chain or branched alkenediyl containing one olefinic bond. Examples of “alkenylene” include CH═CH, CH₂CH═CH and CH═C(CH₃). “Alkynylene” denotes a straight-chain or branched alkanediyl containing one triple bond. Examples of “alkynylene” include CH₂C≡C, C≡CCH₂, and the different butynylene, pentenylene or hexynylene isomers.

“Alkylamino” includes an NH radical substituted with straight-chain or branched alkyl. Examples of “alkylamino” include CH₃CH₂NH, CH₃CH₂CH₂NH and (CH₃)₂CHNH. Examples of “dialkylamino” include (CH₃)₂N, (CH₃CH₂)₂N and CH₃CH₂(CH₃)N. “Alkylaminoalkyl” denotes alkylamino substitution on alkyl. Examples of “alkylaminoalkyl” include CH₃NHCH₂, CH₃NHCH₂CH₂ and CH₃CH₂NHCH₂. Examples of “dialkylaminoalkyl” include (CH₃)₂NCH₂, CH₃CH₂(CH₃)NCH₂ and (CH₃)₂NCH₂CH₂.

“Alkoxy” includes, for example, methoxy, ethoxy, n-propyloxy, i-propyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkenyloxy” includes straight-chain or branched alkenyl attached to and linked through an oxygen atom. Examples of “alkenyloxy” include H₂C═CHCH₂O, (CH₃)₂C═CHCH₂O, CH₃CH═CHCH₂O, CH₃CH═C(CH₃)CH₂O and CH₂═CHCH₂CH₂O. “Alkynyloxy” includes straight-chain or branched alkynyl attached to and linked through an oxygen atom. Examples of “alkynyloxy” include HC≡CCH₂O, CH₃C≡CCH₂O and CH₃C≡CCH₂CH₂O. The term “alkylsulfonyloxy” denotes alkylsulfonyl attached to and linked through an oxygen atom. Examples of “alkylsulfonyloxy” include CH₃S(═O)₂O, CH₃CH₂S(═O)₂O, CH₃CH₂CH₂S(═O)₂O and (CH₃)₂CHS(═O)₂O.

“Alkylthio” includes branched or straight-chain alkylthio moieties such as methylthio, ethylthio, and the different propylthio isomers. “Alkylsulfinyl” includes both enantiomers of an alkylsulfinyl group. Examples of “alkylsulfinyl” include CH₃S(═O), CH₃CH₂S(═O), CH₃CH₂CH₂S(═O) and (CH₃)₂CHS(═O). Examples of “alkylsulfonyl” include CH₃S(═O)₂, CH₃CH₂S(═O)₂, CH₃CH₂CH₂S(═O)₂ and (CH₃)₂CHS(═O)₂. “Alkylthioalkyl” denotes alkylthio substitution on alkyl. Examples of “alkylthioalkyl” include CH₃SCH₂, CH₃SCH₂CH₂, CH₃CH₂ SCH₂, CH₃CH₂ CH₂CH₂ S CH₂ and CH₃CH₂ SCH₂CH₂; “alkylsulfinylalkyl” and “alkylsulfonylalkyl” include the corresponding sulfoxides and sulfones, respectively.

The term “cycloalkyl” denotes a saturated carbocyclic ring consisting of between 3 to 8 carbon atoms linked to one another by single bonds. Examples of “cycloalkyl” include cyclopropyl, cyclobutyl, cyclopentyl and cyclohexyl. “Cycloalkenyl” includes groups such as cyclopentenyl and cyclohexenyl as well as groups with more than one double bond such as 1,3- and 1,4-cyclohexadienyl. The term “cycloalkylalkyl” denotes cycloalkyl substitution on an alkyl group. Examples of “cycloalkylalkyl” include cyclopropylmethyl, cyclopentylethyl, and other cycloalkyl moieties bonded to straight-chain or branched alkyl groups. “Alkylcycloalkyl” denotes alkyl substitution on a cycloalkyl moiety. Examples include 4-methylcyclohexyl and 3-ethylcyclopentyl. “Alkylcycloalkylalkyl” denotes an alkyl group substituted with alkylcycloalkyl. Examples of “alkylcycloalkylalkyl” include 1-, 2-, 3- or 4-methyl or -ethyl cyclohexylmethyl. The term “cycloalkylcycloalkyl” denotes cycloalkyl substitution on another cycloalkyl ring, wherein each cycloalkyl ring independently has from 3 to 6 carbon atom ring members. Examples of cycloalkylcycloalkyl include cyclopropylcyclopropyl (such as 1,1′-bicyclopropyl-1-yl, 1,1′-bicyclopropyl-2-yl), cyclohexylcyclopentyl (such as 4-cyclopentylcyclohexyl) and cyclohexylcyclohexyl (such as 1,1′-bicyclohexyl-1-yl), and the different cis- and trans-cycloalkylcycloalkyl isomers, (such as (1R,2S)-1,1′-bicyclopropyl-2-yl and (1R,2R)-1,1′-bicyclopropyl-2-yl). The term “cycloalkoxy” denotes cycloalkyl attached to and linked through an oxygen atom such as cyclopentyloxy and cyclohexyloxy. “Cycloalkylalkoxy” denotes cycloalkyl substitution on an alkoxy group. Examples of “cycloalkylalkoxy” include cyclopropylmethoxy, cyclopentylethoxy, and other cycloalkyl moieties bonded to straight-chain or branched alkoxy groups. “Cycloalkylcarbonyl” denotes cycloalkyl bonded to a C(═O) group including, for example, cyclopropylcarbonyl and cyclopentylcarbonyl. The term “cycloalkoxycarbonyl” means cycloalkoxy bonded to a C(═O) group, for example, cyclopropyloxycarbonyl and cyclopentyloxycarbonyl. The term “cycloalkylene” denotes a cycloalkanediyl ring. Examples of “cycloalkylene” include cyclopropylene, cyclobutylene, cyclopentylene and cyclohexylene. The term “cycloalkenylene” denotes a cycloalkenediyl ring containing one olefinic bond. Examples of “cycloalkenylene” include cyclopropenylene and cyclopentenylene.

“Cyanoalkyl” denotes an alkyl group substituted with one cyano group. Examples of “cyanoalkyl” include NCCH₂, NCCH₂CH₂ and CH₃CH(CN)CH₂. “Hydroxyalkyl” denotes an alkyl group substituted with one hydroxy group. Examples of “hydroxyalkyl” include HOCH₂, HOCH₂CH₂ and CH₃CH₂(OH)CH. “Nitroalkyl” denotes an alkyl group substituted with one nitro group. Examples of “nitroalkyl” include NO₂CH₂ and NO₂CH₂CH₂.

“Alkylcarbonyl” denotes a straight-chain or branched alkyl group bonded to a C(═O) moiety. Examples of “alkylcarbonyl” include CH₃C(═O), CH₃CH₂CH₂C(═O) and (CH₃)₂CHC(═O). Examples of “alkoxycarbonyl” include CH₃C(═O), CH₃CH₂OC(═O), CH₃CH₂CH₂C(═O), (CH₃)₂CHOC(═O) and the different pentoxy- or hexoxycarbonyl isomers. The term “alkylcarbonyloxy” denotes straight-chain or branched alkyl bonded to a C(═O)O moiety. Examples of “alkylcarbonyloxy” include CH₃CH₂C(═O)O and (CH₃)₂CHC(═O)O. “(Alkylthio)carbonyl” denotes a straight-chain or branched alkylthio group bonded to a C(═O) moiety. Examples of “(alkylthio)carbonyl” include CH₃SC(═O), CH₃CH₂CH₂SC(═O) and (CH₃)₂CHSC(═O). “Alkoxy(thiocarbonyl)” denotes a straight-chain or branched alkoxy group bonded to a C(═S) moiety. Examples of “alkoxy(thiocarbonyl)” include CH₃C(═S), CH₃CH₂CH₂C(═S) and (CH₃)₂CHOC(═S). The term “alkylcarbonylamino” denotes alkyl bonded to a C(═O)NH moiety. Examples of “alkylcarbonylamino” include CH₃C(═O)NH and CH₃CH₂C(═O)NH.

“Trialkylsilyl” includes 3 branched and/or straight-chain alkyl radicals attached to and linked through a silicon atom, such as trimethylsilyl, triethylsilyl and tert-butyldimethylsilyl.

The term “halogen”, either alone or in compound words such as “halomethyl”, “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkoxy”, “haloalkylthio”, “haloalkylsulfinyl” “haloalkylsulfonyl” and “halocycloalkyl” are defined analogously to the term “haloalkyl”. Examples of “haloalkenyl” include Cl₂C═CHCH₂ and CF₃CH₂═CH. Examples of “haloalkoxy” include CF₃O, CCl₃CH₂O, F₂CHCH₂CH₂O and CF₃CH₂O. Examples of “haloalkylthio” include CCl₃S, CF₃S, CCl₃CH₂S and ClCH₂CH₂CH₂S. Examples of “haloalkylsulfinyl” include CF₃S(═O), CCl₃S(═O), CF₃CH₂S(═O) and CF₃CF₂S(═O). Examples of “haloalkylsulfonyl” include CF₃S(═O)₂, CCl₃S(═O)₂, CF₃CH₂S(═O)₂ and CF₃CF₂S(═O)₂. Examples of “halocycloalkyl” include chlorocyclopropyl, fluorocyclobutyl and chlorocyclohexyl.

The total number of carbon atoms in a substituent group is indicated by the “Cᵢ-Cⱼ” prefix where i and j are numbers from 1 to 12. For example, C₁-C₃ alkylsulfonyl designates methylsulfonyl through propylsulfonyl; C₂ alkoxyalkyl designates CH₃OCH₂; C₃ alkoxyalkyl designates, for example, CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂.

The term “unsubstituted” in connection with a group such as a ring means the group does not have any substituents other than its one or more attachments to the remainder of Formula 1. The term “optionally substituted” means that the number of substituents can be zero. Unless otherwise indicated, optionally substituted groups may be substituted with as many optional substituents as can be accommodated by replacing a hydrogen atom with a non-hydrogen substituent on any available carbon or nitrogen atom. Commonly, the number of optional substituents (when present) range from 1 to 3. As used herein, the term “optionally substituted” is used interchangeably with the phrase “substituted or unsubstituted” or with the term “(un)substituted.”

The number of optional substituents may be restricted by an expressed limitation. For example, the phrase “optionally substituted with up to 3 substituents independently selected from R⁴ on carbon atom ring members” means that 0, 1, 2 or 3 substituents can be present (if the number of potential connection points allows). Similarly, the phrase “optionally substituted with up to 5 substituents independently selected from R⁴” means that 0, 1, 2, 3, 4 or 5 substituents can be present if the number of available connection points allows.

When a group contains a substituent which can be hydrogen, for example R¹ or R^{1a}, then when this substituent is taken as hydrogen, it is recognized that this is equivalent to said group being unsubstituted. When one or more positions on a group are said to be “not substituted” or “unsubstituted”, then hydrogen atoms are attached to take up any free valency.

Unless otherwise indicated, a “ring” or “ring system” as a component of Formula 1 (e.g., substituent Q¹) is carbocyclic or heterocyclic. The term “ring system” denotes two or more fused rings. The terms “bicyclic ring system” and “fused bicyclic ring system” denote a ring system consisting of two fused rings, in which either ring can be saturated, partially unsaturated, or fully unsaturated unless otherwise indicated. The term “ring member” refers to an atom or other moiety (e.g., C(═O), C(═S), S(═O) or S(═O)₂) forming the backbone of a ring or ring system.

The terms “carbocyclic ring”, “carbocycle” or “carbocyclic ring system” denote a ring or ring system wherein the atoms forming the ring backbone are selected only from carbon. Unless otherwise indicated, a carbocyclic ring can be a saturated, partially unsaturated, or fully unsaturated ring. When a fully unsaturated carbocyclic ring satisfies Hückel's rule, then said ring is also called an “aromatic ring”. “Saturated carbocyclic” refers to a ring having a backbone consisting of carbon atoms linked to one another by single bonds; unless otherwise specified, the remaining carbon valences are occupied by hydrogen atoms.

The terms “heterocyclic ring”, “heterocycle” or “heterocyclic ring system” denote a ring or ring system in which at least one atom forming the ring backbone is not carbon, e.g., nitrogen, oxygen or sulfur. Typically a heterocyclic ring contains no more than 4 nitrogens, no more than 2 oxygens and no more than 2 sulfurs. Unless otherwise indicated, a heterocyclic ring can be a saturated, partially unsaturated, or fully unsaturated ring. When a fully unsaturated heterocyclic ring satisfies Hückel's rule, then said ring is also called a “heteroaromatic ring” or “aromatic heterocyclic ring”. Unless otherwise indicated, heterocyclic rings and ring systems can be attached through any available carbon or nitrogen by replacement of a hydrogen on said carbon or nitrogen.

“Aromatic” indicates that each of the ring atoms is essentially in the same plane and has a p-orbital perpendicular to the ring plane, and that (4n+2) π electrons, where n is a positive integer, are associated with the ring to comply with Hückel's rule. The term “aromatic ring system” denotes a carbocyclic or heterocyclic ring system in which at least one ring of the ring system is aromatic. The term “aromatic carbocyclic ring system” denotes a carbocyclic ring system in which at least one ring of the ring system is aromatic. The term “aromatic heterocyclic ring system” denotes a heterocyclic ring system in which at least one ring of the ring system is aromatic. The term “nonaromatic ring system” denotes a carbocyclic or heterocyclic ring system that may be fully saturated, as well as partially or fully unsaturated, provided that none of the rings in the ring system are aromatic.

In the context of the present invention when an instance of Q¹ comprises a phenyl or 6-membered heterocyclic ring (e.g., pyridinyl), the ortho, meta and para positions of each ring are relative to the connection of the ring to the remainder of Formula 1.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, individual stereoisomers or as an optically active form.

One skilled in the art recognizes that because in the environment and under physiological conditions salts of chemical compounds are in equilibrium with their corresponding nonsalt forms, salts share the biological utility of the nonsalt forms. Thus a wide variety of salts of the compounds of Formula 1 are useful for control of plant diseases caused by fungal plant pathogens (i.e. are agriculturally suitable). The salts of the compounds of Formula 1 include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

Compounds selected from Formula 1, stereoisomers, N-oxides, and salts thereof, typically exist in more than one form, therefore Formula 1 includes all crystalline and non-crystalline forms of the compounds that Formula 1 represents. Non-crystalline forms include embodiments which are solids such as waxes and gums as well as embodiments which are liquids such as solutions and melts. Crystalline forms include embodiments which represent essentially a single crystal type and embodiments which represent a mixture of polymorphs (i.e. different crystalline types). The term “polymorph” refers to a particular crystalline form of a chemical compound that can crystallize in different crystalline forms, these forms having different arrangements and/or conformations of the molecules in the crystal lattice. Although polymorphs can have the same chemical composition, they can also differ in composition due to the presence or absence of co-crystallized water or other molecules, which can be weakly or strongly bound in the lattice. Polymorphs can differ in such chemical, physical and biological properties as crystal shape, density, hardness, color, chemical stability, melting point, hygroscopicity, suspensibility, dissolution rate and biological availability. One skilled in the art will appreciate that a polymorph of a compound represented by Formula 1 can exhibit beneficial effects (e.g., suitability for preparation of useful formulations, improved biological performance) relative to another polymorph or a mixture of polymorphs of the same compound represented by Formula 1. Preparation and isolation of a particular polymorph of a compound represented by Formula 1 can be achieved by methods known to those skilled in the art including, for example, crystallization using selected solvents and temperatures.

Embodiments of the present invention as described in the Summary of the Invention include those described below. In the following Embodiments, Formula 1 includes stereoisomers, N-oxides and salts thereof, and reference to “a compound of Formula 1” includes the definitions of substituents specified in the Summary of the Invention unless further defined in the Embodiments.

### Embodiment 1

A compound of Formula 1 wherein Q¹ is a phenyl ring substituted with 1 to 3 substituents independently selected from R⁴; or a pyridinyl, pyrimidinyl, pyrazinyl or pyridazinyl, each optionally substituted with up to 3 substituents independently selected from R⁴.

### Embodiment 2

A compound of Embodiment 1 wherein Q¹ is a phenyl ring substituted with 1 to 3 substituents independently selected from R⁴.

### Embodiment 3

A compound of Embodiment 2 wherein Q¹ is a phenyl ring substituted with 2 to 3 substituents independently selected from R⁴.

### Embodiment 4

A compound of Embodiment 3 wherein Q¹ is a phenyl ring substituted with 3 substituents independently selected from R⁴.

### Embodiment 5

A compound of Embodiment 3 wherein Q¹ is a phenyl ring substituted with 2 substituents independently selected from R⁴.

### Embodiment 6

A compound of Formula 1 or any one of Embodiments 1 through 5 wherein Q¹ is a phenyl ring substituted with at least one R⁴ substituent attached at an ortho position (relative to the connection of the Q¹ ring to the remainder of Formula 1).

### Embodiment 7

A compound of Formula 1 or any one of Embodiments 1 through 6 wherein Q¹ is a phenyl ring substituted with at least one R⁴ substituent attached at the para position (relative to the connection of the Q¹ ring to the remainder of Formula 1).

### Embodiment 8

A compound of Formula 1 or any one of Embodiments 1 through 7 wherein Q¹ is a phenyl ring substituted with at least one R⁴ substituent attached at a meta position (relative to the connection of the Q¹ ring to the remainder of Formula 1).

### Embodiment 9

A compound of Formula 1 or any one of Embodiments 1 through 8 wherein X is O, S, NR⁵, CR^{6a}OR^{6b}, CR^{6a}SR^{6b} or CR^{6a}NR^{6b}R^{6c}.

### Embodiment 10

A compound of Embodiment 9 wherein X is O, NH, CHOH, CHSCH₃, CHNH₂ or CHNHCH₃.

### Embodiment 10a

A compound of Embodiment 9 wherein X is O, NR⁵ or CHOR^{6b}.

### Embodiment 11

A compound of Embodiment 10 wherein X is NR⁵ or CHOR^{6b}.

### Embodiment 12

A compound of Embodiment 11 wherein X is CHOR^{6b}.

### Embodiment 13

A compound of Embodiment 11 wherein X is NR⁵.

### Embodiment 14

A compound of Formula 1 or any one of Embodiments 1 through 13 wherein when R¹ is taken alone (i.e. not taken together with R^{1a}), then R¹ is H, cyano, halogen, C₁-C₃ alkyl, C₁-C₃ haloalkyl, C₂-C₄ alkenyl, C₂-C₄ alkynyl, cyclopropyl, C₂-C₄ alkoxyalkyl, C₁-C₃ alkoxy, C₁-C₃ haloalkoxy, C(═O)OR⁷ or C(═O)NR⁸R⁹.

### Embodiment 15

A compound of Embodiment 14 wherein R¹ is H, cyano, halogen, C₁-C₃ alkyl, C₁-C₃ haloalkyl, C₂-C₄ alkoxyalkyl, C₁-C₃ alkoxy or C₁-C₃ haloalkoxy.

### Embodiment 16

A compound of Embodiment 15 wherein R¹ is H, cyano, halogen, C₁-C₃ alkyl, C₁-C₃ haloalkyl, C₁-C₃ alkoxy or C₁-C₃ haloalkoxy.

### Embodiment 17

A compound of Embodiment 16 wherein R¹ is H, halogen or C₁-C₃ alkyl.

### Embodiment 18

A compound of Embodiment 17 wherein R¹ is H or methyl.

### Embodiment 19

A compound of Embodiment 18 wherein R¹ is H.

### Embodiment 20

A compound of Formula 1 or any one of Embodiments 1 through 19 wherein R¹ is taken alone.

### Embodiment 21

A compound of Formula 1 or any one of Embodiments 1 through 20 wherein R^{1a} is H.

### Embodiment 22

A compound of Formula 1 or any one of Embodiments 1 through 21 wherein R^{1a} is taken alone.

### Embodiment 23

A compound of Formula 1 or any one of Embodiments 1 through 22 wherein when R^{1a} and R¹ are taken together with the carbon atom to which they are attached to form a ring, then said ring is cyclopropyl (i.e. unsubstituted).

### Embodiment 24

A compound of Formula 1 or any one of Embodiments 1 through 23 wherein R^{1a} and R¹ are taken together.

### Embodiment 25

A compound of Formula 1 or any one of Embodiments 1 through 24 wherein R² is cyano, halogen, C₁-C₂ alkyl, halomethyl, cyanomethyl, hydroxymethyl, methoxy or methylthio; or cyclopropyl optionally substituted with up to 2 substituents independently selected from halogen and methyl.

### Embodiment 26

A compound of Embodiment 25 wherein R² is Br, Cl, I or C₁-C₂ alkyl.

### Embodiment 27

A compound of Embodiment 26 wherein R² is Br, Cl or methyl.

### Embodiment 28

A compound of Embodiment 27 wherein R² is methyl.

### Embodiment 29

A compound of Formula 1 or any one of Embodiments 1 through 28 wherein when R³ is taken alone (i.e. not taken together with R⁵), then R³ is C₁-C₆ alkyl, C₁-C₆ haloalkyl, C₂-C₆ alkenyl, C₂-C₆ haloalkenyl, C₂-C₆ alkynyl, C₂-C₆ haloalkynyl, C₂-C₆ cyanoalkyl, C₁-C₆ hydroxyalkyl, C₁-C₆ nitroalkyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₄-C₈ cycloalkoxyalkyl, C₃-C₆ alkoxyalkoxyalkyl, C₂-C₆ alkylthioalkyl, C₂-C₆ haloalkylthioalkyl, C₂-C₆ alkylsulfinylalkyl, C₂-C₆ haloalkylsulfinylalkyl, C₂-C₆ alkylsulfonylalkyl, C₂-C₆ haloalkylsulfonylalkyl, C₃-C₆ alkylcarbonylalkyl, C₃-C₆ haloalkylcarbonylalkyl, C₃-C₆ alkoxycarbonylalkyl, C₃-C₆ haloalkoxycarbonylalkyl, C₂-C₆ alkylaminoalkyl, C₂-C₆ haloalkylaminoalkyl, C₃-C₆ dialkylaminoalkyl, C₃-C₆ alkylaminocarbonylalkyl, C₄-C₈ dialkylaminocarbonylalkyl, C₄-C₈ cycloalkylaminoalkyl or C(R^{10a}R^{10b})ₙW¹.

### Embodiment 30

A compound of Embodiment 29 wherein R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl, C₂-C₆ haloalkylthioalkyl, C₂-C₆ alkylsulfinylalkyl, C₂-C₆ alkylsulfonylalkyl, C₂-C₆ alkylaminoalkyl, C₃-C₆ dialkylaminoalkyl or C(R^{10a}R^{10b})ₙW¹.

### Embodiment 31

A compound of Embodiment 30 wherein R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl, C₂-C₆ haloalkylthioalkyl or C(R^{10a}R^{10b})ₙW¹.

### Embodiment 32

A compound of Embodiment 31 wherein R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl or C₂-C₆ haloalkylthioalkyl.

### Embodiment 33

A compound of Embodiment 31 wherein R³ is C(R^{10a}R^{10b})ₙW¹.

### Embodiment 34

A compound of Embodiment 32 wherein R³ is C₁-C₆ alkyl, C₂-C₆ alkenyl, C₂-C₆ alkynyl, C₃-C₆ cycloalkyl, C₃-C₆ cycloalkenyl, C₂-C₆ alkoxyalkyl or C₂-C₆ alkylthioalkyl.

### Embodiment 35

A compound of Embodiment 34 wherein R³ is C₁-C₆ alkyl, C₂-C₆ alkenyl, C₂-C₆ alkynyl, C₃-C₆ cycloalkyl, C₃-C₆ cycloalkenyl or C₂-C₆ alkoxyalkyl.

### Embodiment 36

A compound of Embodiment 35 wherein R³ is C₁-C₆ alkyl, C₂-C₆ alkenyl, C₂-C₆ alkynyl, C₃-C₆ cycloalkyl or C₂-C₆ alkoxyalkyl.

### Embodiment 37

A compound of Formula 1 or any one of Embodiments 1 through 36 wherein R³ is taken alone.

### Embodiment 38

A compound of Formula 1 or any one of Embodiments 1 through 33 wherein W¹ is a 5- to 6-membered fully unsaturated heterocyclic ring containing ring members selected from carbon atoms and 1 to 2 heteroatoms independently selected from up to 2 O, up to 2 S and up to 2 N atoms, the ring optionally substituted with up to 2 substituents independently selected from halogen, cyano, methyl, halomethyl, methoxy and halomethoxy on carbon atom ring members and cyano, methyl and methoxy on nitrogen atom ring members; or a 3- to 7-membered fully saturated ring containing ring members selected from carbon atoms and up to 2 heteroatoms independently selected from up to 2 O, up to 2 S and up to 2 N atoms, wherein up to 1 carbon atom ring member is selected from C(═O) and C(═S), the ring optionally substituted with up to 2 substituents independently selected from halogen, cyano, methyl, halomethyl, methoxy and halomethoxy on carbon atom ring members and cyano, methyl and methoxy on nitrogen atom ring members.

### Embodiment 39

A compound of Formula 1 or any one of Embodiments 1 through 38 wherein each R⁴ is independently amino, cyano, halogen, C₁-C₆ alkyl, C₁-C₆ haloalkyl, C₂-C₆ alkenyl, C₂-C₆ haloalkenyl, C₃-C₆ cycloalkyl, C₄-C₆ cycloalkylalkyl, C₅-C₈ cycloalkylalkenyl, C₄-C₆ alkylcycloalkyl, C₁-C₆ alkylthio, C₁-C₆ alkylsulfinyl, C₁-C₆ alkylsulfonyl, C₁-C₆ alkoxy, C₁-C₆ haloalkoxy, C₃-C₈ cycloalkoxy, C₁-C₆ alkylsulfonyloxy, C₁-C₄ haloalkylsulfonyloxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₂-C₆ alkylcarbonyloxy, C₂-C₆ alkylcarbonyl, C₁-C₆ alkylamino, C₂-C₆ dialkylamino, C₂-C₆ alkylcarbonylamino, C₃-C₉ trialkylsilyl, C₄-C₉ trialkylsilylalkoxy, C₄-C₉ trialkylsilylalkyl, —CH(═O), NHCH(═O), SF₅, SC≡N, —C(═S)NR^{11a}R^{11b}, CR^{12a}═NOR^{12b}, —CR^{12c}═NNR^{11a}R^{11b}, —NR^{11a}N═CR^{13a}R^{13b}, —ON═CR^{13a}R^{13b} or —U—V-T; or each R⁴ is independently -A(CR^{14a}R^{14b})ₙW².

### Embodiment 40

A compound of Embodiment 39 wherein each R⁴ is independently cyano, halogen, methyl, halomethyl, cyclopropyl, methylthio, C₁-C₄ alkoxy, C₁-C₄ haloalkoxy, C₃-C₆ cycloalkoxy, C₁-C₄ alkylsulfonyloxy, C₁-C₄ haloalkylsulfonyloxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₂-C₆ alkylcarbonyloxy, C₃-C₉ trialkylsilyl, C₄-C₉ trialkylsilylalkoxy, C₄-C₉ trialkylsilylalkyl, —CR^{12a}═NOR^{12b}, —ON═CR^{13a}R^{13b} or —U—V-T; or each R⁴ is independently -A(CR^{14a}R^{14b})ₙW².

### Embodiment 41

A compound of Embodiment 40 wherein each R⁴ is independently halogen, methyl, C₁-C₄ alkoxy, C₁-C₄ haloalkoxy, C₃-C₆ cycloalkoxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₃-C₉ trialkylsilyl, C₄-C₉ trialkylsilylalkoxy, C₄-C₉ trialkylsilylalkyl, —CR^{12a}═NOR^{12b}, —ON═CR^{13a}R^{13b} or —U—V-T; or each R⁴ is independently -A(CR^{14a}R^{14b})ₙW².

### Embodiment 42

A compound of Embodiment 41 wherein each R⁴ is independently halogen, methyl, C₁-C₄ alkoxy, C₁-C₄ haloalkoxy, C₃-C₆ cycloalkoxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, —CR^{12a}═NOR^{12b}, —ON═CR^{13a}R^{13b} or —U—V-T; or each R⁴ is independently -A(CR^{14a}R^{14b})ₙW².

### Embodiment 43

A compound of Embodiment 42 wherein each R⁴ is independently halogen, methyl, C₁-C₄ alkoxy, C₂-C₆ alkynyloxy, C₄-C₆ cycloalkylalkoxy, —CR^{12a}═NOR^{12b}, —ON═CR^{13a}R^{13b} or —U—V-T; or each R⁴ is independently -A(CR^{14a}R^{14b})ₙW².

### Embodiment 44

A compound of Embodiment 43 wherein each R⁴ is independently -A(CR^{14a}R^{14b})ₙW².

### Embodiment 45

A compound of Embodiment 43 wherein each R⁴ is independently halogen, methyl, C₁-C₄ alkoxy, C₂-C₆ alkynyloxy, C₄-C₆ cycloalkylalkoxy, —CR^{12a}═NOR^{12b}, —ON═CR^{13a}R^{13b} or —U—V-T.

### Embodiment 46

A compound of Embodiment 45 wherein each R⁴ is independently halogen, methyl, methoxy, C₂-C₄ alkynyloxy, —CR^{12a}═NOR^{12b} or —ON═CR^{13a}R^{13b}.

### Embodiment 46a

A compound of Embodiment 46 wherein each R⁴ is independently halogen.

### Embodiment 46b

A compound of Embodiment 46a wherein each R⁴ is independently Br, Cl or F.

### Embodiment 47

A compound of Formula 1 or any one of Embodiments 1 through 46b wherein each A is O.

### Embodiment 48

A compound of Formula 1 or any one of Embodiments 1 through 44 wherein each A is a direct bond.

### Embodiment 49

A compound of Formula 1 or any one of Embodiments 1 through 44 wherein each W² is independently a 3- to 7-membered heterocyclic ring containing ring members selected from carbon atoms and 1 to 2 heteroatoms independently selected from up to 2 O, up to 2 S and up to 2 N atoms, wherein up to 1 carbon atom ring member is C(═O), the ring optionally substituted with up to 3 substituents independently selected from R¹⁵ on carbon atom ring members and R¹⁶ on nitrogen atom ring members.

### Embodiment 50

A compound of Embodiment 49 wherein each W² is independently a 3- to 6-membered heterocyclic ring containing ring members selected from carbon atoms and 1 to 2 heteroatoms independently selected from up to 2 O, up to 2 S and up to 2 N atoms, the ring optionally substituted with up to 3 substituents independently selected from R¹⁵ on carbon atom ring members and R¹⁶ on nitrogen atom ring members.

### Embodiment 51

A compound of Embodiment 50 wherein each W² is independently a 3- to 5-membered heterocyclic ring containing ring members selected from carbon atoms and 1 to 2 heteroatoms independently selected from up to 2 O and up to 2 N atoms, the ring optionally substituted with up to 2 substituents independently selected from R¹⁵ on carbon atom ring members and R¹⁶ on nitrogen atom ring members.

### Embodiment 52

A compound of Embodiment 51 wherein each W² is independently a 3- to 5-membered heterocyclic ring containing ring members selected from carbon atoms and 1 to 2 heteroatoms independently selected from up to 2 O and up to 2 N atoms.

### Embodiment 53

A compound of Formula 1 or any one of Embodiments 1 through 52 wherein when R⁵ is taken alone (i.e. not taken together with R³), then R⁵ is H, amino, C₂-C₃ alkenyl, C₃-C₂ alkynyl, cyclopropyl, —CH(═O), S(═O)ₘR¹⁷, S(═O)O₂M, C(═Z)R¹⁸ or OR¹⁹; or C₁-C₃ alkyl or C₁-C₃ haloalkyl, each optionally substituted with up to 2 substituents independently selected from R^{20a}.

### Embodiment 54

A compound of Embodiment 53 wherein R⁵ is H, cyclopropyl, —CH(═O), S(═O)ₘR¹⁷, S(═O)O₂M, C(═Z)R¹⁸, OR¹⁹, C₁-C₃ alkyl or C₁-C₃ haloalkyl.

### Embodiment 55

A compound of Embodiment 54 wherein R⁵ is H, —CH(═O), methoxy or methyl.

### Embodiment 56

A compound of Embodiment 55 wherein R⁵ is H.

### Embodiment 57

A compound of Formula 1 or any one of Embodiments 1 through 56 wherein R⁵ is taken alone.

### Embodiment 58

A compound of Formula 1 or any one of Embodiments 1 through 56 wherein when R³ and R⁵ are taken together with the nitrogen atom to which they are attached to form a 4- to 8-membered fully saturated heterocyclic ring, then said ring contains ring members, in addition to the connecting nitrogen atom, selected from carbon atoms and up to 1 heteroatom independently selected from up to 1 O, up to 1 S and up to 1 N, the ring optionally substituted with up to 3 substituents independently selected from halogen, cyano, C₁-C₂ alkyl, C₁-C₂ haloalkyl, C₁-C₂ alkoxy and C₁-C₂ haloalkoxy on carbon atom ring members and cyano, C₁-C₂ alkyl and C₁-C₂ alkoxy on nitrogen atom ring members.

### Embodiment 59

A compound of Embodiment 58 wherein R³ and R⁵ are taken together with the nitrogen atom to which they are attached to form a pyrrolidinyl, piperidinyl, morpholinyl or piperazinyl, each optionally substituted with up to 3 substituents independently selected from halogen, cyano, C₁-C₂ alkyl, C₁-C₂ haloalkyl, C₁-C₂ alkoxy and C₁-C₂ haloalkoxy on carbon atom ring members and cyano, C₁-C₂ alkyl and C₁-C₂ alkoxy on the nitrogen atom ring member.

### Embodiment 60

A compound of Embodiment 59 wherein R³ and R⁵ are taken together with the nitrogen atom to which they are attached to form a pyrrolidinyl, piperidinyl, morpholinyl or piperazinyl, each optionally substituted with up to 2 substituents independently selected from halogen, cyano, methyl, halomethyl, methoxy and halomethoxy on carbon atom ring members and cyano and methyl on the nitrogen atom ring member.

### Embodiment 61

A compound of Embodiment 60 wherein R³ and R⁵ are taken together with the nitrogen atom to which they are attached to form a pyrrolidinyl, piperidinyl, morpholinyl or piperazinyl, each optionally substituted with up to 2 substituents independently selected from halogen and methyl on carbon atom ring members and methyl on the nitrogen atom ring member.

### Embodiment 62

A compound of Formula 1 or any one of Embodiments 1 through 61 wherein R³ and R⁵ are taken together.

### Embodiment 63

A compound of Formula 1 or any one of Embodiments 1 through 62 wherein R^{6a} is H or methyl.

### Embodiment 64

A compound of Embodiment 63 wherein R^{6a} is H.

### Embodiment 65

A compound of Formula 1 or any one of Embodiments 1 through 64 wherein R^{6b} is H, —CH(═O), C₁-C₃ alkyl, C₁-C₂ haloalkyl, C₂-C₃ alkoxyalkyl, C₂-C₄ cyanoalkyl, C₂-C₄ alkylcarbonyl, C₂-C₄ alkoxycarbonyl, C₂-C₄ (alkylthio)carbonyl or C₂-C₄ alkoxy(thiocarbonyl).

### Embodiment 66

### A compound of Embodiment 65 wherein R^{6b} is H, —CH(═O), C₁-C₃ alkyl, C₁-C₂ haloalkyl, C₂-C₃ alkoxyalkyl, C₂-C₄ cyanoalkyl, C₂-C₄ alkylcarbonyl or C₂-C₄ alkoxycarbonyl.

### Embodiment 67

A compound of Embodiment 66 wherein R^{6b} is H, —CH(═O), methyl, halomethyl, cyanomethyl, methylcarbonyl or methoxycarbonyl.

### Embodiment 68

A compound of Embodiment 67 wherein R^{6b} is H.

### Embodiment 69

A compound of Formula 1 or any one of Embodiments 1 through 68 wherein R^{6c} is H or methyl.

### Embodiment 70

A compound of Embodiment 69 wherein R^{6c} is H.

### Embodiment 71

A compound of Formula 1 or any one of Embodiments 1 through 70 wherein R⁷ is H or C₁-C₆ alkyl.

### Embodiment 72

A compound of Embodiment 71 wherein R⁷ is H or C₁-C₂ alkyl.

### Embodiment 73

A compound of Embodiment 72 wherein R⁷ is H or methyl.

### Embodiment 74

A compound of Embodiment 73 wherein R⁷ is H.

### Embodiment 75

A compound of Formula 1 or any one of Embodiments 1 through 74 wherein when R⁸ is taken alone (i.e. not taken together with R⁹ to form a ring), then R⁸ is H or C₁-C₆ alkyl.

### Embodiment 76

A compound of Embodiment 75 wherein R⁸ is H.

### Embodiment 77

A compound of Formula 1 or any one of Embodiments 1 through 76 wherein R⁸ is taken alone.

### Embodiment 78

A compound of Formula 1 or any one of Embodiments 1 through 77 wherein when R⁹ is taken alone (i.e. not taken together with R⁸ to form a ring), then R⁹ is H, C₁-C₆ alkyl, C₁-C₆ haloalkyl or C₄-C₈ alkylcycloalkyl.

### Embodiment 79

A compound of Embodiment 78 wherein R⁹ is H or C₁-C₆ alkyl.

### Embodiment 80

A compound of Embodiment 79 wherein R⁹ is H.

### Embodiment 81

A compound of Formula 1 or any one of Embodiments 1 through 80 wherein R⁹ is taken alone.

### Embodiment 82

A compound of Formula 1 or any one Embodiments 1 through 81 wherein when R⁸ and R⁹ are taken together with the nitrogen atom to which they are attached to form a 4- to 7-membered nonaromatic heterocyclic ring, then said ring contains ring members, in addition to the connecting nitrogen atom, selected from carbon atoms and up to 1 ring member selected from O and NR¹⁸.

### Embodiment 83

A compound of Embodiment 82 wherein R⁸ and R⁹ are taken together with the nitrogen atom to which they are attached to form a 6-membered nonaromatic heterocyclic, containing ring members, in addition to the connecting nitrogen atom, selected from carbon atoms and up to 1 ring member selected from O and NR¹⁸.

### Embodiment 84

A compound of Embodiment 83 wherein R⁸ and R⁹ are taken together with the nitrogen atom to which they are connected to form a piperidinyl, piperazinyl or morpholinyl ring.

### Embodiment 85

A compound of Formula 1 or any one of Embodiments 1 through 84 wherein R^{10a} is H, cyano or methyl.

### Embodiment 86

A compound of Embodiment 85 wherein R^{10a} is H or methyl.

### Embodiment 87

A compound of Embodiment 86 wherein R^{10a} is H.

### Embodiment 88

A compound of Formula 1 or any one of Embodiments 1 through 87 wherein R^{10b} is H or methyl.

### Embodiment 89

A compound of Embodiment 88 wherein R^{10b} is H.

### Embodiment 90

A compound of Formula 1 or any one of Embodiments 1 through 89 wherein each R^{11a} and R^{11b} is independently H or methyl.

### Embodiment 91

A compound of Formula 1 or any one of Embodiments 1 through 90 wherein each R^{12a} is independently H, methyl or halomethyl.

### Embodiment 92

A compound of Formula 1 or any one of Embodiments 1 through 91 wherein each R^{12b} and R^{12c} is independently H, C₁-C₃ alkyl, C₁-C₃ haloalkyl, C₃-C₄ cycloalkyl or C₃-C₄ halocycloalkyl.

### Embodiment 93

A compound of Embodiment 92 wherein each R^{12b} and R^{12c} is independently H, methyl, halomethyl or cyclopropyl.

### Embodiment 94

A compound of Formula 1 or any one of Embodiments 1 through 93 wherein each R^{13a} is independently H or methyl.

### Embodiment 95

A compound of Formula 1 or any one of Embodiments 1 through 94 wherein each R^{13b} is independently H, methyl or halomethyl.

### Embodiment 96

A compound of Formula 1 or any one of Embodiments 1 through 95 wherein each R^{14a} is independently H, halogen, cyano or methyl.

### Embodiment 97

A compound of Embodiment 96 wherein each R^{14a} is independently H or methyl.

### Embodiment 98

A compound of Embodiment 97 wherein each R^{14a} is H.

### Embodiment 99

A compound of Formula 1 or any one of Embodiments 1 through 98 wherein each R^{14b} is independently H or methyl.

### Embodiment 100

A compound of Embodiment 99 wherein each R^{14b} is H.

### Embodiment 101

A compound of Formula 1 or any one of Embodiments 1 through 100 wherein each R¹⁵ is independently halogen, cyano, methyl, halomethyl or methoxy.

### Embodiment 102

A compound of Embodiment 101 wherein each R¹⁵ is independently halogen, methyl, halomethyl or methoxy.

### Embodiment 103

A compound of Formula 1 or any one of Embodiments 1 through 102 wherein each R¹⁶ is independently cyano, methyl or methoxy.

### Embodiment 104

A compound of Formula 1 or any one of Embodiments 1 through 103 wherein R¹⁷ is methyl, ethyl, CF₃ or CF₂CF₃.

### Embodiment 105

A compound of Embodiment 82 wherein R¹⁷ is methyl.

### Embodiment 106

A compound of Formula 1 or any one of Embodiments 1 through 105 wherein R¹⁸ is C₁-C₆ alkyl, C₁-C₆ alkoxy or C₁-C₆ alkylthio.

### Embodiment 107

A compound of Embodiment 106 wherein R¹⁸ is methyl, ethyl, methoxy, ethoxy, methylthio or ethylthio.

### Embodiment 108

A compound of Embodiment 107 wherein R¹⁸ is methyl, methoxy or methylthio.

### Embodiment 109

A compound of Formula 1 or any one of Embodiments 1 through 108 wherein R¹⁹ is H, —CH(═O), cyclopropyl, S(═O)₂OM or C(═Z)R²²; or C₁-C₃ alkyl or C₁-C₃ haloalkyl, each optionally substituted with up to 2 substituents independently selected from R^{20b}.

### Embodiment 110

A compound of Formula 1 or any one of Embodiments 1 through 109 wherein each R^{20a} and R^{20b} is independently cyano, C₃-C₆ cycloalkyl or C₁-C₃ alkoxy.

### Embodiment 111

A compound of Embodiment 110 wherein each R^{20a} and R^{20b} is independently cyano, cyclopropyl or methoxy.

### Embodiment 112

A compound of Embodiment 111 wherein each R^{20a} and R^{20b} is independently cyclopropyl or methoxy.

### Embodiment 113

A compound of Formula 1 or any one of Embodiments 1 through 112 wherein R²¹ is H or methyl

### Embodiment 114

A compound of Embodiment 113 wherein R²¹ is methyl.

### Embodiment 115

A compound of Formula 1 or any one of Embodiments 1 through 114 wherein R²² is C₁-C₆ alkyl, C₁-C₆ alkoxy or C₁-C₆ alkylthio.

### Embodiment 116

A compound of Embodiment 115 wherein R²² is methyl, ethyl, methoxy, ethoxy, methylthio or ethylthio.

### Embodiment 117

A compound of Embodiment 116 wherein R²² is methyl, methoxy or methylthio.

### Embodiment 118

A compound of Formula 1 or any one of Embodiments 1 through 117 wherein each U is independently O or NR²³.

### Embodiment 119

A compound of Embodiment 118 wherein each U is independently O or NH.

### Embodiment 120

A compound of Formula 1 or any one of Embodiments 1 through 119 wherein each V is C₂-C₄ alkylene.

### Embodiment 121

A compound of Formula 1 or any one of Embodiments 1 through 120 wherein each T is independently NR^{24a}R^{24b} or OR²⁵.

### Embodiment 122

A compound of Formula 1 or any one of Embodiments 1 through 121 and wherein each R^{24a} and R^{24b} is independently H, C₁-C₆ alkyl or C₁-C₆ haloalkyl.

### Embodiment 123

A compound of Formula 1 or any one of Embodiments 1 through 122 wherein each R²⁵ is independently H, C₁-C₆ alkyl or C₁-C₆ haloalkyl.

### Embodiment 124

A compound of Formula 1 or any one of Embodiments 1 through 123 wherein Z is O.

### Embodiment 125

A compound of Formula 1 or any one of Embodiments 1 through 124 wherein M is K or Na.

### Embodiment 126

A compound of Formula 1 or any one of Embodiments 1 through 125 wherein m is 0.

### Embodiment 127

A compound of Formula 1 or any one of Embodiments 1 through 126 wherein each n is independently 0, 1 or 2.

### Embodiment 128

A compound of Embodiment 127 wherein each n is independently 0 or 1.

### Embodiment 129

A compound of Embodiment 128 wherein each n is 1.

### Embodiment 130

A compound of Embodiment 128 wherein each n is 0.

Embodiments of this invention, including Embodiments 1-130 above as well as any other embodiments described herein, can be combined in any manner, and the descriptions of variables in the embodiments pertain not only to the compounds of Formula 1 but also to the starting compounds and intermediate compounds useful for preparing the compounds of Formula 1. In addition, embodiments of this invention, including Embodiments 1-130 above as well as any other embodiments described herein, and any combination thereof, pertain to the compositions and methods of the present invention.

Combinations of Embodiments 1-130 are illustrated by:

### Embodiment A

A compound of Formula 1 wherein
Q¹ is a phenyl ring substituted with 1 to 3 substituents independently selected from R⁴; or a pyridinyl, pyrimidinyl, pyrazinyl or pyridazinyl, each optionally substituted with up to 3 substituents independently selected from R⁴;
X is O, S, NRS, CR^{6a}OR^{6b}; CR^{6a}SR^{6b} or CR^{6a}NR^{6b}R^{6c};
R¹ is H, cyano, halogen, C₁-C₃ alkyl, C₁-C₃ haloalkyl, C₂-C₄ alkenyl, C₂-C₄ alkynyl, cyclopropyl, C₂-C₄ alkoxyalkyl, C₁-C₃ alkoxy, C₁-C₃ haloalkoxy, C(═O)OR⁷ or C(═O)NR⁸R⁹;
R^{1a} is H;
R² is Br, Cl, I or C₁-C₂ alkyl;
R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl, C₂-C₆ haloalkylthioalkyl, C₂-C₆ alkylsulfinylalkyl, C₂-C₆ alkylsulfonylalkyl, C₂-C₆ alkylaminoalkyl, C₃-C₆ dialkylaminoalkyl or C(R^{10a}R^{10b})ₙW¹;
W¹ is a 5- to 6-membered fully unsaturated heterocyclic ring containing ring members selected from carbon atoms and 1 to 2 heteroatoms independently selected from up to 2 O, up to 2 S and up to 2 N atoms, the ring optionally substituted with up to 2 substituents independently selected from halogen, cyano, methyl, halomethyl, methoxy and halomethoxy on carbon atom ring members and cyano, methyl and methoxy on nitrogen atom ring members; or a 3- to 7-membered fully saturated ring containing ring members selected from carbon atoms and up to 2 heteroatoms independently selected from up to 2 O, up to 2 S and up to 2 N atoms, wherein up to 1 carbon atom ring member is selected from C(═O) and C(═S), the ring optionally substituted with up to 2 substituents independently selected from halogen, cyano, methyl, halomethyl, methoxy and halomethoxy on carbon atom ring members and cyano, methyl and methoxy on nitrogen atom ring members;
each R⁴ is independently cyano, halogen, methyl, halomethyl, cyclopropyl, methylthio, C₁-C₄ alkoxy, C₁-C₄ haloalkoxy, C₃-C₆ cycloalkoxy, C₁-C₄ alkylsulfonyloxy, C₁-C₄ haloalkylsulfonyloxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₂-C₆ alkylcarbonyloxy, C₃-C₉ trialkylsilyl, C₄-C₉ trialkylsilylalkoxy, C₄-C₉ trialkylsilylalkyl, —CR^{12a}═NOR^{12b}, —ON═CR^{13a}R^{13b} or —U—V-T; or each R⁴ is independently -A(CR^{14a}R^{14b})ₙW²;
W² is independently a 3- to 6-membered heterocyclic ring containing ring members selected from carbon atoms and 1 to 2 heteroatoms independently selected from up to 2 O, up to 2 S and up to 2 N atoms, the ring optionally substituted with up to 3 substituents independently selected from R¹⁵ on carbon atom ring members and R¹⁶ on nitrogen atom ring members;
R⁵ is H, cyclopropyl, —CH(═O), S(═O)ₘR¹⁷, S(═O)O₂M, C(═Z)R¹⁸, OR¹⁹, C₁-C₃ alkyl or C₁-C₃ haloalkyl; or
R³ and R⁵ are taken together with the nitrogen atom to which they are attached to form a pyrrolidinyl, piperidinyl, morpholinyl or piperazinyl, each optionally substituted with up to 3 substituents independently selected from halogen, cyano, C₁-C₂ alkyl, C₁-C₂ haloalkyl, C₁-C₂ alkoxy and C₁-C₂ haloalkoxy on carbon atom ring members and cyano, C₁-C₂ alkyl and C₁-C₂ alkoxy on the nitrogen atom ring member;
R^{6a} is H or methyl;
R^{6b} is H, —CH(═O), C₁-C₃ alkyl, C₁-C₂ haloalkyl, C₂-C₃ alkoxyalkyl, C₂-C₄ cyanoalkyl, C₂-C₄ alkylcarbonyl or C₂-C₄ alkoxycarbonyl;
R^{6c} is H or methyl;
R⁷ is H or methyl;
R⁸ is H or C₁-C₆ alkyl;
R⁹ is H, C₁-C₆ alkyl, C₁-C₆ haloalkyl or C₄-C₈ alkylcycloalkyl;
R^{10a} is H or methyl;
R^{10b} is H or methyl;
each R^{12a} is independently H, methyl or halomethyl;
each R^{12b} is independently H, methyl, halomethyl or cyclopropyl
each R^{13a} is independently H or methyl;
each R^{13b} is independently H, methyl or halomethyl;
each R^{14a} is independently H, halogen, cyano or methyl
each R^{14b} is independently H or methyl
each R¹⁵ is independently halogen, cyano, methyl, halomethyl or methoxy
each R¹⁶ is independently cyano, methyl or methoxy
R¹⁷ is methyl, ethyl, CF₃ or CF₂CF₃;
R¹⁸ is methyl, ethyl, methoxy, ethoxy, methylthio or ethylthio;
R¹⁹ is H, —CH(═O), cyclopropyl, S(═O)₂OM or C(═Z)R²²; or C₁-C₃ alkyl or C₁-C₃ haloalkyl, each optionally substituted with up to 2 substituents independently selected from R^{20b};
each R^{20b} independently cyano, C₃-C₆ cycloalkyl or C₁-C₃ alkoxy;
R²² is methyl, methoxy or methylthio;
each U is independently O or NR²³;
each V is C₂-C₄ alkylene;
each T is independently NR^{24a}R^{24b} or OR²⁵;
each R^{24a} and R^{24b} is independently H, C₁-C₆ alkyl or C₁-C₆ haloalkyl;
each R²⁵ is independently H, C₁-C₆ alkyl or C₁-C₆ haloalkyl; and
each n is independently 0 or 1.

### Embodiment B

A compound of Embodiment A wherein
Q¹ is a phenyl ring substituted with 1 to 3 substituents independently selected from R⁴;
X is O, NH, CHOH, CHSCH₃, CHNH₂ or CHNHCH₃;
R¹ is H, halogen or C₁-C₃ alkyl;
R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl, C₂-C₆ haloalkylthioalkyl or C(R^{10a}R^{10b})ₙW¹;
each R⁴ is independently halogen, methyl, C₁-C₄ alkoxy, C₁-C₄ haloalkoxy, C₃-C₆ cycloalkoxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₃-C₉ trialkylsilyl, C₄-C₉ trialkylsilylalkoxy, C₄-C₉ trialkylsilylalkyl, —CR^{12a}═NOR^{12b}, —ON═CR^{13a}R^{13b} or —U—V-T; or each R⁴ is independently -A(CR^{14a}R^{14b})ₙW²;
W² is independently a 3- to 5-membered heterocyclic ring containing ring members selected from carbon atoms and 1 to 2 heteroatoms independently selected from up to 2 O and up to 2 N atoms, the ring optionally substituted with up to 2 substituents independently selected from R¹⁵ on carbon atom ring members and R¹⁶ on nitrogen atom ring members;
R^{10a} is H;
R^{10b} is H;
R^{14a} is independently H or methyl;
R^{14b} is independently H or methyl;
R¹⁵ is independently halogen, methyl, halomethyl or methoxy; and
each U is independently O or NH.

### Embodiment C

A compound of Embodiment B wherein
R¹ is H;
R² is Br, Cl or methyl;
R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl or C₂-C₆ haloalkylthioalkyl; and
each R⁴ is independently halogen, methyl, C₁-C₄ alkoxy, C₁-C₄ haloalkoxy, C₃-C₆ cycloalkoxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, —CR^{12a}═NOR^{12b}, —ON═CR^{13a}R^{13b} or —U—V-T; or each R⁴ is independently -A(CR^{14a}R^{14b})ₙW².

### Embodiment D

A compound of Embodiment C wherein
Q¹ is phenyl ring substituted with 2 to 3 substituents independently selected from R⁴;
R² is methyl;
R³ is C₁-C₆ alkyl, C₂-C₆ alkenyl, C₂-C₆ alkynyl, C₃-C₆ cycloalkyl, C₃-C₆ cycloalkenyl, C₂-C₆ alkoxyalkyl or C₂-C₆ alkylthioalkyl; and
each R⁴ is independently Br, Cl or F.

Specific embodiments include compounds of Formula 1 selected from the group consisting of:
4-(2-chloro-4-fluorophenyl)-1,3-dimethyl-α-(1-methylpropyl)-1H-pyrazole-5-methanol,
4-(2-chloro-6-fluorophenyl)-α-cyclohexyl-1,3-dimethyl-1H-pyrazole-5-methanol,
4-(2-chloro-6-fluorophenyl)-1,3-dimethyl-α-(1-methylpropyl)-1H-pyrazole-5-methanol,
4-(2-chloro-4-fluorophenyl)-1,3-dimethyl-α-(1-methylethyl)-1H-pyrazole-5-methanol,
4-(2,4-dichlorophenyl)-1,3-dimethyl-N-(2-methylpropyl)-1H-pyrazol-5-amine,
N-butyl-4-(2,4-dichlorophenyl)-1,3-dimethyl-1H-pyrazol-5-amine,
4-(2-bromo-4-fluorophenyl)-1,3-dimethyl-5-(2-methylbutoxy)-1H-pyrazole,
4-(2-chloro-4-fluorophenyl)-5-(cyclopropylmethoxy)-1,3-dimethyl-1H-pyrazole,
4-(2-chloro-6-fluorophenyl)-N,1,3-trimethyl-α-(1-methylpropyl)-1H-pyrazole-5-methanamine,
4-(2-chloro-6-fluorophenyl)-1,3-dimethyl-α-(1-methylpropyl)-1H-pyrazole-5-methanamine,
4-(2-chloro-4-fluorophenyl)-5-(2-methoxyethoxy)-1,3-dimethyl-1H-pyrazole,
4-(2-chloro-4-fluorophenyl)-5-(cyclohexyloxy)-1,3-dimethyl-1H-pyrazole,
1-[4-(2-chloro-4-fluorophenyl)-1,3-dimethyl-1H-pyrazol-5-yl]-4-methylpiperidine,
4-[4-(2-chloro-4-fluorophenyl)-1,3-dimethyl-1H-pyrazol-5-yl]morpholine, and
4-(2-chloro-6-fluorophenyl)-1,3-dimethyl-5-[2-methyl-1-(methylthio)butyl]-1H-pyrazole.

This invention provides a fungicidal composition comprising a compound of Formula 1 (including all stereoisomers, N-oxides, and salts thereof), and at least one other fungicide. Of note as embodiments of such compositions are compositions comprising a compound corresponding to any of the compound embodiments described above.

This invention provides a fungicidal composition comprising a compound of Formula 1 (including all stereoisomers, N-oxides, and salts thereof) (i.e. in a fungicidally effective amount), and at least one additional component selected from the group consisting of surfactants, solid diluents and liquid diluents. Of note as embodiments of such compositions are compositions comprising a compound corresponding to any of the compound embodiments described above.

This invention provides a method for controlling plant diseases caused by fungal plant pathogens comprising applying to the plant or portion thereof, or to the plant seed, a fungicidally effective amount of a compound of Formula 1 (including all stereoisomers, N-oxides, and salts thereof). Of note as embodiment of such methods are methods comprising applying a fungicidally effective amount of a compound corresponding to any of the compound embodiments describe above. Of particular notes are embodiment where the compounds are applied as compositions of this invention.

One or more of the following methods and variations as described in Schemes 1-38 can be used to prepare the compounds of Formula 1. The definitions of R¹, R^{1a}, R², R³, Q¹, X and m in the compounds of Formulae 1-50 below are as defined above in the Summary of the Invention unless otherwise noted. Compounds of Formulae 1a-1i are various subsets of the compounds of Formula 1, and all substituents for Formulae 1a-1i are as defined above for Formula 1 unless otherwise noted. Formulae 4a-4-c are various subsets of Formula 4; Formulae 6a and 6b are various subsets of Formula 6; Formula 14a is a subset of Formula 14; Formulae 17a and 17b are various subsets of Formula 17; Formula 21a is a subset of Formula 21, substituents for each subset formula are as defined for its parent formula unless otherwise noted.

As shown in Scheme 1, Compounds of Formula 1a (i.e. Formula 1 wherein X is NR⁵) wherein R⁵ is other than H can be prepared by reacting corresponding compounds of Formula 1b (i.e. Formula 1 wherein X is NR⁵ and R⁵ is H) with an electrophile comprising R⁵, typically in the presence of a base such as NaH and a polar solvent such as N,N-dimethylformamide. In this context the expression “electrophile comprising R⁵” means a chemical compound capable of transferring an R⁵ moiety to a nucleophile. Often electrophiles comprising R⁵ have the formula R⁵Lg wherein Lg is a nucleofuge (i.e. leaving group in nucleophilic reactions). Typical nucleofuges include halogens (e.g., Cl, Br, I) and sulfonates (e.g., OS(O)₂CH₃, OS(O)₂CF₃, OS(O)₂-(4-CH₃-Ph)). However, some electrophiles comprising R⁵ do not comprise a nucleofuge; an example is sulfur trioxide (SO₃), which after deprotonation (such as by a base of the formulae M+H⁻ wherein M⁺ is a cation) of the nitrogen atom attached to R³ in Formula 1b, can bond to the nitrogen atom as a —SO₃−M⁺ substituent.

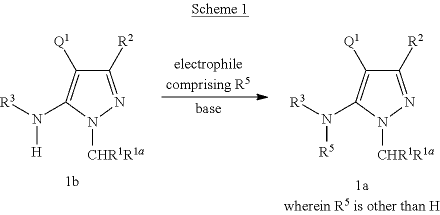

As shown in Scheme 2, compounds of Formula 1b (i.e. Formula 1 wherein X is NR⁵ and R⁵ is H) wherein R^{1a} is H can be prepared by the reaction of 1H-pyrazole compounds of Formula 2 with various alkylating agents (e.g., Formula 3), such as iodoalkanes, alkylsulfonates (e.g., mesylate (OMs) or tosylate (OTs)) or trialkyl phosphates, preferably in the presence of an organic or inorganic base such as 1,8-diazabicyclo[5.4.0]undec-7-ene, potassium carbonate or potassium hydroxide, and in a solvent such as N,N-dimethylformamide, tetrahydrofuran, toluene or water.

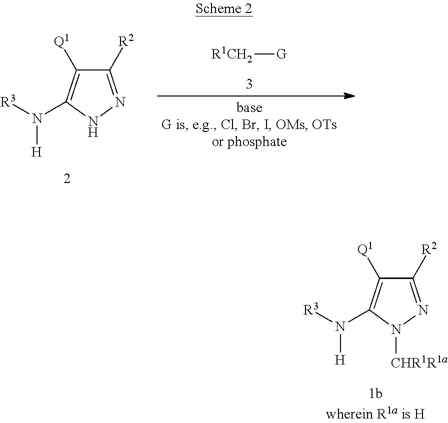

Compounds of Formula 1b (i.e. Formula 1 wherein X is NR⁵ and R⁵ is H) wherein R^{1a} and R¹ are taken together to form an optionally substituted cyclopropyl ring can be prepared by reacting a pyrazole of Formula 2 with an organometallic reagent, such as tricyclopropylbismuth, in the presence of a catalyst, such as copper acetate, under conditions known in the art. See, for example, J. Am. Chem. Soc. 2007, 129(1), 44-45.

As shown in Scheme 3, Compounds of Formula 1 wherein X is NR⁵, O or S can be prepared by reacting compounds of Formula 4 (e.g., 5-aminopyrazoles for X being N(R⁵), 5-hydroxypyrazoles for X being O or 5-mercaptopyrazoles for X being S) with compounds of Formula 5 wherein L¹ is a leaving group such as halogen (e.g., Cl, Br or I) or (halo)alkylsulfonate (e.g., p-toluenesulfonate, methanesulfonate or trifluoromethanesulfonate) optionally in the presence of a metal catalyst, and generally in the presence of a base and a polar aprotic solvent such as N,N-dimethylformamide or dimethyl sulfoxide. For compounds of Formula 5 wherein R³ is attached through a sp³-hybridized carbon atom, L¹ is typically Cl, Br, I or a sulfonate (e.g., methanesulfonate). In certain instances the use of a metal catalyst (e.g., metal or metal salt) in amounts ranging from catalytic up to superstoichiometric can facilitate the desired reaction. Typically for these conditions, L¹ is Br or I or a sulfonate such as methyl trifluoromethanesulfonate or —OS(O)₂(CF₂)₃CF₃. For example, the reaction can be run in the presence of a metal catalyst such as copper salt complexes (e.g., CuI with N,N′-dimethylethylenediamine, proline or bipyridyl), palladium complexes (e.g., tris(dibenzylideneacetone)dipalladium(0)) or palladium salts (e.g., palladium acetate) with ligands such as 4,5-bis(diphenylphosphino)-9,9-dimethylxanthene, 2-dicyclohexylphosphino-2′,4′,6′-triisopropylbiphenyl or 2,2′-bis-(diphenylphosphino)1,1′-binaphthalene, with a base such as potassium carbonate, cesium carbonate, potassium phosphate, sodium phenoxide or sodium tert-butoxide and a solvent such as N,N-dimethylformamide, 1,2-dimethoxyethane, dimethyl sulfoxide, 1,4-dioxane or toluene, optionally containing an alcohol such as ethanol. For relevant references, see PCT Patent Publication WO 2010/020363 and Archives of Pharmacal Research 2002, 25(6), 781-785.

One skilled in the art will appreciate that the leaving group L¹ attached to compounds of Formula 5 should be selected in view of the relative reactivity of other functional groups present on Formula 5 (i.e. substituents attached to R³), so that the group L¹ is displaced and not the functional group to give the final desired compounds of Formula 1.

General methods useful for preparing starting compounds of Formula 4 are well-known in the art; see, for example, J. Heterocyclic Chem. 1982, 19, 1173-1177, and Organic & Biomolecular Chemistry 2011, 9(10), 3714-3725 for conditions for preparing 5-aminopyrazoles of Formula 4; and Chemical & Pharmaceutical Bulletin 1994, 42(8), 1617-1630 for conditions for preparing 5-hydroxypyrazoles of Formula 4. 5-thiopyrazoles of Formula 4 can be prepared by reacting the corresponding 5-hydroxypyrazoles with phosphorus pentasulfide or 2,4-bis(4-methoxyphenyl)-1,3-dithia-2,4-diphosphetane-2,4-disulfide (Lawesson's reagent) in solvents such as toluene, xylene or tetrahydrofuran. For references see, for example, PCT Patent Publication WO 2005/118575, and Justus Liebigs Annalen der Chemie 1908, 361, 251.

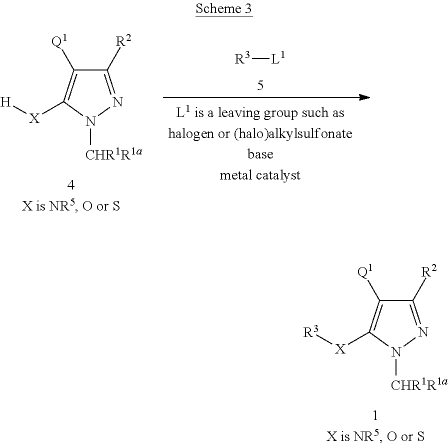

In an alternative method, as illustrated in Scheme 4, compounds of Formula 1b (i.e. Formula 1 wherein X is NRS and R⁵ is H) can be prepared by reaction of compounds of Formula 6 (i.e. 5-bromopyrazoles or other pyrazoles substituted at the 5-position with a leaving group) with compounds of Formula 7 in the presence of a metal catalyst. Typically for these conditions, G is Br or I or a sulfonate such as OS(O)₂CF₃ or OS(O)₂(CF₂)₃CF₃. For example, copper salt complexes (e.g., CuI with N,N′-dimethylethylenediamine, proline or bipyridyl), palladium complexes (e.g., tris(dibenzylideneacetone)dipalladium(0)) or palladium salts (e.g., palladium acetate) with ligands such as 4,5-bis(diphenylphosphino)-9,9-dimethylxanthene (i.e. “Xantphos”), 2-dicyclohexylphosphino-2′,4′,6′-triisopropylbiphenyl (i.e. “Xphos”) or 2,2′-bis(diphenylphosphino)-1,1′-binaphthalene (i.e. “BINAP”), in the presence of a base such as potassium carbonate, cesium carbonate, sodium phenoxide or sodium tert-butoxide, in a solvent such as N,N-dimethylformamide, 1,2-dimethoxyethane, dimethyl sulfoxide, 1,4-dioxane or toluene, optionally mixed with alcohols such as ethanol, can be used. Compounds of Formula 7 are commercially available and their preparation is known in the art; see, for example, J. Org. Chem. 2010, 75, 984-987.

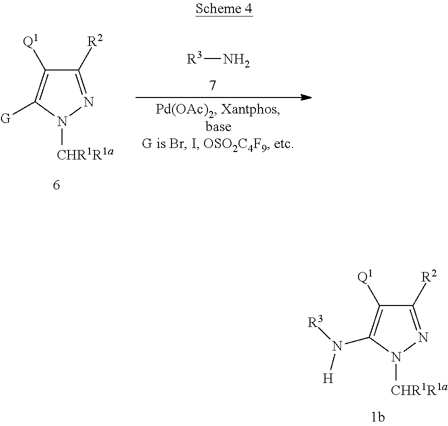

As shown in Scheme 5, compounds of Formula 1c (i.e. Formula 1 wherein X is S(O)ₘ and m is 0) and Formula Id (i.e. Formula 1 wherein X is CR^{6a}OR^{6b} and R^{6b} is H), can be prepared by treatment of compounds of Formula 6 with an organometallic reagent (i.e. Formula 8) such as an alkyllithium, preferably n-butyllithium, or an alkylmagnesium reagent, preferably isopropylmagnesium chloride (optionally complexed with lithium chloride), followed by the addition of a sulfur electrophile (i.e. Formula 9) or carbonyl electrophile (i.e. Formula 10). Reaction temperatures can range from −90° C. to the boiling point of the reaction solvent; temperatures of −78° C. to ambient temperature are generally preferred, with temperatures of −78 to −10° C. preferred when an alkyllithium reagent is used, and −20° C. to ambient temperature preferred with use of alkylmagnesium reagents. A variety of solvents are useful, such as toluene, ethyl ether, tetrahydrofuran or dimethoxymethane; anhydrous tetrahydrofuran is preferred. The R³-containing sulfur and carbonyl intermediates of Formulae 9 and 10 are commercially available and can be prepared by methods known in the art.

It will be recognized by one skilled in the art that reactions analogous to those shown in Scheme 5 can also be utilized with pyrazoles lacking a Q¹ substituent.

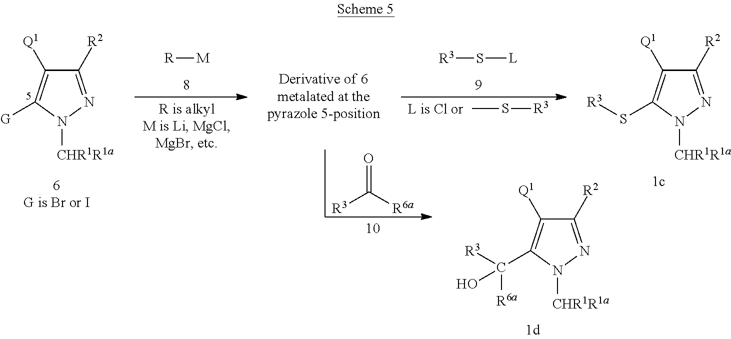

As shown in Scheme 6, compounds of Formula 1e (i.e. Formula 1 wherein X is CR^{6a}OR^{6b}) can be prepared by alkylation or acylation of compounds of Formula Id with an electrophile comprising R^{6b} under conditions well-known in the literature.

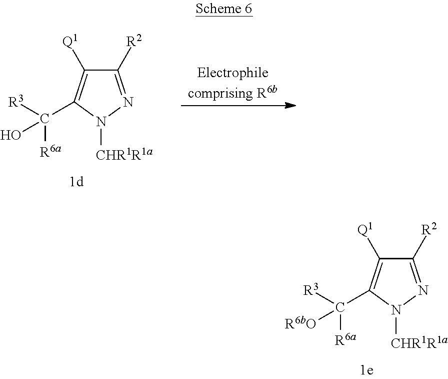

As shown in Scheme 7, compounds of Formula if (i.e. Formula 1 wherein X is CR^{6a}SR^{6b} and R^{6a} is H) and Formula 1g (i.e. Formula 1 wherein X is CR^{6a}NR^{6b}R^{6c} and R^{6a} is H) can be prepared by treatment of compounds of Formula 11 with thiols of Formula 12 and amines of Formula 13, respectively, preferably in the presence of a base. Intermediates of Formula 11 can be prepared from alcohols of Formula Id by standard methods known in the literature.

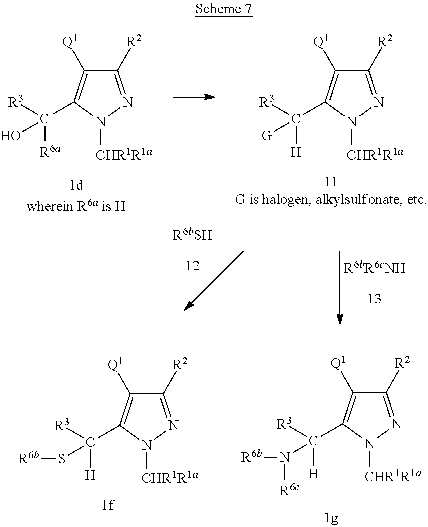

As shown in Scheme 8 compounds of Formula 6 wherein G is Br or I can be prepared by reaction of 5-aminopyrazoles of Formula 4a (i.e. Formula 4 wherein X is NH) under diazotization conditions either in the presence of, or followed by, copper salts containing bromide or iodide. For example, addition of tert-butyl nitrite to a solution of a 5-aminopyrazole of Formula 4a in the presence of CuBr₂ in a solvent such as acetonitrile provides the corresponding 5-bromopyrazole of Formula 6. Likewise, a 5-aminopyrazole of Formula 4a can be converted to a diazonium salt and then to a corresponding 5-halopyrazole of Formula 6 by treatment with sodium nitrite in solvents such as water, acetic acid or trifluoroacetic acid, in the presence of a mineral acid typically containing the same halide atom (such as aqueous HI solution for G being I), followed by treatment with the corresponding copper(I) or copper(II) salt according to general procedures well known to those skilled in the art; see, for example, J. Comb. Chem. 2003, 5, 118-124.

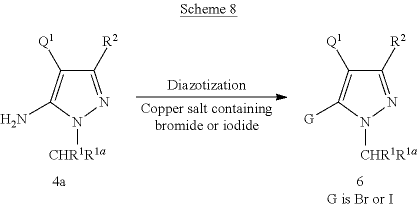

As shown in Scheme 9,5-bromopyrazoles of Formula 6a (i.e. Formula 6 wherein G is Br) can be prepared by reacting 5-hydroxypyrazoles of Formula 4b (i.e. Formula 4 wherein X is O) with phosphorus tribromide as described in Tetrahedron Lett. 2000, 41(24), 4713.

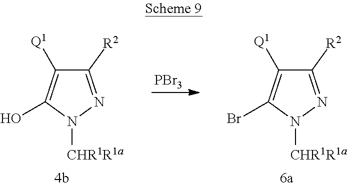

As shown in Scheme 10, 5-hydroxypyrazoles of Formula 4b can also be used to prepare 5-fluoroalkylsulfonyl (e.g, 5-trifluoromethanesulfonyl, 5-nonafluorobutylsulfinyl) pyrazoles of Formula 6b (i.e. Formula 6 wherein G is fluoroalkylsulfonyl) as described in Synlett 2004, 5, 795.

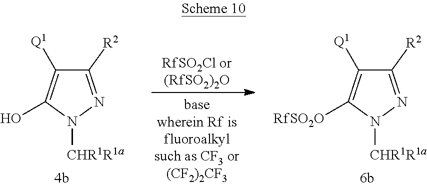

As shown in Scheme 11, compounds of Formula 1 can be prepared by reaction of compounds of Formula 14 wherein G is Br or I with organometallic compounds of formula Q¹-M (Formula 15) under transition-metal-catalyzed cross-coupling reaction conditions. Reaction of a 4-bromo or iodopyrazole of Formula 14 with a boronic acid, trialkyltin, zinc or organomagnesium reagent of Formula 15 in the presence of a palladium or nickel catalyst having appropriate ligands (e.g., triphenylphosphine (PPh₃), dibenzylideneacetone (dba), dicyclohexyl(2′,6′-dimethoxy[1,1′-biphenyl]-2-yl)phosphine (SPhos)) and a base, if needed, affords the corresponding compound of Formula 1. For example, a substituted aryl boronic acid or derivative (e.g., Formula 11 wherein Q¹ is optionally substituted phenyl or heterocyclyl and M is B(OH)₂, B(OC(CH₃)₂C(CH₃)₂O)) or [B(OiPr)₃]Li reacts with a 4-bromo- or 4-iodopyrazole of Formula 10 in the presence of dichlorobis(triphenylphosphine) palladium(II) and aqueous base such as sodium carbonate or potassium hydroxide, in solvents such as 1,4-dioxane, 1,2-dimethoxyethane, toluene or ethyl alcohol, or under anhydrous conditions with a ligand such as phosphine oxide or phosphite ligand (e.g., diphenylphosphine oxide) and potassium fluoride in a solvent such as 1,4-dioxane (see Angewandte Chemie, International Edition 2008, 47(25), 4695-4698) to provide the corresponding compound of Formula 1.

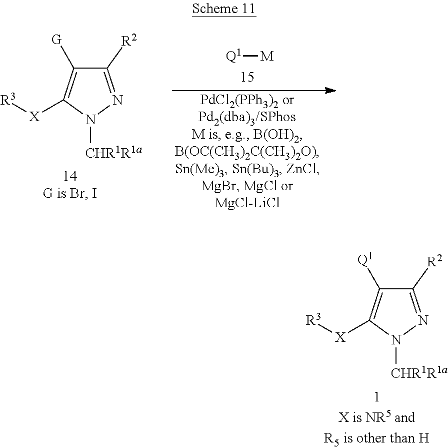

As illustrated in Scheme 12, compounds of Formula 4a (i.e. Formula 4 wherein X is NH) can be prepared by reacting compounds of Formula 16 with compounds of Formula 15 (such as Q¹-B(OH)₂ (Formula 15a)) using transition-metal-catalyzed cross-coupling reaction conditions as described for the method of Scheme 11.

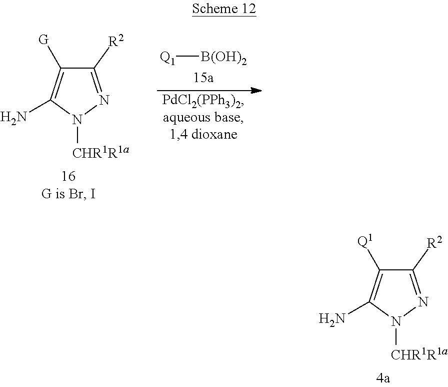

As illustrated in Scheme 13, pyrazoles of Formula 14 wherein G is Br or I are readily prepared by the reaction of pyrazoles unsubstituted at the 4-position (Formula 17) with halogenating reagents such as bromine, sodium bromite, N-bromosuccinimide (NBS) or N-iodosuccinimide (NIS), in solvents such as acetic acid, acetonitrile, N,N-dimethyl-formamide, N,N-dimethylacetamide or 1,4-dioxane, or a mixture of water with the aforementioned solvents, at temperatures ranging from ambient to the boiling point of the solvent.

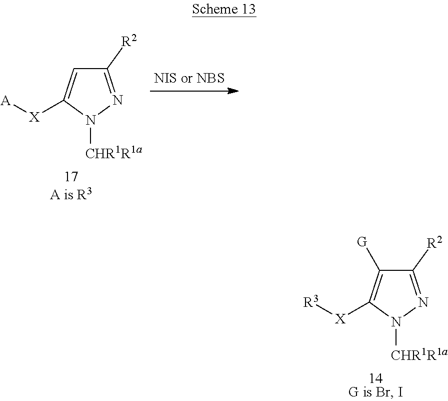

Furthermore, using reaction conditions similar to those for the method of Scheme 13 compounds of Formula 17 wherein A is H or a protecting group can be converted into intermediates corresponding to Formula 14 wherein R³ is replaced by A or a protecting group, respectively, which are useful for preparing compounds of Formula 1. Compounds of Formula 17 wherein A is H can be prepared by methods known in the art; see, for example, Synlett 2004, 5, 795-798, U.S. Pat. No. 4,256,902 and references cited therein. Furthermore, some compounds of Formula 17 wherein A is H, particularly those in which R² is methyl, ethyl or halogen, are commercially available.

As shown in Scheme 14, compounds of Formula 17 wherein X is O, S(O)ₘ or NR⁴, m is 0 and A is R³ can be prepared from corresponding compounds of Formula 17a (i.e. Formula 17 wherein A is H) by procedures analogous those used for the method of Scheme 3. Compounds of Formula 17 wherein X is S (i.e. S(O)ₘ wherein m is 0) can then be oxidized using procedures such as those described below in Scheme 38 to provide corresponding compounds of Formula 17 wherein X is S(O)₂ or S(O)₂ for use in the method of Scheme 14. Compounds of Formula 17a are commercially available or can be prepared by methods known in the art.

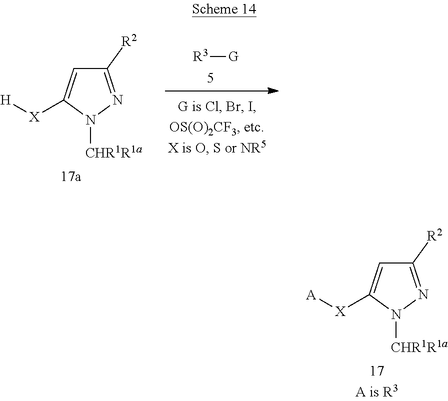

General methods useful for preparing 5-aminopyrazoles of Formula 4a are well known in the art; see, for example, Journal für Praktische Chemie (Leipzig) 1911, 83, 171 and J. Am. Chem. Soc. 1954, 76, 501. Such a method is illustrated in Scheme 15 in which R² is alkyl or cycloalkyl.

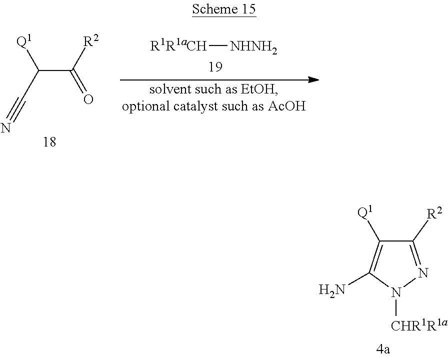

Similarly, general methods useful for preparing 5-hydroxypyrazoles of Formula 4b are well known in the art; see, for example, Annalen der Chemie 1924, 436, 88, and J. Heterocyclic Chem. 1987, 24, 149-153. Such a method is illustrated in Scheme 16 in which R² is alkyl or cycloalkyl.

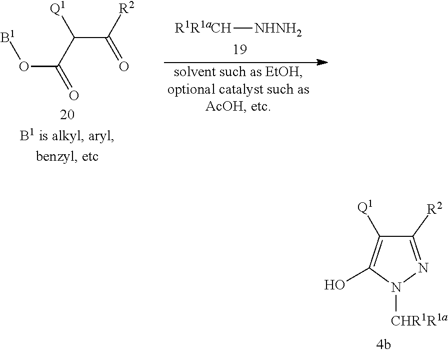

As shown in Scheme 17, 5-thiopyrazole compounds of Formula 4c (i.e. Formula 4 wherein X is S) can be prepared by reaction of corresponding 5-hydroxypyrazole compounds of Formula 4b with P₂S₅ (see, for example, Justus Liebigs Annalen der Chemie 1908, 361, 251) or with Lawesson's Reagent (2,4-bis-(4-methoxyphenyl)-1,3-dithia-2,4-diphosphetane 2,4-disulfide; see, for example, International Patent Publication WO 2005/118575) in solvents such as toluene, xylene or tetrahydrofuran.

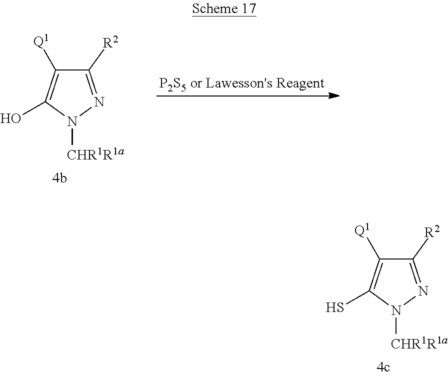

As shown in Scheme 18, compounds of Formula 1b (i.e. Formula 1 wherein X is NR⁴ and R⁴ is H) can be prepared by condensing compounds of Formula 21 with alkylhydrazines of Formula 19 in a solvent such as ethanol or methanol and optionally in the presence of an acid or base catalyst such as acetic acid, piperidine or sodium methoxide, according to general procedures known in the art.

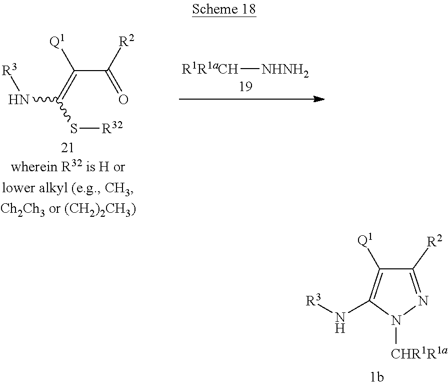

In a manner analogous to the method of Scheme 18, compounds of Formula 2 can be similarly prepared by condensing compounds of Formula 21 with hydrazine. This method is described in Chemistry of Heterocyclic Compounds 2005, 41(1), 105-110.

As shown in Scheme 19, compounds of Formula 21 (wherein, e.g., R² is methyl, ethyl or optionally substituted cyclopropyl and R³³ is H or lower alkyl such as CH₃, CH₂CH₃ or (CH₂)₂CH₃) can be prepared by reaction of corresponding ketene dithioacetal compounds of Formula 22 with compounds of formula R³—NH₂ (i.e. Formula 7) optionally in the presence of a base, such as sodium hydride or ethylmagnesium chloride, in solvents such as toluene, tetrahydrofuran or dimethoxymethane, at temperatures ranging from −10° C. to the boiling point of the solvent. See, for example, J. Heterocycl. Chem. 1975, 12(1), 139. Methods useful for preparing compounds of Formula 22 are known in the art.

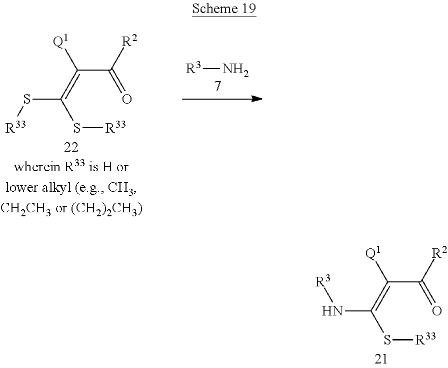

It is also known in the art (see, for example, Synthesis 1989, 398) that compounds of Formula 22 in which the two R³³ groups are taken together as a single CH₂ group (thus forming a dithietane ring) react with a stoichiometric excess amount of hydrazines of Formula 19 to afford compounds of Formula 4c, which are useful for preparation of compounds of Formula 1 in which X is S according to the method of Scheme 3.

As shown in Scheme 20, compounds of Formula 21a (i.e. tautomer of Formula 21 wherein R³³ is H) can be prepared by reaction of corresponding isothiocyanate compounds of Formula 23 with arylacetone compounds of Formula 24 wherein R² is methyl, ethyl or optionally substituted cyclopropyl; see, for example, Zhurnal Organicheskoi Khimii 1982, 18(12), 2501. Bases useful for this reaction include sodium hydride, alkoxide bases (e.g., potassium tert-butoxide or sodium ethoxide), potassium hydroxide, sodium hydroxide, potassium carbonate, or amine bases (e.g., triethylamine or N,N-diisopropylethylamine). A variety of solvents are useful, such as tetrahydrofuran, ether, toluene, N,N-dimethyl-formamide, alcohols (e.g., ethanol), esters (e.g., ethyl acetate or isopropyl acetate), or mixtures thereof. Solvents are chosen for compatibility with the base selected, as is well-known in the art. Reaction temperatures can range from −78° C. to the boiling point of the solvent. One useful mixture of base and solvent is potassium tert-butoxide in tetrahydrofuran, to which at −70 to 0° C. is added a combined solution of an isothiocyanate of Formula 23 and a carbonyl compound of Formula 24.

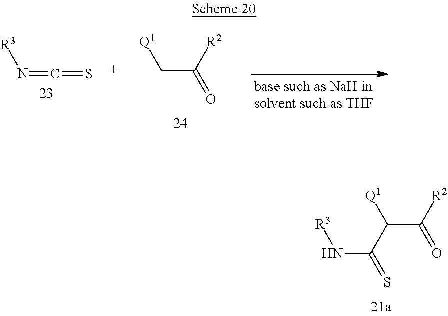

Ketothioamides of Formula 20 can be also be prepared by allowing the corresponding ketoamides to react with sulfurizing agents such as Lawesson's reagent or P₂S₅; see, for example, Helv. Chim. Act. 1998, 81(7), 1207.

As shown in Scheme 21, compounds of Formula 1i (i.e. Formula 1 wherein R² is H can be prepared by hydrogenolysis of compounds of Formula 1h (i.e. Formula 1 wherein R² is Br) with hydrogen in the presence of a catalyst such as palladium. This type of transformation is well known in the literature and typical conditions for carrying out this hydrogenolysis can be found in German Patent Publication DE 19619112 A1.

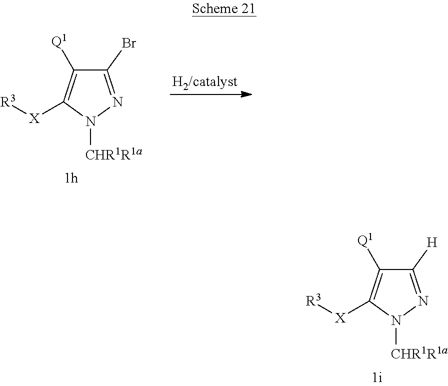

As shown in Scheme 22, compounds of Formula 1 wherein R² is C₂-C₃ alkenyl or C₂-C₃ alkynyl can be prepared by reacting compounds of Formula 1h with organometallics of Formula 31, in which M is, for example, B(OH)₂ or esters thereof, ZnCl, ZnBr, MgCl, MgBr, SnMe₃ or SnBu₃. Alternatively, compounds of Formula 1 wherein R² is C₂-C₃ alkenyl or C₂-C₃ alkynyl can be prepared by reacting compounds of Formula 1h with C₂-C₃ alkenes or C₂-C₃ alkynes of Formula 32 in the presence of a palladium catalyst such as tetrakis(triphenylphosphine)Pd(0), dichloro[1,1′-bis(diphenylphosphino)ferrocene]palladium or Pd(OAc)₂, optionally with the addition of copper(I) salts such as cuprous iodide, and advantageously in the presence of a base such as triethylamine, sodium acetate, potassium carbonate or sodium tert-butoxide. Procedures of this type may be found in PCT Patent Publications WO 2010/093885 and WO 2011/076725.

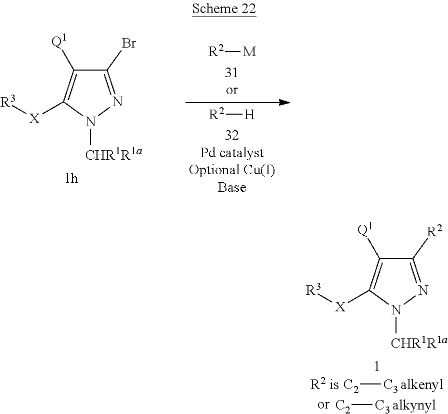

As shown in Scheme 23, compounds of Formula 1h can be prepared by reacting compounds of Formula 14a (i.e. Compound 14 wherein G is I and R² is Br) with compounds of Formula 15 using transition-metal-catalyzed cross-coupling reaction conditions similar to those described in Scheme 11.

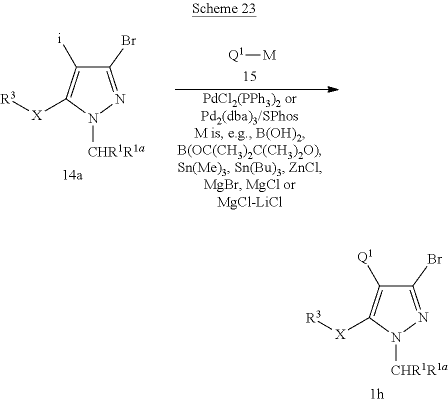

As shown in Scheme 24 compounds of Formula 14a wherein X is NH or O can be prepared by the Sandmeyer reaction of compounds of Formula 33 by conditions well-known to one skilled in the art. Conditions for such conversions can be found in PCT Patent Publication WO 2005/012256 and US Patent Publication 2011/0002879.

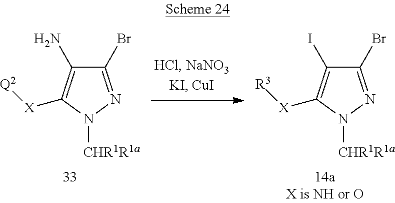

As illustrated in Scheme 25, compounds of Formula 33 in which X is NH or O can be prepared by reduction of compounds of Formula 34 with hydrogen in the presence a catalyst such as nickel under such conditions as described in Chemische Berichte 1955, 88, 866-74, or by use of a metal such as iron or zinc in the presence of an acidic medium such as acetic acid under such conditions as described in Berichte der Deutschen Chemischen Gesellschaft 1904, 37, 3520-3525, or by treatment with SnCl₂ as described in Chemische Berichte 1955, 88, 1577-85).

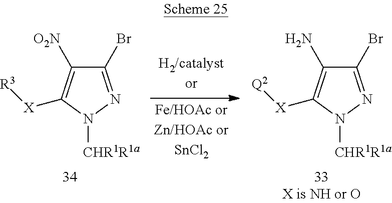

As shown in Scheme 26, compounds of Formula 34a (i.e. Formula 34 wherein X is NH) can be prepared by reacting compounds of Formula 35 with compounds of Formula 7 under the metal-catalyzed conditions described for Scheme 4. Also shown in Scheme 26, compounds of Formula 34b (i.e., Formula 35 wherein X is O) and Formula 34c (i.e., Formula 34 wherein X is S) can be prepared by reacting compounds of Formula 35 with compounds of Formulae 37 and 38, generally in the presence of a base such as sodium hydroxide, potassium carbonate, or sodium hydride. For general conditions, procedures and reagents, see PCT Patent Publication WO 93/15060.

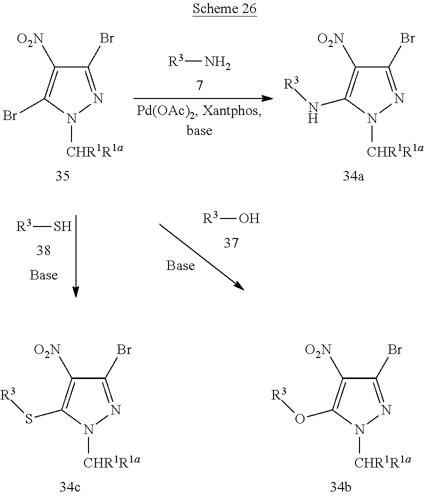

As shown in Scheme 27, compounds of Formula 14a can be prepared by reacting compounds of Formula 17b (i.e. Formula 17 wherein A is R³ and R² is Br) with an iodinating reagent, such as with iodine under such conditions as described in Journal of Heterocyclic Chemistry 1995, 32(4), 1351-4, or with N-iodosuccinimide (NIS), under conditions such as those disclosed in Journal of Medicinal Chemistry 1990, 33(1), 31-8.

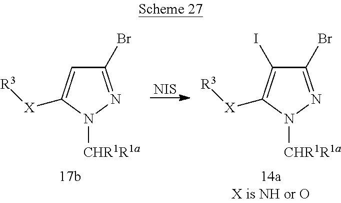

As shown in Scheme 28, compounds of Formula 17b wherein X is CR^{6a}OR^{6b} and R^{6b} is H) can be prepared by treatment of compounds of Formula 39 with carbonyl electrophiles of Formula 10 using the method described in Scheme 5. The compounds of Formula 10 are commercially available or prepared by general methods well-known in the art. Compounds of Formula 10 are known or are prepared by general methods well-known in the art.

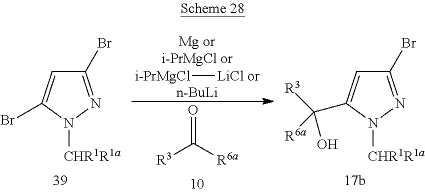

Compounds of Formula 1b (i.e. Formula 1 wherein X is NRS and R⁵ is H) wherein R² is halogen can be prepared as shown in Scheme 29. In this method an acetonitrile compound of Formula 40 is condensed with an isothiocyanate compound of Formula 23 in the presence of a base such as sodium hydride or potassium tert-butoxide, in a solvent such as N,N-dimethylformamide or tetrahydrofuran, to afford a cyano ketoamide intermediate compound, which is then reacted with a methylating agent such as iodomethane or dimethyl sulfate, in the presence of a base to provide the corresponding compound of Formula 41. Alternatively, the methylating agent can be included in the reaction mixture with the compounds of Formulae 40 and 23 without isolation of the cyano ketoamide intermediate. One skilled in the art will recognize that compounds of Formula 41 can also be prepared by a method analogous to Scheme 19 wherein the C(O)R² of the compound of Formula 21 is replaced by cyano. According to the method of Scheme 29, the resultant compound of Formula 41 is then reacted with an alkylhydrazine of Formula 19 to form the corresponding 3-aminopyrazole compound of Formula 42 using general procedures known in the art; see, for example, J. Chem. Soc. Perkin 1 1988, 2, 169-173 and J. Med. Chem. 2003, 46(7), 1229-1241. The amino group of the compound of Formula 42 can then be converted to R² being halogen in Formula 1b by a diazotization reaction using conditions known in the art, such as those previously described for Scheme 24.

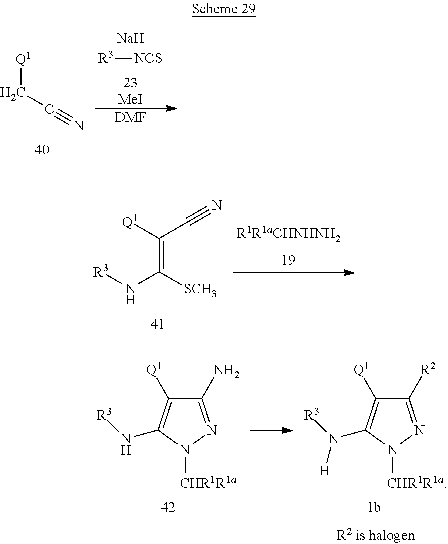

Analogous to the method of Scheme 29, compounds of Formula 2 wherein R² is halogen can be similarly prepared by condensing compounds of Formula 41 with hydrazine instead of an alkylhydrazine of Formula 19.

As shown in Scheme 30, compounds of Formula 1b (i.e. Formula 1 wherein X is NR⁵ and R⁵ is H) can be prepared by the reaction of substituted hydrazines of Formula 19 with dialkylaminothioacrylamides of Formula 43. The reaction in Scheme 30 can optionally be carried out in a variety of solvents, such as methanol, ethanol, isopropanol, tetrahydrofuran or 1,4-dioxane, or mixtures of these solvents with each other or with water, at temperatures from below ambient to the boiling point of the solvent or solvent mixture. The addition of an acid such as acetic acid, sulfuric acid or methanesulfonic acid, or a base such as sodium hydroxide, sodium hydrogen carbonate, potassium carbonate, sodium ethoxide, potassium tert-butoxide or triethylamine may be used to improve the rate of the reaction.

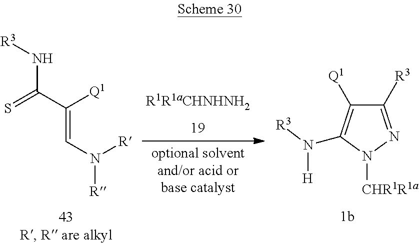

One skilled in the art will recognize that compounds of Formula 2 wherein R² is H can be prepared by the method of Scheme 30 by reaction of Compounds of Formula 43 with hydrazine instead of an alkyl hydrazine of Formula 19.

As shown in Scheme 31, compounds of Formula 43 can be prepared by reaction of thioamides of Formula 44 with such reagents as dimethylformamide dimethyl acetal, tert-butoxy-bis(dimethylamino)methane (Brederick's reagent), or by a two-stage reaction with a trialkyl orthoformate, such as triethyl orthoformate, followed by the addition of a dialkylamine such as dimethylamine or cyclic secondary amine such as piperidine or morpholine. Examples of analogous reactions are known in the literature (see for example Journal für Praktische Chemie (Leipzig) 1986, 328(1), 120-6). Compounds of Formula 44 are known or prepared by methods known in the art, such as those found in PCT Patent Publication WO 2010/018874.

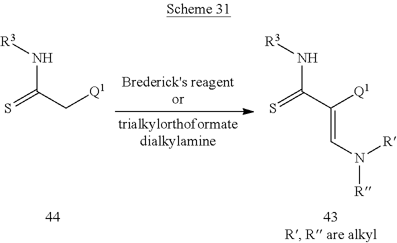

As shown in Scheme 32, compounds of Formula 35 wherein R^{1a} is H can be prepared by alkylating the 1H-pyrazole of Formula 45 with various alkylating agents of Formula 3, according to the method described in Scheme 2. The 1H-pyrazole of Formula 45 is commercially available.

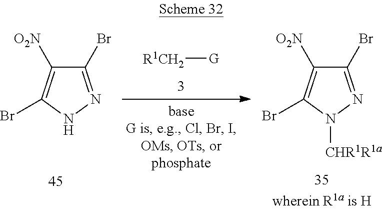

As shown in Scheme 33, compounds of Formula 35 wherein R^{1a} is taken together with R¹ and the carbon atom to which they are attached to form an optionally substituted cyclopropyl ring can be prepared by reacting the 1H-pyrazole of Formula 45 with a compound of Formula 46 in the presence of a copper catalyst and ligand. For example, boronic acids, boronate esters or trifluoroborate salts of Formula 46 are used in the presence of copper(II) acetate and a ligand such as 2,2′-bipyridyl, optionally in the presence of an added base such as sodium carbonate in a solvent such as dichloromethane or 1,2-dichloroethane, at temperatures ranging from room temperature to 90° C. For reagents, conditions and procedures see Tetrahedron Letters, 2010, 5(52), 6799-6801 and PCT Patent Publication 2009/134392. Alternatively compounds of Formula 35 wherein R^{1a} is other than H can be prepared by reacting the 1H-pyrazole of Formula 45 with trialkylbismuth reagents of Formula 47 under conditions similar to those utilized with compounds of Formula 46, as described in Journal of the American Chemical Society, 2007, 129(1), 44-45.

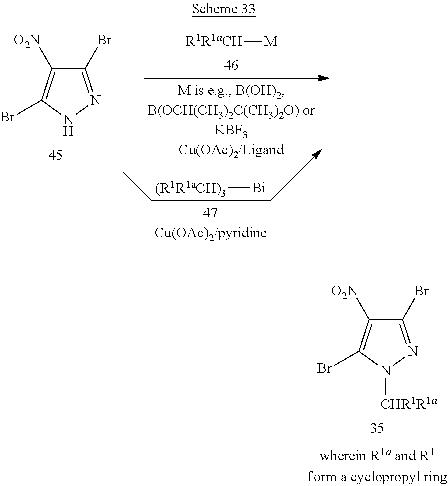

Compounds of Formula 2 wherein R² is Cl or Br, which are useful for preparing compounds of Formula 1 according to the method of Scheme 2, can be prepared by reaction of corresponding compounds of Formula 48 with POCl₃ or POBr₃ using general procedures known in the art, as shown in Scheme 34.

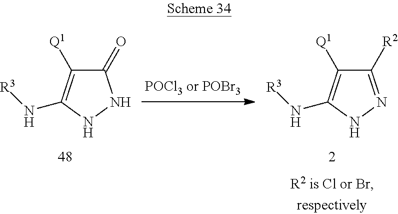

As shown in Scheme 35, compounds of Formula 1b (i.e. Formula 1 wherein X is NR⁵ and R⁵ is H) wherein R¹ and R^{1a} are H and R² is OCH₃ can be prepared by reacting corresponding compounds of Formula 48 with diazomethane or iodomethane in the presence of base using general procedures known in the art, such as those described in J. Heterocyclic Chem. 1988, 1307-1310.

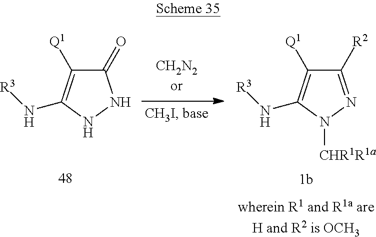

Compounds of Formula 1b (i.e. Formula 1 wherein X is NRS and R⁵ is H) wherein R¹ and R^{1a} are H and R² is SCH₃ can be prepared by treating corresponding compounds of Formula 48 with P₂S₅ or Lawesson's Reagent to prepare compounds of Formula 49, which are then reacted with diazomethane or iodomethane in the presence of base using general procedures known in the art, as shown in Scheme 36.

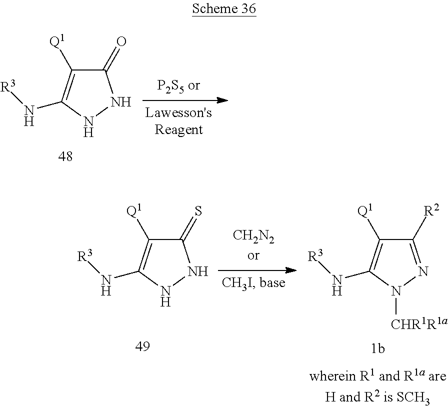

As shown in Scheme 37, compounds of Formula 48 can be prepared by condensation of corresponding isothiocyanates of Formula 23 with esters of Formula 50 wherein R³³ is lower alkyl (e.g., methyl, ethyl, propyl) in the presence of a strong, non-nucleophilic base such as sodium hydride or lithium hexamethyldisilazide, in an inert solvent such as tetrahydrofuran followed by reaction of the intermediate with hydrazine or an acid salt of hydrazine, such as, for example, an acetate or hydrochloride salt (analogous to the method of Scheme 29).

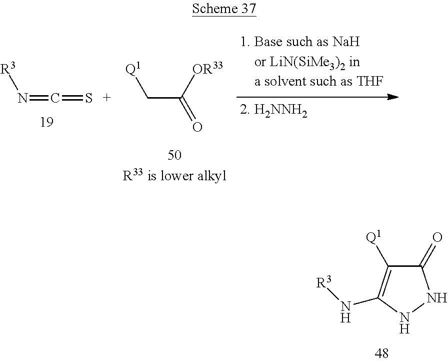

One skilled in the art will recognize that use of a substituted hydrazine of formula H₂NNHCHR¹R^{1a}, i.e. Formula 19, instead of unsubstituted hydrazine in the method of Scheme 37, followed by the further manipulations described for Schemes 34, 35 and 36 will also afford compounds of Formula 1b.

As shown in Scheme 38, sulfoxides and sulfones of Formula 1j (i.e. Formula 1 wherein X is S(═O)ₘ and m is 1 or 2) can be prepared by oxidation of compounds of Formula 1k (i.e. Formula 1 wherein X is S). Typically, an oxidizing agent in an amount from about 1 to 4 equivalents, depending on the oxidation state of the product desired, is added to a mixture of a compound of Formula 1k and a solvent. Useful oxidizing agents include Oxone® (potassium peroxymonosulfate), potassium permanganate, hydrogen peroxide, sodium periodate, peracetic acid and 3-chloroperbenzoic acid. The solvent is selected with regard to the oxidizing agent employed. Aqueous ethanol or aqueous acetone is preferably used with potassium peroxymonosulfate, and dichloromethane is generally preferable with 3-chloroperbenzoic acid. Useful reaction temperatures typically range from about −78 to 90° C. Oxidation reactions of this type are described by Brand et al., J. Agric. Food Chem. 1984, 32, 221-226 and Ouyang, et al., J. Agric. Food Chem. 2008, 56, 10160-10167.

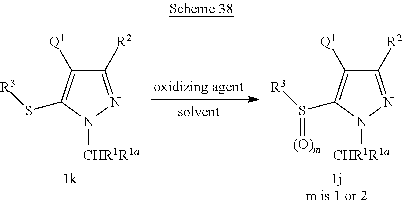

It is recognized by one skilled in the art that various functional groups can be converted into others to provide different compounds of Formula 1. For example, compounds of Formula 1 in which R² is methyl, ethyl, cyclopropyl, and the like, can be modified by free-radical halogenation to form compounds of Formula 1 wherein R² is halomethyl, haloethyl, halocyclopropyl, and the like. Compounds where R² is halomethyl can be used as intermediates to prepare compounds of Formula 1 wherein R² is hydroxymethyl or cyanomethyl. Compounds of Formula 1 or intermediates for their preparation may contain aromatic nitro groups, which can be reduced to amino groups, and then be converted via reactions well known in the art such as the Sandmeyer reaction, to various halides, providing other compounds of Formula 1. By similar known reactions, aromatic amines (anilines) can be converted via diazonium salts to phenols, which can then be alkylated to prepare compounds of Formula 1 with alkoxy substituents. Likewise, aromatic halides such as bromides or iodides prepared via the Sandmeyer reaction can react with alcohols under copper-catalyzed conditions, such as the Ullmann reaction or known modifications thereof, to provide compounds of Formula 1 that contain alkoxy substituents. Additionally, some halogen groups, such as fluorine or chlorine, can be displaced with alcohols under basic conditions to provide compounds of Formula 1 containing the corresponding alkoxy substituents. The resultant alkoxy compounds can themselves be used in further reactions to prepare compounds of Formula 1 wherein R⁴ is —U—V-T (see, for example, PCT Patent Publication WO 2007/149448). Compounds of Formula 1 or precursors thereof in which R² is halide, preferably bromide or iodide, are particularly useful intermediates for transition metal-catalyzed cross-coupling reactions to prepare compounds of Formula 1. These types of reactions are well documented in the literature; see, for example, Tsuji in Transition Metal Reagents and Catalysts: Innovations in Organic Synthesis, John Wiley and Sons, Chichester, 2002; Tsuji in Palladium in Organic Synthesis, Springer, 2005; and Miyaura and Buchwald in Cross Coupling Reactions: A Practical Guide, 2002; and references cited therein.

The above reactions can also in many cases be performed in alternate sequence. The presence of certain functional groups may not be compatible with all of these reaction conditions, and the use of protecting groups may be desirable for obtaining the desired products with improved yields and or purity.

It is recognized that some reagents and reaction conditions described above for preparing compounds of Formula 1 may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula 1. One skilled in the art will also recognize that it may be necessary to perform a combination of the steps illustrated in the above schemes in an order other than that implied by the particular sequence presented to prepare the compounds of Formula 1. One skilled in the art will also recognize that compounds of Formula 1 and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative, and not limiting of the disclosure in any way whatsoever. Steps in the following Examples illustrate a procedure for each step in an overall synthetic transformation, and the starting material for each step may not have necessarily been prepared by a particular preparative run whose procedure is described in other Examples or Steps. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; “s” means singlet, “d” means doublet, “t” means triplet, “q” means quartet, “m” means multiplet, “dd” means doublet of doublets, “dt” means doublet of triplets, “br s” means broad singlet.

### Example 1

### Preparation of N-cyclohexyl-4-(2,4-difluorophenyl)-1,3-dimethyl-1H-pyrazol-5-amine

To a mixture of potassium 2-methyl-2-butanol (1.7 M in toluene, 3.1 mmol) in tetrahydrofuran (5 mL) at approximately −8° C. was added a mixture of cyclohexyl isothiocyanate (0.53 g, 3.1 mmol) and 1-(2,4-difluorophenyl)-2-propanone (0.40 g, 2.8 mmol) in tetrahydrofuran (5 mL) dropwise over 5 minutes. The reaction mixture was stirred for 15 minutes, and then hydrochloric acid was added (1N, 2.5 mL). The mixture was extracted with ethyl acetate, and the combined organic extracts were washed with water and saturated aqueous sodium chloride, dried over magnesium sulfate, filtered and concentrated under reduced pressure. To a mixture of the resulting material in methanol (10 mL), glacial acetic acid (0.25 mL) and water (0.20 mL) was added methylhydrazine (0.14 g, 3.1 mmol). The reaction mixture was heated at reflux for 90 minutes, then concentrated under reduced pressure. The resulting material was purified by medium pressure liquid chromatography on silica gel (0 to 100% gradient of ethyl acetate in hexanes as eluant). The resulting material was purified by medium pressure liquid chromatography on silica gel (0 to 100% gradient of ethyl acetate in 1-chlorobutane as eluant) to provide the title compound (0.10 g), a compound of the present invention.

¹H NMR (CDCl₃): δ 7.19 (m, 1H), 6.92 (s, 2H), 3.70 (s, 3H), 2.93 (m, 1H), 2.68 (m, 1H), 2.12 (s, 3H), 1.75 (d, 2H), 1.58 (br s, 2H), 1.48 (m, 1H), 1.07 (d, 3H), 0.90 (m, 2H).

### Example 2

### Preparation of 1,3-dimethyl-5-(2-methylpropoxy)-4-(2,4,6-trifluorophenyl)-1H-pyrazole

To a mixture of 1,3-dimethyl-4-(2,4,6-trifluorophenyl)-1H-pyrazol-5-ol (1,3-dimethyl-4-(2,4,6-trifluorophenyl)-1H-pyrazol-5-one (prepared as described in PCT Patent Publication WO 2012/031061 A2) (47.5 mg, 0.196 mmol) and potassium carbonate (powder, 80 mg, 0.58 mmol) in N,N-dimethylformamide (2 mL), was added 1-bromo-2-methylpropane (0.11 mL, 1.0 mmol). The reaction mixture was stirred at room temperature for 72 h, and then heated at 80° C. for 3 h. After cooling to room temperature, the reaction mixture was partitioned between water (10 mL) and ethyl acetate (10 mL), the layers were separated and the aqueous phase was extracted with ethyl acetate (10 mL). The combined organics were washed with water (3×) and with saturated aqueous sodium chloride solution, dried over magnesium sulfate, filtered and concentrated under reduced pressure. The resulting material was purified by flash chromatography on a prepacked column of silica gel (5 g) eluting with 2:1 hexanes/ethyl acetate to provide the title compound, a compound of the present invention, as a clear viscous oil (0.045 g).

¹H NMR (CD₃COCD₃): δ 7.02 (m, 2H), 3.64 (d, 2H), 3.63 (s, 3H), 1.96 (s, 3H), 1.88 (m, 1H), 0.86 (d, 6H)

### Example 3

### Preparation of 4-(2-chloro-6-fluorophenyl)-1,3-dimethyl-α-(1-methylethyl)-1H-pyrazole-5-methanol

### Step A

### Preparation of α-acetyl-2-chloro-6-fluorobenzeneacetonitrile

To a mixture of 2-chloro-6-fluorophenylacetonitrile (10.0 g, 59.17 mmol) in toluene (100 ml) at 0° C. was added sodium methoxide (4.15 g, 76.9 mmol) in one portion. After stirring for 30 minutes at 0° C., ethyl acetate (30 mL) was added dropwise to the reaction mixture while maintaining the temperature at 0° C. The reaction mixture was allowed to warm to room temperature, then heated at 85° C. for 12 h, and then cooled to room temperature and diluted with ethyl acetate (150 mL). The resulting mixture was washed successively with hydrochloric acid (1.5 N, 150 mL), water (100 mL) and saturated aqueous sodium chloride solution (100 mL). The organic layer was dried over magnesium sulfate, filtered and concentrated under reduced pressure. The resulting material was purified by column chromatography on silica gel, eluting with 5% methyl tert-butyl ether in petroleum ether to provide the title compound as a pink-white solid (9.0 g).

¹H NMR (DMSO-d₆): δ 11.67 (br s, 1H), 7.48-7.21 (m, 3H), 2.27 (s, 3H).

### Step B

### Preparation of 4-(2-chloro-6-fluorophenyl)-1,3-dimethyl-1H-pyrazol-5-amine

To a mixture of α-acetyl-2-chloro-6-fluorobenzeneacetonitrile (i.e. the product of Step A) (9.0 g, 42.65 mmol) in ethanol (100 mL) at room temperature was added methylhydrazine sulfate (9.2 g, 63.98 mmol) and sodium acetate (5.97 g, 85.3 mmol). The reaction mixture was heated at 85° C. for 12 h, then cooled to room temperature and concentrated under reduced pressure. The resulting material was dissolved in ethyl acetate (150 mL) and washed with water (100 mL) and saturated aqueous sodium chloride solution (100 mL). The organic layer was dried over magnesium sulfate, filtered and concentrated under reduced pressure. The resulting material was purified by column chromatography on silica gel eluting with 1% methanol in chloroform to provide the title compound as a pale yellow viscous oil (6.37 g).

¹H NMR (DMSO-d₆): δ 7.38-7.31 (m, 2H), 7.24-7.19 (t, 1H), 5.0 (s, 2H), 3.49 (s, 3H), 1.81 (s, 3H).

### Step C

### Preparation of 5-bromo-4-(2-chloro-6-fluorophenyl)-1,3-dimethyl-1H-pyrazole

To a stirred mixture of 4-(2-chloro-6-fluorophenyl)-1,3-dimethyl-1H-pyrazol-5-amine (i.e. the product of Step B) (7.2 g, 30.06 mmol) and copper bromide (12.06 g, 54.11 mmol) in acetonitrile (70 mL) at 0° C. was added t-butyl nitrite (4.71 g, 0.05 mmol) dropwise over 10 minutes. The reaction mixture was stirred at room temperature for 2 h, then diluted with ethyl acetate (150 mL) and washed with water (100 mL) and saturated aqueous sodium chloride solution (100 mL). The organic layer was dried over magnesium sulfate, filtered and concentrated under reduced pressure. The resulting material was purified by column chromatography on silica gel eluting with 5% ethyl acetate in petroleum ether to provide the title compound as a yellowish oil (5.0 g).

¹H NMR (CDCl₃): δ 7.33-7.26 (m, 2H), 7.11-7.05 (t, 1H), 3.9 (s, 3H), 2.15 (s, 3H).

### Step D

### Preparation of 4-(2-chloro-6-fluorophenyl)-1,3-dimethyl-α-(1-methylethyl)-1H-pyrazole-5-methanol

To a mixture of 5-bromo-4-(2-chloro-6-fluorophenyl)-1,3-dimethyl-1H-pyrazole (5.0 g, 16.4 mmol) (i.e. the product of Step C) in tetrahydrofuran (50 mL) at −78° C. was added n-butyl lithium (1 M in hexanes, 24.7 mL, 24.7 mmol). The reaction mixture was stirred at −78° C. for 30 minutes, and then a solution of 2-methylpropanal (1.18 g, 16.4 mmol) in tetrahydrofuran (10 mL) was added dropwise while maintaining the reaction temperature at −78° C. The reaction mixture was allowed to warm to room temperature and stirred for 2 h, and then diluted with ethyl acetate (100 mL) and washed with water (100 mL) and saturated aqueous sodium chloride solution (100 mL). The organic layer was dried over magnesium sulfate, filtered and concentrated under reduced pressure. The resulting material was purified by column chromatography on silica gel eluting with 5% ethyl acetate in petroleum ether to provide the title compound, a compound of the present invention, as a yellow semi-solid (3.0 g).

¹H NMR (DMSO-d₆): δ 7.4-7.39 (m, 2H), 7.27-7.22 (t, 1H), 5.39 (d, 1H), 4.0-3.9 (m, 1H), 3.84 (s, 3H), 1.86 (s, 3H), 1.79-1.75 (m, 1H), 0.85-0.83 (d, 3H), 0.5-0.4 (d, 3H).

### Example 4

### Preparation of 4-(2-chloro-6-fluorophenyl)-N,1,3-trimethyl-α-(1-methylethyl)-1H-pyrazole-5-methanamine

### Step A

### Preparation of 4-(2-chloro-6-fluorophenyl)-5-(1-chloro-2-methylpropyl)-1,3-dimethyl-1H-pyrazole

To a mixture of 4-(2-chloro-6-fluorophenyl)-1,3-dimethyl-α-(1-methylethyl)-1H-pyrazole-5-methanol (i.e. the product of Example 3) (3.0 g, 10.1 mmol) in dichloromethane (30 mL) was added a catalytic amount of pyridine followed by thionyl chloride (2.4 g, 20.2 mmol). The reaction mixture was heated at 50° C. for 2 h, and then concentrated under reduced pressure. The resulting material was dissolved in ethyl acetate (100 mL) and washed with water (100 mL) and aqueous sodium chloride solution (100 mL). The organic layer was dried over magnesium sulfate, filtered and concentrated under reduced pressure. The resulting material was purified by column chromatography on silica gel eluting with 2% ethyl acetate in petroleum ether to provide title compound as a yellow liquid (2.0 g).

¹H NMR (CDCl₃): δ 7.35-7.3 (m, 2H), 7.15-7.14 (m, 1H), 4.27-4.24 (m, 1H), 4.02 (s, 3H), 2.33-2.27 (m, 1H), 2.09 (s, 3H), 1.14-1.12 (d, 3H), 0.75-0.72 (d, 3H).

### Step B

### Preparation of 4-(2-chloro-6-fluorophenyl)-N,1,3-trimethyl-α-(1-methylethyl)-1H-pyrazole-5-methanamine

To a mixture of 4-(2-chloro-6-fluorophenyl)-5-(1-chloro-2-methylpropyl)-1,3-dimethyl-1H-pyrazole (i.e. the product of Step A) (0.5 g, 1.58 mmol) in methanol (10 mL) was added methylamine (2 M in tetrahydrofuran, 2.37 mL, 47.5 mmol). The reaction mixture was stirred in a sealed tube at 50° C. for 12 h, and then concentrated under reduced pressure. The resulting material was dissolved in ethyl acetate (25 mL) and washed successively with aqueous sodium bicarbonate (10%, 25 mL), water (25 mL) and aqueous sodium chloride solution (25 mL). The organic layer was dried over magnesium sulfate, filtered and concentrated under reduced pressure. The resulting material was purified by column chromatography on silica gel eluting with 1% methanol in chloroform to provide title compound, a compound of the present invention, as colorless oil (0.1 g)

¹H NMR (CDCl₃): δ 7.32-7.29 (m, 2H), 7.09-7.04 (m, 1H), 3.95 (s, 3H), 3.63-3.59 (m, 1H), 3.31 (s, 3H), 2.06 (s, 3H), 1.99-1.97 (m, 1H), 0.91-0.88 (d, 3H), 0.71-0.64 (d, 3H).

### Example 5

### Preparation of 4-(2-chloro-6-fluorophenyl)-1,3-dimethyl-5-[2-methyl-1-(methylthio)propyl]-1H-pyrazole

To a mixture of 4-(2-chloro-6-fluorophenyl)-5-(1-chloro-2-methylpropyl)-1,3-dimethyl-1H-pyrazole (i.e. the product of Example 4, Step A) (0.5 g, 1.58 mmol) in N-methylpyrrolidone (10 mL) was added aqueous sodium thiomethoxide (25%, 2 equivalents). The reaction mixture was heated at 80° C. for 1 h, and then cooled to room temperature and diluted with ethyl acetate (25 mL). The resulting mixture was washed with water (25 mL) and aqueous sodium chloride solution (25 mL), and the organic layer was dried over magnesium sulfate, filtered and concentrated under reduced pressure. The resulting material was purified by column chromatography on silica gel eluting with 1% methanol in chloroform to provide the title compound, a compound of the present invention, as a colorless oil (0.14 g).

¹H NMR (CDCl₃): δ 7.32-7.27 (m, 2H), 7.05-7.1 (m, 1H), 4.01-3.9 (d, 3H), 3.28-3.25 (m, 1H), 2.08 (s, 3H), 2.05-2.02 (m, 1H), 1.9-1.71 (d, 3H), 1.27-1.1 (dd, 3H), 0.9-0.8 (dd, 3H).

By the procedures described herein together with methods known in the art, the compounds disclosed in the Tables that follow can be prepared. The following abbreviations are used in the Tables which follow: t means tertiary, s means secondary, n means normal, means iso, c means cyclo, Me means methyl, Et means ethyl, Pr means propyl, i-Pr means isopropyl, Bu means butyl, Ph means phenyl, MeO means methoxy, EtO means ethoxy and CN means cyano.

TABLE 1

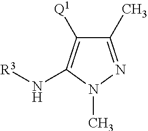

Q¹ is 2,4-di-F—Ph, and R² is Me.

| R³ | R³ |
|---|---|
| Et | i-Pr |
| n-Bu | c-Bu |
| n-pentyl | n-hexyl |
| c-hexyl | cyclohexen-1-yl |
| c-pentyl | 2-methylbutyl |
| neopentyl | CH(Me)CF₃ |
| CH₂CH═CH₂ | CH(Me)CN |
| CH₂CH═CHCl | CH₂-cyclohexyl |
| 2-MeO-1-Me—Et | CH₂-(2-Me-cyclopropyl) |
| 2,4-di-Me-cyclohexyl | CH₂-(1-Cl-cyclopropyl) |
| CH₂CH═CHMe₂ | 1,1-dioxothientan-3-yl |
| tetrahydropyran-4-yl | CH₂-cyclopentyl |
| CH₂C≡CH | CH═CH₂ |
| [1,1′-bicyclopropyl]-2-yl | CH₂C(Me)═NOMe |
| C(Me)₂CH₂CH₂CN | 2-oxocyclohexyl |
| n-Pr | c-propyl |
| s-Bu | t-Bu |
| 1,2-dimethylbutyl | i-pentyl |
| i-Bu | 1-ethylpropyl |
| 2-Me-cyclopentyl | CH₂-cyclopropyl |
| CH(Me)C≡CH | CH₂CH(Me)CF₃ |
| CH₂CN | CH₂C(Me)═CHMe |
| CH₂CH═CCl₂ | 2-MeO—Pr |
| CH₂CF₃ | 2-Me-cyclohexyl |
| CH(Me)-cyclopropyl | 4-morpholinyl |
| thien-3-yl | oxetan-3-yl |
| CH₂C≡CMe | tetrahydrofuran-3-yl |
| tetrahydrothiophen-3-yl | CH₂CH═CHMe |
| CH₂C(Me)═CH₂ | 3-Me-1,3-dioxan-4-yl |
| CH₂C(Me)═CMe₂ | 2,2-dimethylthietan-3-yl |

The present disclosure also includes Tables 1A through 92A, each of which is constructed the same as Table 1 above, except that the row heading in Table 1 (i.e. “Q¹ is 2,4-di-F-Ph, and R² is Me.”) is replaced with the respective row headings shown below. For Example, in Table 1A the row heading is “Q¹ is 2,6-di-F-Ph and R² is Me”, and R³ is as defined in Table 1 above. Thus, the first entry in Table 1A specifically discloses 4-(2,6-difluorophenyl)-N-ethyl-1,3-dimethyl-1H-pyrazole-5-amine. Tables 2A through 92A are constructed similarly.

| Table | Row Heading |
|---|---|
| 1A | Q¹ is 2,6-di-F—Ph and R² is Me. |
| 2A | Q¹ is 2,4,6-tri-F—Ph and R² is Me. |
| 3A | Q¹ is 2,6-di-F-4-MeO—Ph and R² is Me. |
| 4A | Q¹ is 2,6-di-F-4-EtO—Ph and R² is Me. |
| 5A | Q¹ is 2,6-di-F-4-CN—Ph and R² is Me. |
| 6A | Q¹ is 2,6-di-F-3-MeO—Ph and R² is Me. |
| 7A | Q¹ is is 2,6-di-F-3-EtO—Ph and R² is Me. |
| 8A | Q¹ is is 2,6-di-F-3-CN—Ph and R² is Me. |
| 9A | Q¹ is is 2,4,5-tri-F—Ph and R² is Me. |
| 10A | Q¹ is 2,4-di-Cl—Ph and R² is Me. |
| 11A | Q¹ is 2,6-di-Cl—Ph and R² is Me. |
| 12A | Q¹ is 2-Cl-4-F—Ph and R² is Me. |
| 13A | Q¹ is 2-Cl-6-F—Ph and R² is Me. |
| 14A | Q¹ is 2-Br-4-F—Ph and R² is Me. |
| 15A | Q¹ is 2-Br-6-F—Ph and R² is Me. |
| 16A | Q¹ is 2-F-4-MeO—Ph and R² is Me. |
| 17A | Q¹ is 2-Cl-4-MeO—Ph and R² is Me. |
| 18A | Q¹ is 2-Br-4-MeO—Ph and R² is Me. |
| 19A | Q¹ is 2-F-4-EtO—Ph and R² is Me. |
| 20A | Q¹ is 2-Cl-4-EtO—Ph and R² is Me. |
| 21A | Q¹ is 2-Br-4-EtO—Ph and R² is Me. |
| 22A | Q¹ is 2-F-4-Me—Ph and R² is Me. |
| 23A | Q¹ is 2-Cl-4-Me—Ph and R² is Me. |
| 24A | Q¹ 2-Br-4-Me—Ph and R² is Me. |
| 25A | Q¹ is 2-Me-4-Me—Ph and R² is Me. |
| 26A | Q¹ is 2-Me-4-F—Ph and R² is Me. |
| 27A | Q¹ is 2-Me-4-MeO—Ph and R² is Me. |
| 28A | Q¹ is 2-Me-4-EtO—Ph and R² is Me. |
| 29A | Q¹ is cyclohexyl and R² is Me. |
| 30A | Q¹ is 2-Me-cyclohexyl and R² is Me. |
| 31A | Q¹ is 2,4-di-F—Ph and R² is Cl. |
| 32A | Q¹ is 2,6-di-F—Ph and R² is Cl. |
| 33A | Q¹ is 2,4,6-tri-F—Ph and R² is Cl. |
| 34A | Q¹ is 2,6-di-F-4-MeO—Ph and R² is Cl. |
| 35A | Q¹ is 2,6-di-F-4-EtO—Ph and R² is Cl. |
| 36A | Q¹ is 2,6-di-F-4-CN—Ph and R² is Cl. |
| 37A | Q¹ is 2,6-di-F-3-MeO—Ph and R² is Cl. |
| 38A | Q¹ is 2,6-di-F-3-EtO—Ph and R² is Cl. |
| 39A | Q¹ is 2,6-di-F-3-CN—Ph and R² is Cl. |
| 40A | Q¹ is 2,4,5-tri-F—Ph and R² is Cl. |
| 41A | Q¹ is 2,4-di-Cl—Ph and R² is Cl. |
| 42A | Q¹ is 2,6-di-Cl—Ph and R² is Cl. |
| 43A | Q¹ is 2-Cl-4-F—Ph and R² is Cl. |
| 44A | Q¹ is 2-Cl-6-F—Ph and R² is Cl. |
| 45A | Q¹ is 2-Br-4-F—Ph and R² is Cl. |
| 46A | Q¹ is 2-Br-6-F—Ph and R² is Cl. |
| 47A | Q¹ is 2-F-4-MeO—Ph and R² is Cl. |
| 48A | Q¹ is 2-Cl-4-MeO—Ph and R² is Cl. |
| 49A | Q¹ is 2-Br-4-MeO—Ph and R² is Cl. |
| 50A | Q¹ is 2-F-4-EtO—Ph and R² is Cl. |
| 51A | Q¹ is 2-Cl-4-EtO—Ph and R² is Cl. |
| 52A | Q¹ is 2-Br-4-EtO—Ph and R² is Cl. |
| 53A | Q¹ is 2-F-4-Me—Ph and R² is Cl. |
| 54A | Q¹ is 2-Cl-4-Me—Ph and R² is Cl |
| 55A | Q¹ is 2-Br-4-Me—Ph and R² is Cl. |
| 56A | Q¹ is 2-Me-4-Me—Ph and R² is Cl. |
| 57A | Q¹ is 2-Me-4-F—Ph and R² is Cl. |
| 58A | Q¹ is 2-Me-4-MeO—Ph and R² is Cl. |
| 59A | Q¹ is 2-Me-4-EtO—Ph and R² is Cl. |
| 60A | Q¹ is cyclohexyl and R² is Cl. |
| 61A | Q¹ is 2-Me-cyclohexyl and R² is Cl. |
| 62A | Q¹ is 2,4-di-F—Ph and R² is Br. |
| 63A | Q¹ is 2,6-di-F—Ph and R² is Br. |
| 64A | Q¹ is 2,4,6-tri-F—Ph and R² is Br. |
| 65A | Q¹ is 2,6-di-F-4-MeO—Ph and R² is Br. |
| 66A | Q¹ is 2,6-di-F-4-EtO—Ph and R² is Br. |
| 67A | Q¹ is 2,6-di-F-4-CN—Ph and R² is Br. |
| 68A | Q¹ is 2,6-di-F-3-MeO—Ph and R² is Br. |
| 69A | Q¹ is 2,6-di-F-3-EtO—Ph and R² is Br. |
| 70A | Q¹ is 2,6-di-F-3-CN—Ph and R² is Br. |
| 71A | Q¹ is 2,4,5-tri-F—Ph and R² is Br. |
| 72A | Q¹ is 2,4-di-Cl—Ph and R² is Br. |
| 73A | Q¹ is 2,6-di-Cl—Ph and R² is Br. |
| 74A | Q¹ is 2-Cl-4-F—Ph and R² is Br. |
| 75A | Q¹ is 2-Cl-6-F—Ph and R² is Br. |
| 76A | Q¹ is 2-Br-4-F—Ph and R² is Br. |
| 77A | Q¹ is 2-Br-6-F—Ph and R² is Br. |
| 78A | Q¹ is 2-F-4-MeO—Ph and R² is Br |
| 79A | Q¹ is 2-Cl-4-MeO—Ph and R² is Br. |
| 80A | Q¹ is 2-Br-4-MeO—Ph and R² is Br. |
| 81A | Q¹ is 2-F-4-EtO—Ph and R² is Br. |
| 82A | Q¹ is 2-Cl-4-EtO—Ph and R² is Cl. |
| 83A | Q¹ is 2-Br-4-EtO—Ph and R² is Br. |
| 84A | Q¹ is 2-F-4-Me—Ph and R² is Br. |
| 85A | Q¹ is 2-Cl-4-Me—Ph and R² is Br. |
| 86A | Q¹ is 2-Br-4-Me—Ph and R² is Br. |
| 87A | Q¹ is 2-Me-4-Me—Ph and R² is Br. |
| 88A | Q¹ is 2-Me-4-F—Ph and R² is Br. |
| 89A | Q¹ is 2-Me-4-MeO—Ph and R² is Br |
| 90A | Q¹ is 2-Me-4-EtO—Ph and R² is Br. |
| 91A | Q¹ is cyclohexyl and R² is Br. |
| 92A | Q¹ is 2-Me-cyclohexyl and R² is Br. |

TABLE 2

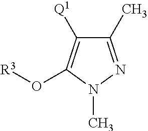

Q¹ is 2,4-di-F—Ph, and R² is Me.

| R³ | R³ |
|---|---|
| Et | i-Pr |
| n-Bu | c-Bu |
| n-pentyl | n-hexyl |
| cyclohexyl | cyclohexen-1-yl |
| cyclopentyl | 2-methylbutyl |
| neopentyl | CH(Me)CF₃ |
| CH₂CH═CH₂ | CH(Me)CN |
| CH₂CH═CHCl | CH₂-cyclohexyl |
| 2-MeO-1-Me—Et | CH₂-(2-Me-cyclopropyl) |
| 2,4-di-Me-cyclohexyl | CH₂-(1-Cl-cyclopropyl) |
| CH₂CH═CHMe₂ | 1,1-dioxothientan-3-yl |
| tetrahydropyran-4-yl | CH₂-cyclopentyl |
| CH₂C≡CH | CH═CH₂ |
| [1,1′-bicyclopropyl]-2-yl | CH₂C(Me)═NOMe |
| C(Me)₂CH₂CH₂CN | 2-oxocyclohexyl |
| n-Pr | cyclopropyl |
| s-Bu | t-Bu |
| 1,2-dimethylbutyl | i-pentyl |
| i-Bu | 1-ethylpropyl |
| 2-Me-cyclopentyl | CH₂-cyclopropyl |
| CH(Me)C≡CH | CH₂CH(Me)CF₃ |
| CH₂CN | CH₂C(Me)═CHMe |
| CH₂CH═CCl₂ | 2-MeO—Pr |
| CH₂CF₃ | 2-Me-cyclohexyl |
| CH(Me)-cyclopropyl | 4-morpholinyl |
| thien-3-yl | oxetan-3-yl |
| CH₂C≡CMe | tetrahydrofuran-3-yl |
| tetrahydrothiophen-3-yl | CH₂CH═CHMe |
| CH₂C(Me)═CH₂ | 3-Me-1,3-dioxan-4-yl |
| CH₂C(Me)═CMe₂ | 2,2-dimethylthietan-3-yl |

The present disclosure also includes Tables 1B through 92B, each of which is constructed the same as Table 2 above, except that the row heading in Table 2 (i.e. “Q¹ is 2,4-di-F-Ph, and R² is Me.”) is replaced with the respective row headings shown below. For Example, in Table 1B the row heading is “Q¹ is 2,6-di-F-Ph, and R² is Me”, and R³ is as defined in Table 2 above. Thus, the first entry in Table 1B specifically discloses 4-(2,6-difluorophenyl)-5-ethoxy-1,3-dimethyl-1H-pyrazole. Tables 2B through 92B are constructed similarly.

| Table | Row Heading |
|---|---|
| 1B | Q¹ is 2,6-di-F—Ph and R² is Me. |
| 2B | Q¹ is 2,4,6-tri-F—Ph and R² is Me. |
| 3B | Q¹ is 2,6-di-F-4-MeO—Ph and R² is Me. |
| 4B | Q¹ is 2,6-di-F-4-EtO—Ph and R² is Me. |
| 5B | Q¹ is 2,6-di-F-4-CN—Ph and R² is Me. |
| 6B | Q¹ is 2,6-di-F-3-MeO—Ph and R² is Me. |
| 7B | Q¹ is is 2,6-di-F-3-EtO—Ph and R² is Me. |
| 8B | Q¹ is is 2,6-di-F-3-CN—Ph and R² is Me. |
| 9B | Q¹ is is 2,4,5-tri-F—Ph and R² is Me. |
| 10B | Q¹ is 2,4-di-Cl—Ph and R² is Me. |
| 11B | Q¹ is 2,6-di-Cl—Ph and R² is Me. |
| 12B | Q¹ is 2-Cl-4-F—Ph and R² is Me. |
| 13B | Q¹ is 2-Cl-6-F—Ph and R² is Me. |
| 14B | Q¹ is 2-Br-4-F—Ph and R² is Me. |
| 15B | Q¹ is 2-Br-6-F—Ph and R² is Me. |
| 16B | Q¹ is 2-F-4-MeO—Ph and R² is Me. |
| 17B | Q¹ is 2-Cl-4-MeO—Ph and R² is Me. |
| 18B | Q¹ is 2-Br-4-MeO—Ph and R² is Me. |
| 19B | Q¹ is 2-F-4-EtO—Ph and R² is Me. |
| 20B | Q¹ is 2-Cl-4-EtO—Ph and R² is Me. |
| 21B | Q¹ is 2-Br-4-EtO—Ph and R² is Me. |
| 22B | Q¹ is 2-F-4-Me—Ph and R² is Me. |
| 23B | Q¹ is 2-Cl-4-Me—Ph and R² is Me. |
| 24B | Q¹ 2-Br-4-Me—Ph and R² is Me. |
| 25B | Q¹ is 2-Me-4-Me—Ph and R² is Me. |
| 26B | Q¹ is 2-Me-4-F—Ph and R² is Me. |
| 27B | Q¹ is 2-Me-4-MeO—Ph and R² is Me. |
| 28B | Q¹ is 2-Me-4-EtO—Ph and R² is Me. |
| 29B | Q¹ is cyclohexyl and R² is Me. |
| 30B | Q¹ is 2-Me-cyclohexyl and R² is Me. |
| 31B | Q¹ is 2,4-di-F—Ph and R² is Cl. |
| 32B | Q¹ is 2,6-di-F—Ph and R² is Cl. |
| 33B | Q¹ is 2,4,6-tri-F—Ph and R² is Cl. |
| 34B | Q¹ is 2,6-di-F-4-MeO—Ph and R² is Cl. |
| 35B | Q¹ is 2,6-di-F-4-EtO—Ph and R² is Cl. |
| 36B | Q¹ is 2,6-di-F-4-CN—Ph and R² is Cl. |
| 37B | Q¹ is 2,6-di-F-3-MeO—Ph and R² is Cl. |
| 38B | Q¹ is 2,6-di-F-3-EtO—Ph and R² is Cl. |
| 39B | Q¹ is 2,6-di-F-3-CN—Ph and R² is Cl. |
| 40B | Q¹ is 2,4,5-tri-F—Ph and R² is Cl. |
| 41B | Q¹ is 2,4-di-Cl—Ph and R² is Cl. |
| 42B | Q¹ is 2,6-di-Cl—Ph and R² is Cl. |
| 43B | Q¹ is 2-Cl-4-F—Ph and R² is Cl. |
| 44B | Q¹ is 2-Cl-6-F—Ph and R² is Cl. |
| 45B | Q¹ is 2-Br-4-F—Ph and R² is Cl. |
| 46B | Q¹ is 2-Br-6-F—Ph and R² is Cl. |
| 47B | Q¹ is 2-F-4-MeO—Ph and R² is Cl. |
| 48B | Q¹ is 2-Cl-4-MeO—Ph and R² is Cl. |
| 49B | Q¹ is 2-Br-4-MeO—Ph and R² is Cl. |
| 50B | Q¹ is 2-F-4-EtO—Ph and R² is Cl. |
| 51B | Q¹ is 2-Cl-4-EtO—Ph and R² is Cl. |
| 52B | Q¹ is 2-Br-4-EtO—Ph and R² is Cl. |
| 53B | Q¹ is 2-F-4-Me—Ph and R² is Cl. |
| 54B | Q¹ is 2-Cl-4-Me—Ph and R² is Cl |
| 55B | Q¹ is 2-Br-4-Me—Ph and R² is Cl. |
| 56B | Q¹ is 2-Me-4-Me—Ph and R² is Cl. |
| 57B | Q¹ is 2-Me-4-F—Ph and R² is Cl. |
| 58B | Q¹ is 2-Me-4-MeO—Ph and R² is Cl. |
| 59B | Q¹ is 2-Me-4-EtO—Ph and R² is Cl. |
| 60B | Q¹ is cyclohexyl and R² is Cl. |
| 61B | Q¹ is 2-Me-cyclohexyl and R² is Cl. |
| 62B | Q¹ is 2,4-di-F—Ph and R² is Br. |
| 63B | Q¹ is 2,6-di-F—Ph and R² is Br. |
| 64B | Q¹ is 2,4,6-tri-F—Ph and R² is Br. |
| 65B | Q¹ is 2,6-di-F-4-MeO—Ph and R² is Br. |
| 66B | Q¹ is 2,6-di-F-4-EtO—Ph and R² is Br. |
| 67B | Q¹ is 2,6-di-F-4-CN—Ph and R² is Br. |
| 68B | Q¹ is 2,6-di-F-3-MeO—Ph and R² is Br. |
| 69B | Q¹ is 2,6-di-F-3-EtO—Ph and R² is Br. |
| 70B | Q¹ is 2,6-di-F-3-CN—Ph and R² is Br. |
| 71B | Q¹ is 2,4,5-tri-F—Ph and R² is Br. |
| 72B | Q¹ is 2,4-di-Cl—Ph and R² is Br. |
| 73B | Q¹ is 2,6-di-Cl—Ph and R² is Br. |
| 74B | Q¹ is 2-Cl-4-F—Ph and R² is Br. |
| 75B | Q¹ is 2-Cl-6-F—Ph and R² is Br. |
| 76B | Q¹ is 2-Br-4-F—Ph and R² is Br. |
| 77B | Q¹ is 2-Br-6-F—Ph and R² is Br. |
| 78B | Q¹ is 2-F-4-MeO—Ph and R² is Br |
| 79B | Q¹ is 2-Cl-4-MeO—Ph and R² is Br. |
| 80B | Q¹ is 2-Br-4-MeO—Ph and R² is Br. |
| 81B | Q¹ is 2-F-4-EtO—Ph and R² is Br. |
| 82B | Q¹ is 2-Cl-4-EtO—Ph and R² is Cl. |
| 83B | Q¹ is 2-Br-4-EtO—Ph and R² is Br. |
| 84B | Q¹ is 2-F-4-Me—Ph and R² is Br. |
| 85B | Q¹ is 2-Cl-4-Me—Ph and R² is Br. |
| 86B | Q¹ is 2-Br-4-Me—Ph and R² is Br. |
| 87B | Q¹ is 2-Me-4-Me—Ph and R² is Br. |
| 88B | Q¹ is 2-Me-4-F—Ph and R² is Br. |
| 89B | Q¹ is 2-Me-4-MeO—Ph and R² is Br |
| 90B | Q¹ is 2-Me-4-EtO—Ph and R² is Br. |
| 91B | Q¹ is cyclohexyl and R² is Br. |
| 92B | Q¹ is 2-Me-cyclohexyl and R² is Br. |

TABLE 3

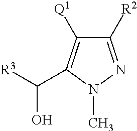

Q¹ is 2,4-di-F—Ph, and R² is Me.

| R³ | R³ |
|---|---|
| Et | i-Pr |
| n-Bu | c-Bu |
| n-pentyl | n-hexyl |
| cyclohexyl | cyclohexen-1-yl |
| cyclopentyl | 2-methylbutyl |
| neopentyl | CH(Me)CF₃ |
| CH₂CH═CH₂ | CH(Me)CN |
| CH₂CH═CHCl | CH₂-cyclohexyl |
| 2-MeO-1-Me—Et | CH₂-(2-Me-cyclopropyl) |
| 2,4-di-Me-cyclohexyl | CH₂-(1-Cl-cyclopropyl) |
| CH₂CH═CHMe₂ | 1,1-dioxothientan-3-yl |
| tetrahydropyran-4-yl | CH₂-cyclopentyl |
| CH₂C≡CH | CH═CH₂ |
| [1,1′-bicyclopropyl]-2-yl | CH₂C(Me)═NOMe |
| C(Me)₂CH₂CH₂CN | 2-oxocyclohexyl |
| n-Pr | cyclopropyl |
| s-Bu | t-Bu |
| 1,2-dimethylbutyl | i-pentyl |
| i-Bu | 1-ethylpropyl |
| 2-Me-cyclopentyl | CH₂-cyclopropyl |
| CH(Me)C≡CH | CH₂CH(Me)CF₃ |
| CH₂CN | CH₂C(Me)═CHMe |
| CH₂CH═CCl₂ | 2-MeO—Pr |
| CH₂CF₃ | 2-Me-cyclohexyl |
| CH(Me)-cyclopropyl | 4-morpholinyl |
| thien-3-yl | oxetan-3-yl |
| CH₂C≡CMe | tetrahydrofuran-3-yl |
| tetrahydrothiophen-3-yl | CH₂CH═CHMe |
| CH₂C(Me)═CH₂ | 3-Me-1,3-dioxan-4-yl |
| CH₂C(Me)═CMe₂ | 2,2-dimethylthietan-3-yl |

The present disclosure also includes Tables 1C through 92C, each of which is constructed the same as Table 3 above, except that the row heading in Table 3 (i.e. “Q¹ is 2,4-di-F-Ph, and R² is Me.”) is replaced with the respective row headings shown below. For Example, in Table 1C the row heading is “Q¹ is 2,6-di-F-Ph, and R² is Me”, and R³ is as defined in Table 3 above. Thus, the first entry in Table 1C specifically discloses 4-(2,6-difluorophenyl)-α-ethyl-1,3-dimethyl-1H-pyrazole-5-methanol. Tables 2C through 92C are constructed similarly.

| Table | Row Heading |
|---|---|
| 1C | Q¹ is 2,6-di-F—Ph and R² is Me. |
| 2C | Q¹ is 2,4,6-tri-F—Ph and R² is Me. |
| 3C | Q¹ is 2,6-di-F-4-MeO—Ph and R² is Me. |
| 4C | Q¹ is 2,6-di-F-4-EtO—Ph and R² is Me. |
| 5C | Q¹ is 2,6-di-F-4-CN—Ph and R² is Me. |
| 6C | Q¹ is 2,6-di-F-3-MeO—Ph and R² is Me. |
| 7C | Q¹ is is 2,6-di-F-3-EtO—Ph and R² is Me. |
| 8C | Q¹ is is 2,6-di-F-3-CN—Ph and R² is Me. |
| 9C | Q¹ is is 2,4,5-tri-F—Ph and R² is Me. |
| 10C | Q¹ is 2,4-di-Cl—Ph and R² is Me. |
| 11C | Q¹ is 2,6-di-Cl—Ph and R² is Me. |
| 12C | Q¹ is 2-Cl-4-F—Ph and R² is Me. |
| 13C | Q¹ is 2-Cl-6-F—Ph and R² is Me. |
| 14C | Q¹ is 2-Br-4-F—Ph and R² is Me. |
| 15C | Q¹ is 2-Br-6-F—Ph and R² is Me. |
| 16C | Q¹ is 2-F-4-MeO—Ph and R² is Me. |
| 17C | Q¹ is 2-Cl-4-MeO—Ph and R² is Me. |
| 18C | Q¹ is 2-Br-4-MeO—Ph and R² is Me. |
| 19C | Q¹ is 2-F-4-EtO—Ph and R² is Me. |
| 20C | Q¹ is 2-Cl-4-EtO—Ph and R² is Me. |
| 21C | Q¹ is 2-Br-4-EtO—Ph and R² is Me. |
| 22C | Q¹ is 2-F-4-Me—Ph and R² is Me. |
| 23C | Q¹ is 2-Cl-4-Me—Ph and R² is Me. |
| 24C | Q¹ 2-Br-4-Me—Ph and R² is Me. |
| 25C | Q¹ is 2-Me-4-Me—Ph and R² is Me. |
| 26C | Q¹ is 2-Me-4-F—Ph and R² is Me. |
| 27C | Q¹ is 2-Me-4-MeO—Ph and R² is Me. |
| 28C | Q¹ is 2-Me-4-EtO—Ph and R² is Me. |
| 29C | Q¹ is cyclohexyl and R² is Me. |
| 30C | Q¹ is 2-Me-cyclohexyl and R² is Me. |
| 31C | Q¹ is 2,4-di-F—Ph and R² is Cl. |
| 32C | Q¹ is 2,6-di-F—Ph and R² is Cl. |
| 33C | Q¹ is 2,4,6-tri-F—Ph and R² is Cl. |
| 34C | Q¹ is 2,6-di-F-4-MeO—Ph and R² is Cl. |
| 35C | Q¹ is 2,6-di-F-4-EtO—Ph and R² is Cl. |
| 36C | Q¹ is 2,6-di-F-4-CN—Ph and R² is Cl. |
| 37C | Q¹ is 2,6-di-F-3-MeO—Ph and R² is Cl. |
| 38C | Q¹ is 2,6-di-F-3-EtO—Ph and R² is Cl. |
| 39C | Q¹ is 2,6-di-F-3-CN—Ph and R² is Cl. |
| 40C | Q¹ is 2,4,5-tri-F—Ph and R² is Cl. |
| 41C | Q¹ is 2,4-di-Cl—Ph and R² is Cl. |
| 42C | Q¹ is 2,6-di-Cl—Ph and R² is Cl. |
| 43C | Q¹ is 2-Cl-4-F—Ph and R² is Cl. |
| 44C | Q¹ is 2-Cl-6-F—Ph and R² is Cl. |
| 45C | Q¹ is 2-Br-4-F—Ph and R² is Cl. |
| 46C | Q¹ is 2-Br-6-F—Ph and R² is Cl. |
| 47C | Q¹ is 2-F-4-MeO—Ph and R² is Cl. |
| 48C | Q¹ is 2-Cl-4-MeO—Ph and R² is Cl. |
| 49C | Q¹ is 2-Br-4-MeO—Ph and R² is Cl. |
| 50C | Q¹ is 2-F-4-EtO—Ph and R² is Cl. |
| 51C | Q¹ is 2-Cl-4-EtO—Ph and R² is Cl. |
| 52C | Q¹ is 2-Br-4-EtO—Ph and R² is Cl. |
| 53C | Q¹ is 2-F-4-Me—Ph and R² is Cl. |
| 54C | Q¹ is 2-Cl-4-Me—Ph and R² is Cl |
| 55C | Q¹ is 2-Br-4-Me—Ph and R² is Cl. |
| 56C | Q¹ is 2-Me-4-Me—Ph and R² is Cl. |
| 57C | Q¹ is 2-Me-4-F—Ph and R² is Cl. |
| 58C | Q¹ is 2-Me-4-MeO—Ph and R² is Cl. |
| 59C | Q¹ is 2-Me-4-EtO—Ph and R² is Cl. |
| 60C | Q¹ is cyclohexyl and R² is Cl. |
| 61C | Q¹ is 2-Me-cyclohexyl and R² is Cl. |
| 62C | Q¹ is 2,4-di-F—Ph and R² is Br. |
| 63C | Q¹ is 2,6-di-F—Ph and R² is Br. |
| 64C | Q¹ is 2,4,6-tri-F—Ph and R² is Br. |
| 65C | Q¹ is 2,6-di-F-4-MeO—Ph and R² is Br. |
| 66C | Q¹ is 2,6-di-F-4-EtO—Ph and R² is Br. |
| 67C | Q¹ is 2,6-di-F-4-CN—Ph and R² is Br. |
| 68C | Q¹ is 2,6-di-F-3-MeO—Ph and R² is Br. |
| 69C | Q¹ is 2,6-di-F-3-EtO—Ph and R² is Br. |
| 70C | Q¹ is 2,6-di-F-3-CN—Ph and R² is Br. |
| 71C | Q¹ is 2,4,5-tri-F—Ph and R² is Br. |
| 72C | Q¹ is 2,4-di-Cl—Ph and R² is Br. |
| 73C | Q¹ is 2,6-di-Cl—Ph and R² is Br. |
| 74C | Q¹ is 2-Cl-4-F—Ph and R² is Br. |
| 75C | Q¹ is 2-Cl-6-F—Ph and R² is Br. |
| 76C | Q¹ is 2-Br-4-F—Ph and R² is Br. |
| 77C | Q¹ is 2-Br-6-F—Ph and R² is Br. |
| 78C | Q¹ is 2-F-4-MeO—Ph and R² is Br |
| 79C | Q¹ is 2-Cl-4-MeO—Ph and R² is Br. |
| 80C | Q¹ is 2-Br-4-MeO—Ph and R² is Br. |
| 81C | Q¹ is 2-F-4-EtO—Ph and R² is Br. |
| 82C | Q¹ is 2-Cl-4-EtO—Ph and R² is Cl. |
| 83C | Q¹ is 2-Br-4-EtO—Ph and R² is Br. |
| 84C | Q¹ is 2-F-4-Me—Ph and R² is Br. |
| 85C | Q¹ is 2-Cl-4-Me—Ph and R² is Br. |
| 86C | Q¹ is 2-Br-4-Me—Ph and R² is Br. |
| 87C | Q¹ is 2-Me-4-Me—Ph and R² is Br. |
| 88C | Q¹ is 2-Me-4-F—Ph and R² is Br. |
| 89C | Q¹ is 2-Me-4-MeO—Ph and R² is Br |
| 90C | Q¹ is 2-Me-4-EtO—Ph and R² is Br. |
| 91C | Q¹ is cyclohexyl and R² is Br. |
| 92C | Q¹ is 2-Me-cyclohexyl and R² is Br. |

TABLE 4

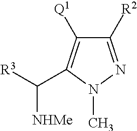

Q¹ is 2,4-di-F—Ph, and R² is Me.

| R³ | R³ |
|---|---|
| Et | i-Pr |
| n-Bu | c-Bu |
| n-pentyl | n-hexyl |
| cyclohexyl | cyclohexen-1-yl |
| cyclopentyl | 2-methylbutyl |
| neopentyl | CH(Me)CF₃ |
| CH₂CH═CH₂ | CH(Me)CN |
| CH₂CH═CHCl | CH₂-cyclohexyl |
| 2-MeO-1-Me—Et | CH₂-(2-Me-cyclopropyl) |
| 2,4-di-Me-cyclohexyl | CH₂-(1-Cl-cyclopropyl) |
| CH₂CH═CHMe₂ | 1,1-dioxothientan-3-yl |
| tetrahydropyran-4-yl | CH₂-cyclopentyl |
| CH₂C≡CH | CH═CH₂ |
| [1,1′-bicyclopropyl]-2-yl | CH₂C(Me)═NOMe |
| C(Me)₂CH₂CH₂CN | 2-oxocyclohexyl |
| n-Pr | cyclopropyl |
| s-Bu | t-Bu |
| 1,2-dimethylbutyl | i-pentyl |
| i-Bu | 1-ethylpropyl |
| 2-Me-cyclopentyl | CH₂-cyclopropyl |
| CH(Me)C≡CH | CH₂CH(Me)CF₃ |
| CH₂CN | CH₂C(Me)═CHMe |
| CH₂CH═CCl₂ | 2-MeO—Pr |
| CH₂CF₃ | 2-Me-cyclohexyl |
| CH(Me)-cyclopropyl | 4-morpholinyl |
| thien-3-yl | oxetan-3-yl |
| CH₂C≡CMe | tetrahydrofuran-3-yl |
| tetrahydrothiophen-3-yl | CH₂CH═CHMe |
| CH₂C(Me)═CH₂ | 3-Me-1,3-dioxan-4-yl |
| CH₂C(Me)═CMe₂ | 2,2-dimethylthietan-3-yl |

The present disclosure also includes Tables 1D through 372, each of which is constructed the same as Table 4 above, except that the row heading in Table 4 (i.e. “Q¹ is 2,4-di-F-Ph, and R² is Me.”) is replaced with the respective row headings shown below. For Example, in Table 1D the row heading is “Q¹ is 2,6-di-F-Ph, and R² is Me”, and R³ is as defined in Table 4 above. Thus, the first entry in Table 1D specifically discloses 4-(2,6-difluorophenyl)-α-ethyl-1,3-dimethyl-1H-pyrazole-5-methanamine. Tables 2D through 92D are constructed similarly.

| Table | Row Heading |
|---|---|
| 1D | Q¹ is 2,6-di-F—Ph and R² is Me. |
| 2D | Q¹ is 2,4,6-tri-F—Ph and R² is Me. |
| 3D | Q¹ is 2,6-di-F-4-MeO—Ph and R² is Me. |
| 4D | Q¹ is 2,6-di-F-4-EtO—Ph and R² is Me. |
| 5D | Q¹ is 2,6-di-F-4-CN—Ph and R² is Me. |
| 6D | Q¹ is 2,6-di-F-3-MeO—Ph and R² is Me. |
| 7D | Q¹ is is 2,6-di-F-3-EtO—Ph and R² is Me. |
| 8D | Q¹ is is 2,6-di-F-3-CN—Ph and R² is Me. |
| 9D | Q¹ is is 2,4,5-tri-F—Ph and R² is Me. |
| 10D | Q¹ is 2,4-di-Cl—Ph and R² is Me. |
| 11D | Q¹ is 2,6-di-Cl—Ph and R² is Me. |
| 12D | Q¹ is 2-Cl-4-F—Ph and R² is Me. |
| 13D | Q¹ is 2-Cl-6-F—Ph and R² is Me. |
| 14D | Q¹ is 2-Br-4-F—Ph and R² is Me. |
| 15D | Q¹ is 2-Br-6-F—Ph and R² is Me. |
| 16D | Q¹ is 2-F-4-MeO—Ph and R² is Me. |
| 17D | Q¹ is 2-Cl-4-MeO—Ph and R² is Me. |
| 18D | Q¹ is 2-Br-4-MeO—Ph and R² is Me. |
| 19D | Q¹ is 2-F-4-EtO—Ph and R² is Me. |
| 20D | Q¹ is 2-Cl-4-EtO—Ph and R² is Me. |
| 21D | Q¹ is 2-Br-4-EtO—Ph and R² is Me. |
| 22D | Q¹ is 2-F-4-Me—Ph and R² is Me. |
| 23D | Q¹ is 2-Cl-4-Me—Ph and R² is Me. |
| 24D | Q¹ 2-Br-4-Me—Ph and R² is Me. |
| 25D | Q¹ is 2-Me-4-Me—Ph and R² is Me. |
| 26D | Q¹ is 2-Me-4-F—Ph and R² is Me. |
| 27D | Q¹ is 2-Me-4-MeO—Ph and R² is Me. |
| 28D | Q¹ is 2-Me-4-EtO—Ph and R² is Me. |
| 29D | Q¹ is cyclohexyl and R² is Me. |
| 30D | Q¹ is 2-Me-cyclohexyl and R² is Me. |
| 31D | Q¹ is 2,4-di-F—Ph and R² is Cl. |
| 32D | Q¹ is 2,6-di-F—Ph and R² is Cl. |
| 33D | Q¹ is 2,4,6-tri-F—Ph and R² is Cl. |
| 34D | Q¹ is 2,6-di-F-4-MeO—Ph and R² is Cl. |
| 35D | Q¹ is 2,6-di-F-4-EtO—Ph and R² is Cl. |
| 36D | Q¹ is 2,6-di-F-4-CN—Ph and R² is Cl. |
| 37D | Q¹ is 2,6-di-F-3-MeO—Ph and R² is Cl. |
| 38D | Q¹ is 2,6-di-F-3-EtO—Ph and R² is Cl. |
| 39D | Q¹ is 2,6-di-F-3-CN—Ph and R² is Cl. |
| 40D | Q¹ is 2,4,5-tri-F—Ph and R² is Cl. |
| 41D | Q¹ is 2,4-di-Cl—Ph and R² is Cl. |
| 42D | Q¹ is 2,6-di-Cl—Ph and R² is Cl. |
| 43D | Q¹ is 2-Cl-4-F—Ph and R² is Cl. |
| 44D | Q¹ is 2-Cl-6-F—Ph and R² is Cl. |
| 45D | Q¹ is 2-Br-4-F—Ph and R² is Cl. |
| 46D | Q¹ is 2-Br-6-F—Ph and R² is Cl. |
| 47D | Q¹ is 2-F-4-MeO—Ph and R² is Cl. |
| 48D | Q¹ is 2-Cl-4-MeO—Ph and R² is Cl. |
| 49D | Q¹ is 2-Br-4-MeO—Ph and R² is Cl. |
| 50D | Q¹ is 2-F-4-EtO—Ph and R² is Cl. |
| 51D | Q¹ is 2-Cl-4-EtO—Ph and R² is Cl. |
| 52D | Q¹ is 2-Br-4-EtO—Ph and R² is Cl. |
| 53D | Q¹ is 2-F-4-Me—Ph and R² is Cl. |
| 54D | Q¹ is 2-Cl-4-Me—Ph and R² is Cl |
| 55D | Q¹ is 2-Br-4-Me—Ph and R² is Cl. |
| 56D | Q¹ is 2-Me-4-Me—Ph and R² is Cl. |
| 57D | Q¹ is 2-Me-4-F—Ph and R² is Cl. |
| 58D | Q¹ is 2-Me-4-MeO—Ph and R² is Cl. |
| 59D | Q¹ is 2-Me-4-EtO—Ph and R² is Cl. |
| 60D | Q¹ is cyclohexyl and R² is Cl. |
| 61D | Q¹ is 2-Me-cyclohexyl and R² is Cl. |
| 62D | Q¹ is 2,4-di-F—Ph and R² is Br. |
| 63D | Q¹ is 2,6-di-F—Ph and R² is Br. |
| 64D | Q¹ is 2,4,6-tri-F—Ph and R² is Br. |
| 65D | Q¹ is 2,6-di-F-4-MeO—Ph and R² is Br. |
| 66D | Q¹ is 2,6-di-F-4-EtO—Ph and R² is Br. |
| 67D | Q¹ is 2,6-di-F-4-CN—Ph and R² is Br. |
| 68D | Q¹ is 2,6-di-F-3-MeO—Ph and R² is Br. |
| 69D | Q¹ is 2,6-di-F-3-EtO—Ph and R² is Br. |
| 70D | Q¹ is 2,6-di-F-3-CN—Ph and R² is Br. |
| 71D | Q¹ is 2,4,5-tri-F—Ph and R² is Br. |
| 72D | Q¹ is 2,4-di-Cl—Ph and R² is Br. |
| 73D | Q¹ is 2,6-di-Cl—Ph and R² is Br. |
| 74D | Q¹ is 2-Cl-4-F—Ph and R² is Br. |
| 75D | Q¹ is 2-Cl-6-F—Ph and R² is Br. |
| 76D | Q¹ is 2-Br-4-F—Ph and R² is Br. |
| 77D | Q¹ is 2-Br-6-F—Ph and R² is Br. |
| 78D | Q¹ is 2-F-4-MeO—Ph and R² is Br |
| 79D | Q¹ is 2-Cl-4-MeO—Ph and R² is Br. |
| 80D | Q¹ is 2-Br-4-MeO—Ph and R² is Br. |
| 81D | Q¹ is 2-F-4-EtO—Ph and R² is Br. |
| 82D | Q¹ is 2-Cl-4-EtO—Ph and R² is Cl. |
| 83D | Q¹ is 2-Br-4-EtO—Ph and R² is Br. |
| 84D | Q¹ is 2-F-4-Me—Ph and R² is Br. |
| 85D | Q¹ is 2-Cl-4-Me—Ph and R² is Br. |
| 86D | Q¹ is 2-Br-4-Me—Ph and R² is Br. |
| 87D | Q¹ is 2-Me-4-Me—Ph and R² is Br. |
| 88D | Q¹ is 2-Me-4-F—Ph and R² is Br. |
| 89D | Q¹ is 2-Me-4-MeO—Ph and R² is Br |
| 90D | Q¹ is 2-Me-4-EtO—Ph and R² is Br. |
| 91D | Q¹ is cyclohexyl and R² is Br. |
| 92D | Q¹ is 2-Me-cyclohexyl and R² is Br. |

### Formulation/Utility

A compound of Formula 1 of this invention (including N-oxides and salts thereof) will generally be used as a fungicidal active ingredient in a composition, i.e. formulation, with at least one additional component selected from the group consisting of surfactants, solid diluents and liquid diluents, which serve as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto seeds of crops and other desirable vegetation as seed treatments before planting to protect developing roots and other subterranean plant parts and/or foliage through systemic uptake.

The formulations will typically contain effective amounts of active ingredient, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders | | | |
| Oil Dispersions, Suspensions, | 1-50 | 40-99 | 0-50 |
| Emulsions, Solutions | | | |
| (including Emulsifiable | | | |
| Concentrates) | | | |
| Dusts | 1-25 | 70-99 | 0-5 |
| Granules and Pellets | 0.001-95 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, N.J.

Liquid diluents include, for example, water, N,N-dimethylalkanamides (e.g., N,N-dimethylformamide), limonene, dimethyl sulfoxide, N-alkypyrrolidones (e.g., N-methylpyrrolidinone), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters and γ-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The compound of Formula 1 and any other active ingredients are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound numbers refer to compounds in Index Tables A-B. Without further elaboration, it is believed that one skilled in the art using the preceding description can utilize the present invention to its fullest extent. The following Examples are, therefore, to be constructed as merely illustrative, and not limiting of the disclosure in any way whatsoever. Percentages are by weight except where otherwise indicated.

### Example A

| High Strength Concentrate | |
|---|---|
| Compound 8 | 98.5% |
| silica aerogel | 0.5% |
| synthetic amorphous fine silica | 1.0% |

### Example B

| Wettable Powder | |
|---|---|
| Compound 16 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0% |

### Example C

| Granule | |
|---|---|
| Compound 19 | 10.0% |
| attapulgite granules (low volatile matter, 0.71/0.30 mm; | 90.0% |
| U.S.S. No. 25-50 sieves) | |

### Example D

| Extruded Pellet | |
|---|---|
| Compound 8 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### Example E

| Emulsifiable Concentrate | |
|---|---|
| Compound 4 | 10.0% |
| polyoxyethylene sorbitol hexoleate | 20.0% |
| C₆-C₁₀ fatty acid methyl ester | 70.0% |

### Example F

| Microemulsion | |
|---|---|
| Compound 5 | 5.0% |
| polyvinylpyrrolidone-vinyl acetate copolymer | 30.0% |
| alkylpolyglycoside | 30.0% |
| glyceryl monooleate | 15.0% |
| water | 20.0% |

### Example G

| Seed Treatment | |
|---|---|
| Compound 8 | 20.00% |
| polyvinylpyrrolidone-vinyl acetate copolymer | 5.00% |
| montan acid wax | 5.00% |
| calcium ligninsulfonate | 1.00% |
| polyoxyethylene/polyoxypropylene block copolymers | 1.00% |
| stearyl alcohol (POE 20) | 2.00% |
| polyorganosilane | 0.20% |
| colorant red dye | 0.05% |
| water | 65.75% |

Water-soluble and water-dispersible formulations are typically diluted with water to form aqueous compositions before application. Aqueous compositions for direct applications to the plant or portion thereof (e.g., spray tank compositions) typically at least about 1 ppm or more (e.g., from 1 ppm to 100 ppm) of the compound(s) of this invention. The compounds of this invention are useful as plant disease control agents. The present invention therefore further comprises a method for controlling plant diseases caused by fungal plant pathogens comprising applying to the plant or portion thereof to be protected, or to the plant seed to be protected, an effective amount of a compound of the invention or a fungicidal composition containing said compound. The compounds and/or compositions of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, turf, vegetable, field, cereal, and fruit crops. These pathogens include: Oomycetes, including Phytophthora diseases such as Phytophthora infestans, Phytophthora megasperma, Phytophthora parasitica, Phytophthora cinnamomi and Phytophthora capsici, Pythium diseases such as Pythium aphanidermatum, and diseases in the Peronosporaceae family such as Plasmopara viticola, Peronospora spp. (including Peronospora tabacina and Peronospora parasitica), Pseudoperonospora spp. (including Pseudoperonospora cubensis) and Bremia lactucae; Ascomycetes, including Alternaria diseases such as Alternaria solani and Alternaria brassicae, Guignardia diseases such as Guignardia bidwell, Venturia diseases such as Venturia inaequalis, Septoria diseases such as Septoria nodorum and Septoria tritici, powdery mildew diseases such as Erysiphe spp. (including Erysiphe graminis and Erysiphe polygoni), Uncinula necatur, Sphaerotheca fuliginea, Podosphaera leucotricha and Pseudocercosporella herpotrichoides, Botrytis diseases such as Botrytis cinerea, Monilinia fructicola, Sclerotinia diseases such as Sclerotinia sclerotiorum, Sclerotinia minor, Magnaporthe grisea, and Phomopsis viticola, Helminthosporium diseases such as Helminthosporium tritici repentis and Pyrenophora teres, anthracnose diseases such as Glomerella or Colletotrichum spp. (such as Colletotrichum graminicola and Colletotrichum orbiculare), and Gaeumannomyces graminis; Basidiomycetes, including rust diseases caused by Puccinia spp. (such as Puccinia recondita, Puccinia striiformis, Puccinia hordei, Puccinia graminis and Puccinia arachidis), Hemileia vastatrix and Phakopsora pachyrhizi; other pathogens including Rutstroemia floccosum (also known as Sclerontina homoeocarpa); Rhizoctonia spp. (such as Rhizoctonia solani); Fusarium diseases such as Fusarium roseum, Fusarium graminearum and Fusarium oxysporum Verticillium dahliae; Sclerotium rolfsii; Rynchosporium secalis; Cercosporidium personatum, Cercospora arachidicola and Cercospora beticola; Rhizopus spp. (such as Rhizopus stolnifer); Aspergillus spp. (such as Aspergillus flavus and Aspergillus parasiticus); and other genera and species closely related to these pathogens. In addition to their fungicidal activity, the compositions or combinations also have activity against bacteria such as Erwinia amylovora, Xanthomonas campestris, Pseudomonas syringae, and other related species. By controlling harmful microorganisms, the compounds of the invention are useful for improving (i.e. increasing) the ratio of beneficial to harmful microorganisms in contact with crop plants or their propagules (e.g., seeds, corns, bulbs, tubers, cuttings) or in the agronomic environment of the crop plants or their propagules.

Furthermore, the compounds of this invention are useful in treating postharvest diseases of fruits and vegetables caused by fungi and bacteria. These infections can occur before, during and after harvest. For example, infections can occur before harvest and then remain dormant until some point during ripening (e.g., host begins tissue changes in such a way that infection can progress); also infections can arise from surface wounds created by mechanical or insect injury. In this respect, the compounds of this invention can reduce losses (i.e. losses resulting from quantity and quality) due to postharvest diseases which may occur at any time from harvest to consumption. Treatment of postharvest diseases with compounds of the invention can increase the period of time during which perishable edible plant parts (e.g, fruits, seeds, foliage, stems, bulbs. tubers) can be stored refrigerated or un-refrigerated after harvest, and remain edible and free from noticeable or harmful degradation or contamination by fungi or other microorganisms. Treatment of edible plant parts before or after harvest with compounds of the invention can also decrease the formation of toxic metabolites of fungi or other microorganisms, for example mycotoxins such as aflatoxins.

Plant disease control is ordinarily accomplished by applying an effective amount of a compound of this invention either pre- or post-infection, to the portion of the plant to be protected such as the roots, stems, foliage, fruits, seeds, tubers or bulbs, or to the media (soil or sand) in which the plants to be protected are growing. The compounds can also be applied to seeds to protect the seeds and seedlings developing from the seeds. The compounds can also be applied through irrigation water to treat plants. Control of postharvest pathogens which infect the produce before harvest is typically accomplished by field application of a compound of this invention, and in cases where infection occurs after harvest the compounds can be applied to the harvested crop as dips, sprays, fumigants, treated wraps and box liners.

Rates of application for these compounds (i.e. a fungicidally effective amount) can be influenced by factors such as the plant diseases to be controlled, the plant species to be protected, ambient moisture and temperature and should be determined under actual use conditions. One skilled in the art can easily determine through simple experimentation the fungicidally effective amount necessary for the desired level of plant disease control. Foliage can normally be protected when treated at a rate of from less than about 1 g/ha to about 5,000 g/ha of active ingredient. Seed and seedlings can normally be protected when seed is treated at a rate of from about 0.1 to about 10 g per kilogram of seed.

Compounds of this invention can also be mixed with one or more other biologically active compounds or agents including fungicides, insecticides, nematocides, bactericides, acaricides, herbicides, herbicide safeners, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Thus the present invention also pertains to a composition comprising a compound of Formula 1 (in a fungicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with a compound of Formula 1, to form a premix, or one or more other biologically active compounds or agents can be formulated separately from the compound of Formula 1, and the formulations combined together before application (e.g., in a spray tank) or, alternatively, applied in succession.

Of note is a composition which in addition to the compound of Formula 1 include at least one fungicidal compound selected from the group consisting of the classes (1) methyl benzimidazole carbamate (MBC) fungicides; (2) dicarboximide fungicides; (3) demethylation inhibitor (DMI) fungicides; (4) phenylamide fungicides; (5) amine/morpholine fungicides; (6) phospholipid biosynthesis inhibitor fungicides; (7) carboxamide fungicides; (8) hydroxy(2-amino-)pyrimidine fungicides; (9) anilinopyrimidine fungicides; (10) N-phenyl carbamate fungicides; (11) quinone outside inhibitor (QoI) fungicides; (12) phenylpyrrole fungicides; (13) quinoline fungicides; (14) lipid peroxidation inhibitor fungicides; (15) melanin biosynthesis inhibitors-reductase (MBI-R) fungicides; (16) melanin biosynthesis inhibitors-dehydratase (MBI-D) fungicides; (17) hydroxyanilide fungicides; (18) squalene-epoxidase inhibitor fungicides; (19) polyoxin fungicides; (20) phenylurea fungicides; (21) quinone inside inhibitor (QiI) fungicides; (22) benzamide fungicides; (23) enopyranuronic acid antibiotic fungicides; (24) hexopyranosyl antibiotic fungicides; (25) glucopyranosyl antibiotic: protein synthesis fungicides; (26) glucopyranosyl antibiotic: trehalase and inositol biosynthesis fungicides; (27) cyanoacetamideoxime fungicides; (28) carbamate fungicides; (29) oxidative phosphorylation uncoupling fungicides; (30) organo tin fungicides; (31) carboxylic acid fungicides; (32) heteroaromatic fungicides; (33) phosphonate fungicides; (34) phthalamic acid fungicides; (35) benzotriazine fungicides; (36) benzene-sulfonamide fungicides; (37) pyridazinone fungicides; (38) thiophene-carboxamide fungicides; (39) pyrimidinamine fungicides; (40) carboxylic acid amide (CAA) fungicides; (41) tetracycline antibiotic fungicides; (42) thiocarbamate fungicides; (43) benzamide fungicides; (44) host plant defense induction fungicides; (45) multi-site contact activity fungicides; (46) fungicides other than classes (1) through (45); and salts of compounds of classes (1) through (46).

Further descriptions of these classes of fungicidal compounds are provided below.

(1) “Methyl benzimidazole carbamate (MBC) fungicides” (Fungicide Resistance Action Committee (FRAC) code 1) inhibit mitosis by binding to β-tubulin during microtubule assembly. Inhibition of microtubule assembly can disrupt cell division, transport within the cell and cell structure. Methyl benzimidazole carbamate fungicides include benzimidazoles and thiophanates. The benzimidazoles include benomyl, carbendazim, fuberidazole and thiabendazole. The thiophanates include thiophanate and thiophanate-methyl.

(2) “Dicarboximide fungicides” (Fungicide Resistance Action Committee (FRAC) code 2) are proposed to inhibit a lipid peroxidation in fungi through interference with NADH cytochrome c reductase. Examples include chlozolinate, iprodione, procymidone and vinclozolin.

(3) “Demethylation inhibitor (DMI) fungicides” (Fungicide Resistance Action Committee (FRAC) code 3) inhibit C14-demethylase, which plays a role in sterol production. Sterols, such as ergosterol, are needed for membrane structure and function, making them essential for the development of functional cell walls. Therefore, exposure to these fungicides results in abnormal growth and eventually death of sensitive fungi. Demethylation fungicides include azoles (including triazoles and imidazoles), pyrimidines, piperazines and pyridines. The triazoles include azaconazole, bitertanol, bromuconazole, cyproconazole, difenoconazole, diniconazole (including diniconazole-M), epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triticonazole and uniconazole. The imidazoles include clotrimazole, imazalil, oxpoconazole, prochloraz, pefurazoate and triflumizole. The pyrimidines include fenarimol and nuarimol. The piperazines include triforine. The pyridines include pyrifenox. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

(4) “Phenylamide fungicides” (Fungicide Resistance Action Committee (FRAC) code 4) are specific inhibitors of RNA polymerase in Oomycete fungi. Sensitive fungi exposed to these fungicides show a reduced capacity to incorporate uridine into rRNA. Growth and development in sensitive fungi is prevented by exposure to this class of fungicide. Phenylamide fungicides include acylalanines, oxazolidinones and butyrolactones. The acylalanines include benalaxyl, benalaxyl-M, furalaxyl, metalaxyl and metalaxyl-M/mefenoxam. The oxazolidinones include oxadixyl. The butyrolactones include ofurace.

(5) “Amine/morpholine fungicides” (Fungicide Resistance Action Committee (FRAC) code 5) inhibit two target sites within the sterol biosynthetic pathway, Δ⁸→Δ⁷ isomerase and Δ¹⁴ reductase. Sterols, such as ergosterol, are needed for membrane structure and function, making them essential for the development of functional cell walls. Therefore, exposure to these fungicides results in abnormal growth and eventually death of sensitive fungi. Amine/morpholine fungicides (also known as non-DMI sterol biosynthesis inhibitors) include morpholines, piperidines and spiroketal-amines. The morpholines include aldimorph, dodemorph, fenpropimorph, tridemorph and trimorphamide. The piperidines include fenpropidin and piperalin. The spiroketal-amines include spiroxamine.

(6) “Phospholipid biosynthesis inhibitor fungicides” (Fungicide Resistance Action Committee (FRAC) code 6) inhibit growth of fungi by affecting phospholipid biosynthesis. Phospholipid biosynthesis fungicides include phosphorothiolates and dithiolanes. The phosphorothiolates include edifenphos, iprobenfos and pyrazophos. The dithiolanes include isoprothiolane.

(7) “Carboxamide fungicides” (Fungicide Resistance Action Committee (FRAC) code 7) inhibit Complex II (succinate dehydrogenase) fungal respiration by disrupting a key enzyme in the Krebs Cycle (TCA cycle) named succinate dehydrogenase. Inhibiting respiration prevents the fungus from making ATP, and thus inhibits growth and reproduction. Carboxamide fungicides include benzamides, furan carboxamides, oxathiin carboxamides, thiazole carboxamides, pyrazole carboxamides, pyridine carboxamides and thiophene carboxamides. The benzamides include benodanil, flutolanil and mepronil. The furan carboxamides include fenfuram. The oxathiin carboxamides include carboxin and oxycarboxin. The thiazole carboxamides include thifluzamide. The pyrazole carboxamides include furametpyr, penthiopyrad, bixafen, isopyrazam, benzovindiflupyr, N-[2-(1S,2R)-[1,1′-bicyclopropyl]-2-ylphenyl]-3-(difluoromethyl)-1-methyl-1H-pyrazole-4-carboxamide, penflufen, (N-[2-(1,3-dimethylbutyl)phenyl]-5-fluoro-1,3-dimethyl-1H-pyrazole-4-carboxamide) and N-[2-(2,4-dichlorophenyl)-2-methoxy-1-methylethyl]-3-(difluoromethyl)-1-methyl-1H-pyrazole-4-carboxamide. The pyridine carboxamides include boscalid. The thiophene carboxamides include isofetamid.

(8) “Hydroxy(2-amino-)pyrimidine fungicides” (Fungicide Resistance Action Committee (FRAC) code 8) inhibit nucleic acid synthesis by interfering with adenosine deaminase. Examples include bupirimate, dimethirimol and ethirimol.

(9) “Anilinopyrimidine fungicides” (Fungicide Resistance Action Committee (FRAC) code 9) are proposed to inhibit biosynthesis of the amino acid methionine and to disrupt the secretion of hydrolytic enzymes that lyse plant cells during infection. Examples include cyprodinil, mepanipyrim and pyrimethanil.

(10) “N-Phenyl carbamate fungicides” (Fungicide Resistance Action Committee (FRAC) code 10) inhibit mitosis by binding to β-tubulin and disrupting microtubule assembly. Inhibition of microtubule assembly can disrupt cell division, transport within the cell and cell structure. Examples include diethofencarb.

(11) “Quinone outside inhibitor (QoI) fungicides” (Fungicide Resistance Action Committee (FRAC) code 11) inhibit Complex III mitochondrial respiration in fungi by affecting ubiquinol oxidase. Oxidation of ubiquinol is blocked at the “quinone outside” (Qₒ) site of the cytochrome bc₁ complex, which is located in the inner mitochondrial membrane of fungi. Inhibiting mitochondrial respiration prevents normal fungal growth and development. Quinone outside inhibitor fungicides (also known as strobilurin fungicides) include methoxyacrylates, methoxycarbamates, oximinoacetates, oximinoacetamides, oxazolidinediones, dihydrodioxazines, imidazolinones and benzylcarbamates. The methoxyacrylates include azoxystrobin, enestroburin (SYP-Z071), picoxystrobin and pyraoxystrobin (SYP-3343). The methoxycarbamates include pyraclostrobin and pyrametostrobin (SYP-4155). The oximinoacetates include kresoxim-methyl and trifloxystrobin. The oximinoacetamides include dimoxystrobin, metominostrobin, orysastrobin, α-[methoxyimino]-N-methyl-2-[[[1-[3-(trifluoromethyl)phenyl]ethoxy]imino]-methyl]benzeneacetamide and 2-[[[3-(2,6-dichlorophenyl)-1-methyl-2-propen-1-ylidene]-amino]oxy]methyl]-α-(methoxyimino)-N-methylbenzeneacetamide. The oxazolidinediones include famoxadone. The dihydrodioxazines include fluoxastrobin. The imidazolinones include fenamidone. The benzylcarbamates include pyribencarb. Class (11) also includes 2-[(2,5-dimethylphenoxy)methyl]-α-methoxy-N-benzeneacetamide.

(12) “Phenylpyrrole fungicides” (Fungicide Resistance Action Committee (FRAC) code 12) inhibit a MAP protein kinase associated with osmotic signal transduction in fungi. Fenpiclonil and fludioxonil are examples of this fungicide class.

(13) “Quinoline fungicides” (Fungicide Resistance Action Committee (FRAC) code 13) are proposed to inhibit signal transduction by affecting G-proteins in early cell signaling. They have been shown to interfere with germination and/or appressorium formation in fungi that cause powder mildew diseases. Quinoxyfen and tebufloquin are examples of this class of fungicide.

(14) “Lipid peroxidation inhibitor fungicides” (Fungicide Resistance Action Committee (FRAC) code 14) are proposed to inhibit lipid peroxidation which affects membrane synthesis in fungi. Members of this class, such as etridiazole, may also affect other biological processes such as respiration and melanin biosynthesis. Lipid peroxidation fungicides include aromatic carbons and 1,2,4-thiadiazoles. The aromatic carbon fungicides include biphenyl, chloroneb, dicloran, quintozene, tecnazene and tolclofos-methyl. The 1,2,4-thiadiazole fungicides include etridiazole.

(15) “Melanin biosynthesis inhibitors-reductase (MBI-R) fungicides” (Fungicide Resistance Action Committee (FRAC) code 16.1) inhibit the naphthal reduction step in melanin biosynthesis. Melanin is required for host plant infection by some fungi. Melanin biosynthesis inhibitors-reductase fungicides include isobenzofuranones, pyrroloquinolinones and triazolobenzothiazoles. The isobenzofuranones include phthalate. The pyrroloquinolinones include pyroquilon. The triazolobenzothiazoles include tricyclazole.

(16) “Melanin biosynthesis inhibitors-dehydratase (MBI-D) fungicides” (Fungicide Resistance Action Committee (FRAC) code 16.2) inhibit scytalone dehydratase in melanin biosynthesis. Melanin in required for host plant infection by some fungi. Melanin biosynthesis inhibitors-dehydratase fungicides include cyclopropanecarboxamides, carboxamides and propionamides. The cyclopropanecarboxamides include carpropamid. The carboxamides include diclocymet. The propionamides include fenoxanil.

(17) “Hydroxyanilide fungicides (Fungicide Resistance Action Committee (FRAC) code 17) inhibit C4-demethylase which plays a role in sterol production. Examples include fenhexamid.

(18) “Squalene-epoxidase inhibitor fungicides” (Fungicide Resistance Action Committee (FRAC) code 18) inhibit squalene-epoxidase in ergosterol biosynthesis pathway. Sterols such as ergosterol are needed for membrane structure and function, making them essential for the development of functional cell walls. Therefore exposure to these fungicides results in abnormal growth and eventually death of sensitive fungi. Squalene-epoxidase inhibitor fungicides include thiocarbamates and allylamines. The thiocarbamates include pyributicarb. The allylamines include naftifine and terbinafine.

(19) “Polyoxin fungicides” (Fungicide Resistance Action Committee (FRAC) code 19) inhibit chitin synthase. Examples include polyoxin.

(20) “Phenylurea fungicides” (Fungicide Resistance Action Committee (FRAC) code 20) are proposed to affect cell division. Examples include pencycuron.

(21) “Quinone inside inhibitor (QiI) fungicides” (Fungicide Resistance Action Committee (FRAC) code 21) inhibit Complex III mitochondrial respiration in fungi by affecting ubiquinol reductase. Reduction of ubiquinol is blocked at the “quinone inside” (Qᵢ) site of the cytochrome bc₁ complex, which is located in the inner mitochondrial membrane of fungi. Inhibiting mitochondrial respiration prevents normal fungal growth and development. Quinone inside inhibitor fungicides include cyanoimidazoles and sulfamoyltriazoles. The cyanoimidazoles include cyazofamid. The sulfamoyltriazoles include amisulbrom.

(22) “Benzamide fungicides” (Fungicide Resistance Action Committee (FRAC) code 22) inhibit mitosis by binding to β-tubulin and disrupting microtubule assembly. Inhibition of microtubule assembly can disrupt cell division, transport within the cell and cell structure. Examples include zoxamide.

(23) “Enopyranuronic acid antibiotic fungicides” (Fungicide Resistance Action Committee (FRAC) code 23) inhibit growth of fungi by affecting protein biosynthesis. Examples include blasticidin-S.

(24) “Hexopyranosyl antibiotic fungicides” (Fungicide Resistance Action Committee (FRAC) code 24) inhibit growth of fungi by affecting protein biosynthesis. Examples include kasugamycin.

(25) “Glucopyranosyl antibiotic: protein synthesis fungicides” (Fungicide Resistance Action Committee (FRAC) code 25) inhibit growth of fungi by affecting protein biosynthesis. Examples include streptomycin.

(26) “Glucopyranosyl antibiotic: trehalase and inositol biosynthesis fungicides” (Fungicide Resistance Action Committee (FRAC) code 26) inhibit trehalase in inositol biosynthesis pathway. Examples include validamycin.

(27) “Cyanoacetamideoxime fungicides (Fungicide Resistance Action Committee (FRAC) code 27) include cymoxanil.

(28) “Carbamate fungicides” (Fungicide Resistance Action Committee (FRAC) code 28) are considered multi-site inhibitors of fungal growth. They are proposed to interfere with the synthesis of fatty acids in cell membranes, which then disrupts cell membrane permeability. Propamacarb, propamacarb-hydrochloride, iodocarb, and prothiocarb are examples of this fungicide class.

(29) “Oxidative phosphorylation uncoupling fungicides” (Fungicide Resistance Action Committee (FRAC) code 29) inhibit fungal respiration by uncoupling oxidative phosphorylation. Inhibiting respiration prevents normal fungal growth and development. This class includes 2,6-dinitroanilines such as fluazinam, pyrimidonehydrazones such as ferimzone and dinitrophenyl crotonates such as dinocap, meptyldinocap and binapacryl.

(30) “Organo tin fungicides” (Fungicide Resistance Action Committee (FRAC) code 30) inhibit adenosine triphosphate (ATP) synthase in oxidative phosphorylation pathway. Examples include fentin acetate, fentin chloride and fentin hydroxide.

(31) “Carboxylic acid fungicides” (Fungicide Resistance Action Committee (FRAC) code 31) inhibit growth of fungi by affecting deoxyribonucleic acid (DNA) topoisomerase type II (gyrase). Examples include oxolinic acid.

(32) “Heteroaromatic fungicides” (Fungicide Resistance Action Committee (FRAC) code 32) are proposed to affect DNA/ribonucleic acid (RNA) synthesis. Heteroaromatic fungicides include isoxazoles and isothiazolones. The isoxazoles include hymexazole and the isothiazolones include octhilinone.

(33) “Phosphonate fungicides” (Fungicide Resistance Action Committee (FRAC) code 33) include phosphorous acid and its various salts, including fosetyl-aluminum.

(34) “Phthalamic acid fungicides” (Fungicide Resistance Action Committee (FRAC) code 34) include teclofthalam.

(35) “Benzotriazine fungicides” (Fungicide Resistance Action Committee (FRAC) code 35) include triazoxide.

(36) “Benzene-sulfonamide fungicides” (Fungicide Resistance Action Committee (FRAC) code 36) include flusulfamide.

(37) “Pyridazinone fungicides” (Fungicide Resistance Action Committee (FRAC) code 37) include diclomezine.

(38) “Thiophene-carboxamide fungicides” (Fungicide Resistance Action Committee (FRAC) code 38) are proposed to affect ATP production. Examples include silthiofam.

(39) “Pyrimidinamide fungicides” (Fungicide Resistance Action Committee (FRAC) code 39) inhibit growth of fungi by affecting phospholipid biosynthesis and include diflumetorim.

(40) “Carboxylic acid amide (CAA) fungicides” (Fungicide Resistance Action Committee (FRAC) code 40) are proposed to inhibit phospholipid biosynthesis and cell wall deposition. Inhibition of these processes prevents growth and leads to death of the target fungus. Carboxylic acid amide fungicides include cinnamic acid amides, valinamide carbamates, carbamates and mandelic acid amides. The cinnamic acid amides include dimethomorph and flumorph. The valinamide carbamates include benthiavalicarb, benthiavalicarb-isopropyl, iprovalicarb, valifenalate and valiphenal. The carbamates include tolprocarb. The mandelic acid amides include mandipropamid, N-[2-[4-[[3-(4-chlorophenyl)-2-propyn-1-yl]oxy]-3-methoxyphenyl]ethyl]-3-methyl-2-[(methylsulfonyl)-amino]butanamide and N-[2-[4-[[3-(4-chlorophenyl)-2-propyn-1-yl]oxy]-3-methoxyphenyl]-ethyl]-3-methyl-2-[(ethylsulfonyl)amino]butanamide.

(41) “Tetracycline antibiotic fungicides” (Fungicide Resistance Action Committee (FRAC) code 41) inhibit growth of fungi by affecting complex 1 nicotinamide adenine dinucleotide (NADH) oxidoreductase. Examples include oxytetracycline.

(42) “Thiocarbamate fungicides” (Fungicide Resistance Action Committee (FRAC) code 42) include methasulfocarb.

(43) “Benzamide fungicides” (Fungicide Resistance Action Committee (FRAC) code 43) inhibit growth of fungi by delocalization of spectrin-like proteins. Examples include acylpicolide fungicides such as fluopicolide and fluopyram.

(44) “Host plant defense induction fungicides” (Fungicide Resistance Action Committee (FRAC) code P) induce host plant defense mechanisms. Host plant defense induction fungicides include benzo-thiadiazoles, benzisothiazoles and thiadiazole-carboxamides. The benzo-thiadiazoles include acibenzolar-5-methyl. The benzisothiazoles include probenazole. The thiadiazole-carboxamides include tiadinil and isotianil.

(45) “Multi-site contact fungicides” inhibit fungal growth through multiple sites of action and have contact/preventive activity. This class of fungicides includes: (45.1) “copper fungicides” (Fungicide Resistance Action Committee (FRAC) code M1)”, (45.2) “sulfur fungicides” (Fungicide Resistance Action Committee (FRAC) code M2), (45.3) “dithiocarbamate fungicides” (Fungicide Resistance Action Committee (FRAC) code M3), (45.4) “phthalimide fungicides” (Fungicide Resistance Action Committee (FRAC) code M4), (45.5) “chloronitrile fungicides” (Fungicide Resistance Action Committee (FRAC) code M5), (45.6) “sulfamide fungicides” (Fungicide Resistance Action Committee (FRAC) code M6), (45.7) “guanidine fungicides” (Fungicide Resistance Action Committee (FRAC) code M7), (45.8) “triazine fungicides” (Fungicide Resistance Action Committee (FRAC) code M8) and (45.9) “quinone fungicides” (Fungicide Resistance Action Committee (FRAC) code M9). “Copper fungicides” are inorganic compounds containing copper, typically in the copper(II) oxidation state; examples include copper oxychloride, copper sulfate and copper hydroxide, including compositions such as Bordeaux mixture (tribasic copper sulfate). “Sulfur fungicides” are inorganic chemicals containing rings or chains of sulfur atoms; examples include elemental sulfur. “Dithiocarbamate fungicides” contain a dithiocarbamate molecular moiety; examples include mancozeb, metiram, propineb, ferbam, maneb, thiram, zineb and ziram. “Phthalimide fungicides” contain a phthalimide molecular moiety; examples include folpet, captan and captafol. “Chloronitrile fungicides” contain an aromatic ring substituted with chloro and cyano; examples include chlorothalonil. “Sulfamide fungicides” include dichlorfluanid and tolyfluranid. “Guanidine fungicides” include dodine, guazatine, iminoctadine albesilate and iminoctadine triacetate. “Triazine fungicides” include anilazine. “Quinone fungicides” include dithianon.

(46) “Fungicides other than fungicides of classes (1) through (45)” include certain fungicides whose mode of action may be unknown. These include: (46.1) “thiazole carboxamide fungicides” (Fungicide Resistance Action Committee (FRAC) code U5), (46.2) “phenyl-acetamide fungicides” (Fungicide Resistance Action Committee (FRAC) code U6), (46.3) “quinazolinone fungicides” (Fungicide Resistance Action Committee (FRAC) code U7), (46.4) “benzophenone fungicides” (Fungicide Resistance Action Committee (FRAC) code U8) and (46.5) “triazolopyrimidine fungicides”. The thiazole carboxamides include ethaboxam. The phenyl-acetamides include cyflufenamid and N-[[(cyclopropylmethoxy)-amino][6-(difluoromethoxy)-2,3-difluorophenyl]-methylene]benzeneacetamide. The quinazolinones include proquinazid. The benzophenones include metrafenone. The triazolopyrimidines include ametoctradin. Class (46) (i.e. “Fungicides other than classes (1) through (45)”) also includes bethoxazin, fluxapyroxad, neo-asozin (ferric methanearsonate), pyriofenone, pyrroInitrin, quinomethionate, tebufloquin, N-[2-[4-[[3-(4-chlorophenyl)-2-propyn-1-yl]oxy]-3-methoxyphenyl]ethyl]-3-methyl-2-[methylsulfonyl)amino]butanamide, N-[2-[4-[[3-(4-chlorophenyl)-2-propyn-1-yl]oxy]-3-methoxyphenyl]ethyl]-3-methyl-2-[(ethylsulfonyl)amino]butanamide, 2-[[2-fluoro-5-(trifluoromethyl)phenyl]thio]-2-[3-(2-methoxyphenyl)-2-thiazolidinylidene]acetonitrile, 3-[5-(4-chlorophenyl)-2,3-dimethyl-3-isoxazolidinyl]pyridine, 4-fluorophenyl N-[1-[[[1-(4-cyanophenyl)ethyl]sulfonyl]methyl]-propyl]carbamate, 5-chloro-6-(2,4,6-trifluorophenyl)-7-(4-methylpiperidin-1-yl)[1,2,4]-triazolo[1,5-a]pyrimidine, N-(4-chloro-2-nitrophenyl)-N-ethyl-4-methylbenzenesulfonamide, N-[[(cyclopropylmethoxy)amino][6-(difluoromethoxy)-2,3-difluorophenyl]methylene]-benzeneacetamide, N′-[4-[4-chloro-3-(trifluoromethyl)phenoxy]-2,5-dimethylphenyl]-N-ethyl-N-methylmethanimidamide, 1-[(2-propenylthio)carbonyl]-2-(1-methylethyl)-4-(2-methylphenyl)-5-amino-1H-pyrazol-3-one, N′-[4-[[3-[(4-chlorophenyl)methyl]-1,2,4-thia-diazol-5-yl]oxy]-2,5-dimethylphenyl]-N-ethyl-N-methyl-methanimidamide, 1,1-dimethyl-ethyl N-[6-[[[[1-methyl-1H-tetrazol-5-yl)phenylmethylene]amino]oxy]methyl-2-pyridinyl]-carbamate, 3-butyn-1-yl N-[6-[[[[1-methyl-1H-tetrazol-5-yl)phenylmethylene]amino]oxy]-methyl]-2-pyridinyl]carbamate, 2,6-dimethyl-1H,5H-[1,4]dithiino[2,3-c:5,6-c′]dipyrrole-1,3,5,7(2H,6H)-tetrone, 5-fluoro-2-[(4-methylphenyl)methoxy]-4-pyrimidinamine, 5-fluoro-2-[(4-fluorophenyl)methoxy]-4-pyrimidinamine, α-[3-(4-chloro-2-fluorophenyl)-5-(2,4-di-fluorophenyl)isoxazol-4-yl]pyrid-3-ylmethanol, (αS)-[3-(4-chloro-2-fluorophenyl)-5-(2,4-difluorophenyl)isoxazol-4-yl]pyrid-3-ylmethanol and (αR)-[3-(4-chloro-2-fluorophenyl)-5-(2,4-difluorophenyl)isoxazol-4-yl]pyrid-3-ylmethanol.

Therefore of note is a mixture (i.e. composition) comprising a compound of Formula 1 and at least one fungicidal compound selected from the group consisting of the aforedescribed classes (1) through (46). Also of note is a composition comprising said mixture (in fungicidally effective amount) and further comprising at least one additional component selected from the group consisting of surfactants, solid diluents and liquid diluents. Of particular note is a mixture (i.e. composition) comprising a compound of Formula 1 and at least one fungicidal compound selected from the group of specific compounds listed above in connection with classes (1) through (46). Also of particular note is a composition comprising said mixture (in fungicidally effective amount) and further comprising at least one additional surfactant selected from the group consisting of surfactants, solid diluents and liquid diluents.

Examples of other biologically active compounds or agents with which compounds of this invention can be formulated are: insecticides such as abamectin, acephate, acetamiprid, acrinathrin, amidoflumet (S-1955), avermectin, azadirachtin, azinphos-methyl, bifenthrin, bifenazate, buprofezin, carbofuran, cartap, chlorantraniliprole, chlorfenapyr, chlorfluazuron, chlorpyrifos, chlorpyrifos-methyl, chromafenozide, clothianidin, cyantraniliprole (3-bromo-1-(3-chloro-2-pyridinyl)-N-[4-cyano-2-methyl-6-[(methylamino)carbonyl]phenyl]-1H-pyrazole-5-carboxamide), cyflumetofen, cyfluthrin, beta-cyfluthrin, cyalothrin, lambda-cyalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, meperfluthrin, metaflumizone, metaldehyde, methamidophos, methidathion, methomyl, methoprene, methoxychlor, methoxyfenozide, metofluthrin, milbemycin oxime, monocrotophos, nicotine, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulfoxaflor, sulprofos, tebufenozide, teflubenzuron, tefluthrin, terbufos, tetrachlorvinphos, tetramethylfluthrin, thiacloprid, thiamethoxam, thiodicarb, thiosultap-sodium, tolfenpyrad, tralomethrin, triazamate, trichlorfon and triflumuron; and biological agents including entomopathogenic bacteria, such as Bacillus thuringiensis subsp. aizawai, Bacillus thuringiensis subsp. kurstaki, and the encapsulated delta-endotoxins of Bacillus thuringiensis (e.g., Cellcap, MPV, MPVII); entomopathogenic fungi, such as green muscardine fungus; and entomopathogenic virus including baculovirus, nucleopolyhedro virus (NPV) such as HzNPV, AfNPV; and granulosis virus (GV) such as CpGV.

Compounds of this invention and compositions thereof can be applied to plants genetically transformed to express proteins toxic to invertebrate pests (such as Bacillus thuringiensis delta-endotoxins). The effect of the exogenously applied fungicidal compounds of this invention may be synergistic with the expressed toxin proteins.

General references for agricultural protectants (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U.K., 2003 and The BioPesticide Manual, 2nd Edition, L. G. Copping, Ed., British Crop Protection Council, Farnham, Surrey, U.K., 2001.

For embodiments where one or more of these various mixing partners are used, the weight ratio of these various mixing partners (in total) to the compound of Formula 1 is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity. It will be evident that including these additional components may expand the spectrum of diseases controlled beyond the spectrum controlled by the compound of Formula 1 alone.

In certain instances, combinations of a compound of this invention with other biologically active (particularly fungicidal) compounds or agents (i.e. active ingredients) can result in a greater-than-additive (i.e. synergistic) effect. Reducing the quantity of active ingredients released in the environment while ensuring effective pest control is always desirable. When synergism of fungicidal active ingredients occurs at application rates giving agronomically satisfactory levels of fungal control, such combinations can be advantageous for reducing crop production cost and decreasing environmental load.

Also in certain instances, combinations of a compound of the invention with other biologically active compounds or agents can result in a less-than-additive (i.e. safening) further invention may safen a herbicide on crop plants or protect a beneficial insect species (e.g., insect predators, pollinators such as bees) from an insecticide.

Of note is a combination of a compound of Formula 1 with at least one other fungicidal active ingredient. Of particular note is such a combination where the other fungicidal active ingredient has different site of action from the compound of Formula 1. In certain instances, a combination with at least one other fungicidal active ingredient having a similar spectrum of control but a different site of action will be particularly advantageous for resistance management. Thus, a composition of the present invention can further comprise a biologically effective amount of at least one additional fungicidal active ingredient having a similar spectrum of control but a different site of action.

Of particular note are compositions which in addition to compound of Formula 1 include at least one compound selected from the group consisting of (1) alkylenebis(dithiocarbamate) fungicides; (2) cymoxanil; (3) phenylamide fungicides; (4) proquinazid (6-iodo-3-propyl-2-propyloxy-4(3H)-quinazolinone); (5) chlorothalonil; (6) carboxamides acting at complex II of the fungal mitochondrial respiratory electron transfer site; (7) quinoxyfen; (8) metrafenone; (9) cyflufenamid; (10) cyprodinil; (11) copper compounds; (12) phthalimide fungicides; (13) fosetyl-aluminum; (14) benzimidazole fungicides; (15) cyazofamid; (16) fluazinam; (17) iprovalicarb; (18) propamocarb; (19) validomycin; (20) dichlorophenyl dicarboximide fungicides; (21) zoxamide; (22) fluopicolide; (23) mandipropamid; (24) carboxylic acid amides acting on phospholipid biosynthesis and cell wall deposition; (25) dimethomorph; (26) non-DMI sterol biosynthesis inhibitors; (27) inhibitors of demethylase in sterol biosynthesis; (28) bc₁ complex fungicides; and salts of compounds of (1) through (28).

Further descriptions of classes of fungicidal compounds are provided below.

Sterol biosynthesis inhibitors (group (27)) control fungi by inhibiting enzymes in the sterol biosynthesis pathway. Demethylase-inhibiting fungicides have a common site of action within the fungal sterol biosynthesis pathway, involving inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides are divided between several chemical classes: azoles (including triazoles and imidazoles), pyrimidines, piperazines and pyridines. The triazoles include azaconazole, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole and uniconazole. The imidazoles include clotrimazole, econazole, imazalil, isoconazole, miconazole, oxpoconazole, prochloraz and triflumizole. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

bc₁ Complex Fungicides (group 28) have a fungicidal mode of action which inhibits the bc₁ complex in the mitochondrial respiration chain. The bc₁ complex is sometimes referred to by other names in the biochemical literature, including complex III of the electron transfer chain, and ubihydroquinone:cytochrome c oxidoreductase. This complex is uniquely identified by Enzyme Commission number EC1.10.2.2. The bc₁ complex is described in, for example, J. Biol. Chem. 1989, 264, 14543-48; Methods Enzymol. 1986, 126, 253-71; and references cited therein. Strobilurin fungicides such as azoxystrobin, dimoxystrobin, enestroburin (SYP-Z071), fluoxastrobin, kresoxim-methyl, metominostrobin, orysastrobin, picoxystrobin, pyraclostrobin, pyrametostrobin, pyraoxystrobin and trifloxystrobin are known to have this mode of action (H. Sauter et al., Angew. Chem. Int. Ed. 1999, 38, 1328-1349). Other fungicidal compounds that inhibit the bc₁ complex in the mitochondrial respiration chain include famoxadone and fenamidone.

Alkylenebis(dithiocarbamate)s (group (1)) include compounds such as mancozeb, maneb, propineb and zineb. Phenylamides (group (3)) include compounds such as metalaxyl, benalaxyl, furalaxyl and oxadixyl. Carboxamides (group (6)) include compounds such as boscalid, carboxin, fenfuram, flutolanil, furametpyr, mepronil, oxycarboxin, thifluzamide, penthiopyrad and N-[2-(1,3-dimethylbutyl)phenyl]-5-fluoro-1,3-dimethyl-1H-pyrazole-4-carboxamide (PCT Patent Publication WO 2003/010149), and are known to inhibit mitochondrial function by disrupting complex II (succinate dehydrogenase) in the respiratory electron transport chain. Copper compounds (group (11)) include compounds such as copper oxychloride, copper sulfate and copper hydroxide, including compositions such as Bordeaux mixture (tribasic copper sulfate). Phthalimides (group (12)) include compounds such as folpet and captan. Benzimidazole fungicides (group (14)) include benomyl and carbendazim. Dichlorophenyl dicarboximide fungicides (group (20)) include chlozolinate, dichlozoline, iprodione, isovaledione, myclozolin, procymidone and vinclozolin.

Non-DMI sterol biosynthesis inhibitors (group (26)) include morpholine and piperidine fungicides. The morpholines and piperidines are sterol biosynthesis inhibitors that have been shown to inhibit steps in the sterol biosynthesis pathway at a point later than the inhibitions achieved by the DMI sterol biosynthesis (group (27)). The morpholines include aldimorph, dodemorph, fenpropimorph, tridemorph and trimorphamide. The piperidines include fenpropidin.

Of further note are combinations of compounds of Formula 1 with azoxystrobin, kresoxim-methyl, trifloxystrobin, pyraclostrobin, picoxystrobin, dimoxystrobin, metominostrobin/fenominostrobin, carbendazim, chlorothalonil, quinoxyfen, metrafenone, cyflufenamid, fenpropidine, fenpropimorph, bromuconazole, cyproconazole, difenoconazole, epoxiconazole, fenbuconazole, flusilazole, hexaconazole, ipconazole, metconazole, penconazole, propiconazole, proquinazid, prothioconazole, tebuconazole, triticonazole, famoxadone, prochloraz, penthiopyrad and boscalid (nicobifen).

The following Tests demonstrate the control efficacy of compounds of this invention on specific pathogens. The pathogen control protection afforded by the compounds is not limited, however, to these species. See Index Tables A-B for compound descriptions. The following abbreviations are used in the Index Tables which follow: s is secondary, n is normal, i is iso, c is cyclo, Me is methyl, Et is ethyl, Pr is propyl, Bu is butyl and Ph is phenyl. The abbreviation “Ex.” stands for “Example” and is followed by a number indicating in which example the compound is prepared. “Cmpd No.” means compound number. In Index Tables A-B the numerical value reported in the column MS is the molecular weight of the observed molecular ion formed by addition of H⁺ (molecular weight of 1) to the molecule having the greatest isotopic abundance (i.e. M). The presence of molecular ions containing one or higher atomic weight isotopes of lower abundance (e.g., ³⁷Cl, ⁸¹Br) is not reported. The reported M+1 peaks were observed by mass spectrometry using atmospheric pressure chemical ionization (AP⁺).

INDEX TABLE A

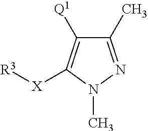

| Cmpd .No. | Q¹ | R³ | X | m.p. (° C.) | AP⁺ (M + 1) |
|---|---|---|---|---|---|
| 1 | 2,4-di-F—Ph | i-Pr | NH | | 266 |
| 2 | 2-Cl-4-F—Ph | i-Pr | CHOH | | 297 |
| 3 | 2,4-di-Cl—Ph | n-Pr | NH | | 298 |
| 4 | 2,4-di-Cl—Ph | i-Bu | NH | | 312 |
| 5 | 2,4-di-Cl—Ph | n-Bu | NH | | 312 |
| 6 | 2,4-di-F—Ph | c-hexyl | NH | | 306 |
| (Ex. 1) | | | | | |
| 7 | 2,6-di-F—Ph | EtCH(Me)CH(Me) | CHOH | | 307 |
| 8 | 2-Cl-4-F—Ph | s-Bu | CHOH | | 311 |
| 9 | 2,6-di-F—Ph | N≡CCH₂CH₂C(Me)₂ | CHOH | | 334 |
| 10 | 2,6-di-F—Ph | cyclohexen-1-yl | CHOH | | 319 |
| 11 | 2,6-di-F—Ph | i-Bu | CHOH | | 295 |
| 12 | 2,6-di-F—Ph | CH₂═CHCH₂C(Me)₂ | CHOH | | 321 |
| 13 | 2,6-di-F—Ph | CH₃CH₂CH₂CH₂CH(Et) | CHOH | | 337 |
| 14 | 2,6-di-F—Ph | n-Pr | CHOH | | 281 |
| 15 | 2,6-di-F—Ph | s-Bu | CHOH | | 295 |
| 16 | 2-Cl-6-F—Ph | c-hexyl | CHOH | | 337 |
| 17 | 2-Cl-6-F—Ph | CH₃CH═CH(Me) | CHOH | | 309 |
| 18 | 2,6-di-F—Ph | CH₃CH₂CH═CH(Me) | CHOH | | 307 |
| 19 | 2-Cl-6-F—Ph | s-Bu | CHOH | | 311 |
| 20 | 2-Cl-6-F—Ph | i-Bu | CHOH | | 311 |
| 21 | 2-Cl-6-F—Ph | n-Pr | CHOH | | 297 |
| 22 | 2,4,6-tri-F—Ph | i-Bu | O | | 299 |
| (Ex. 2) | | | | | |
| 23 | 2-Br-4-F—Ph | CH₃CH₂CH(Me)CH₂ | O | | 357 |
| 24 | 2-Cl-6-F—Ph | i-Pr | CHOH | * | * |
| (Ex. 3) | | | | | |
| 25 | 2-Cl-6-F—Ph | i-Pr | CHNMe | * | * |
| (Ex. 4) | | | | | |
| 26 | 2-Cl-6-F—Ph | i-Pr | CHSMe | * | * |
| (Ex. 5) | | | | | |
| 27 | 2-Cl-4-F—Ph | c-Pr—CH₂ | O | | 295 |
| 28 | 2-Cl-4-F—Ph | c-hexyl | O | | 323 |
| 29 | 2-Cl-4-F—Ph | i-Bu | O | | 297 |
| 30 | 2-Cl-4-F—Ph | CH₃OCH₂CH₂ | O | | 299 |
| 31 | 2-Cl-4-F—Ph | i-Pr | O | | 283 |
| 32 | 2-Cl-6-F—Ph | i-Pr | CHNH₂ | | 296 |
| 33 | 2-Cl-6-F—Ph | s-Bu | CHNH₂ | | 310 |
| 34 | 2-Cl-6-F—Ph | s-Bu | CHNHMe | | 325 |
| 35 | 2-Cl-6-F—Ph | s-Bu | CHSMe | | 341 |
| 36 | 2-Br-4-F—Ph | n-Bu | NH | | 340 |
| 37 | 2-Br-4-F—Ph | n-Bu | N(n-Bu) | | 396 |
| 38 | 2-Br-4-F—Ph | i-Pr | NH | 71-73 | |
| 39 | 2-Br-4-F—Ph | Et | NEt | 85-88 | |
| 44 | 2-Br-4-F—Ph | i-Bu | NH | 96-98 | |
| 45 | 2-Br-4-F—Ph | CH₃OCH₂CH₂ | NH | | 343 |
| 46 | 2-Br-4-F—Ph | CH₃OCH₂CH₂ | NCH₂CH₂OCH₃ | | 401 |
| 47 | 2,4,6-tri-F—Ph | n-Bu | NH | | 298 |
| 48 | 2-Br-4-F—Ph | c-Pr—CH₂ | NH | | 339 |
| 49 | 2,4,6-tri-F—Ph | i-Pr | NH | 284.5 | |
| 50 | 2,4,6-tri-F—Ph | Et | NEt | 73-76 | |
| 51 | 2,4,6-tri-F—Ph | CH₃OCH₂CH₂ | NCH₂CH₂OCH₃ | | 358 |
| 52 | 2,4,6-tri-F—Ph | c-Pr—CH₂ | NH | | 297 |
| 53 | 2,4,6-tri-F—Ph | i-Bu | NH | | 298 |
| 54 | 2,4,6-tri-F—Ph | CH₃OCH₂CH₂ | NH | | 300 |

*See synthesis example for ¹H NMR data.

INDEX TABLE B

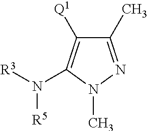

| | | | | | | |
|---|---|---|---|---|---|---|
| | | | | | m.p. | |
| IN | Cmpd. No. | Q¹ | R³ | R⁵ | (° C.) | MS |

| | | | | | |
|---|---|---|---|---|---|
| RUA41 | 40 | 2-Cl-4-F—Ph | 4-morpholinyl | 86-89 | |
| RUA59 | 41 | 2-Cl-4-F—Ph | 1-piperidinyl | | 308 |
| R0X49 | 42 | 2-Cl-4-F—Ph | 4-methyl-1-piperidinyl | 98-100 | |
| SBW15 | 43 | 2-Cl-4-F—Ph | 2-methyl-1-piperidinyl | | 322 |

### Biological Examples of the Invention

General protocol for preparing test suspensions for Tests A-G: the test compounds were first dissolved in acetone in an amount equal to 3% of the final volume and then suspended at the desired concentration (in ppm) in acetone and purified water (50/50 mix by volume) containing 250 ppm of the surfactant Trem® 014 (polyhydric alcohol esters). The resulting test suspensions were then used in Tests A-G. Each test was conducted in triplicate, and the results were averaged. Spraying a 200 ppm test suspension to the point of run-off on the test plants was the equivalent of a rate of 800 g/ha. Unless otherwise indicated, the rating values indicate a 200 ppm test suspension was used. (An asterisk “*” next to the rating value indicates a 40 ppm test suspension was used.)

### Test A

The test suspension was sprayed to the point of run-off on tomato seedlings. The following day the seedlings were inoculated with a spore suspension of Botrytis cinerea (the causal agent of tomato Botrytis) and incubated in saturated atmosphere at 20° C. for 48 h, and then moved to a growth chamber at 24° C. for 3 additional days, after which time visual disease ratings were made.

### Test B

The test suspension was sprayed to the point of run-off on tomato seedlings. The following day the seedlings were inoculated with a spore suspension of Alternaria solani (the causal agent of tomato early blight) and incubated in a saturated atmosphere at 27° C. for 48 h, and then moved to a growth chamber at 20° C. for 5 days, after which time visual disease ratings were made.

### Test C

The test suspension was sprayed to the point of run-off on wheat seedlings. The following day the seedlings were inoculated with a spore suspension of Septoria nodorum (the causal agent of Septoria glume blotch) and incubated in a saturated atmosphere at 24° C. for 48 h, and then moved to a growth chamber at 20° C. for 9 days, after which time visual disease ratings were made.

### Test D

The test suspension was sprayed to the point of run-off on wheat seedlings. The following day the seedlings were inoculated with a spore suspension of Septoria tritici (the causal agent of wheat leaf blotch) and incubated in saturated atmosphere at 24° C. for 48 h. and then the seedlings were moved to a growth chamber at 20° C. for 19 additional days, after which time visual disease ratings were made.

### Test E

Wheat seedlings were inoculated with a spore suspension of Puccinia recondita f. sp. tritici (the causal agent of wheat leaf rust) and incubated in a saturated atmosphere at 20° C. for 24 h, and then moved to a growth chamber at 20° C. for 2 days. At the end of this time the, the test suspension was sprayed to the point of run-off on the wheat seedlings, and then the seedlings were moved back to the growth chamber at 20° C. for 4 days. Upon removal, visual disease ratings were made.

### Test F

The test suspension was sprayed to the point of run-off on wheat seedlings. The following day the seedlings were inoculated with a spore suspension of Puccinia recondita f. sp. tritici (the causal agent of wheat leaf rust) and incubated in a saturated atmosphere at 20° C. for 24 h, and then moved to a growth chamber at 20° C. for 6 days, after which time visual disease ratings were made.

### Test G

The test suspension was sprayed to the point of run-off on wheat seedlings. The following day the seedlings were inoculated with a spore dust of Blumeria graminis f. sp. tritici (also known as Erysiphe graminis f. sp. tritici, the causal agent of wheat powdery mildew) and incubated in a growth chamber at 20° C. for 8 days, after which time visual disease ratings were made.

Results for Tests A-G are given in Table A. In the Table, a rating of 100 indicates 100% disease control and a rating of 0 indicates no disease control (relative to the controls). A hyphen (-) indicates no test results.

TABLE A

| | Test | Test | Test | Test | Test | Test | Test |
|---|---|---|---|---|---|---|---|
| Cmpd No. | A | B | C | D | E | F | G |
| 1 | 65 | 0 | 0 | 0 | — | 0 | 0 |
| 2 | 100 | 0 | 0 | 100 | 26 | 99 | 97 |
| 3 | 65 | 21 | 0 | 92 | 0 | 0 | 0 |
| 4 | 99 | 94 | 0 | 99 | 26 | 0 | 93 |
| 5 | 98 | 0 | 0 | 88 | 79 | 27 | 58 |
| 6 | 99 | 99 | 0 | 100 | 68 | 17 | 91 |
| 7 | 99 | 99 | 100 | 96 | 98 | 100 | 13 |
| 8 | 95 | 99 | 0 | 100 | 0 | 100 | 99 |
| 9 | 26 | 0 | 0 | 98 | 0 | 9 | 53 |
| 10 | 99 | 99 | 0 | 92 | 0 | 86 | 85 |
| 11 | 67 | 81 | 0 | 98 | 0 | 89 | 99 |
| 12 | 0 | 32 | 0 | 83 | 0 | 41 | 99 |
| 13 | 0 | 0 | 0 | 55 | 0 | 28 | 96 |
| 14 | 33 | 0 | 0 | 62 | 0 | 74 | 99 |
| 15 | 67 | 99 | 0 | 100 | 9 | 74 | 99 |
| 16 | — | 89 | 0 | 100 | 0 | 79 | 100 |
| 17 | — | 58 | 0 | 72 | 9 | 74 | 78 |
| 18 | — | 96 | 0 | 24 | 9 | 18 | 60 |
| 19 | 77* | 0* | 0* | 89* | 0* | 19* | 95* |
| 20 | 92 | 93 | 0 | 100 | 0 | 86 | 99 |
| 21 | 75 | 56 | 0 | 97 | 0 | 74 | 99 |
| 22 | 0 | — | 0 | 0 | — | 17 | 0 |
| 23 | 70 | — | 0 | 95 | — | 9 | 0 |
| 24 | 99 | — | 98 | 91 | — | 99 | 97 |
| 25 | 0 | — | 100 | 25 | — | 99 | 99 |
| 26 | 0 | — | 99 | 3 | — | 98 | 0 |
| 27 | 99 | — | 69 | 100 | — | 9 | 0 |
| 28 | 95 | — | 0 | 100 | — | 58 | 73 |
| 29 | 0 | — | 100 | 63 | — | 99 | 0 |
| 30 | 91 | — | 0 | 85 | — | 58 | 0 |
| 31 | 0 | — | 0 | 0 | — | 22 | 0 |
| 32 | 0 | — | 100 | 94 | — | 96 | 0 |
| 33 | 90 | — | 98 | 92 | — | 80 | 56 |
| 34 | 0 | — | 99 | 12 | — | 90 | 0 |
| 35 | 0 | — | 0 | — | — | 0 | 69 |
| 36 | 67 | — | 100 | 50 | — | 100 | 0 |
| 37 | 0 | — | 99 | 0 | — | 99 | 0 |
| 38 | 100 | — | 100 | 46 | — | 100 | 0 |
| 39 | 0 | — | 64 | 0 | — | 68 | 0 |
| 40 | 100 | — | 0 | 100 | — | 99 | 94 |
| 41 | 99 | — | 0 | 88 | — | 44 | 0 |
| 42 | 0 | — | 0 | 99 | — | 72 | 0 |
| 43 | 73 | — | 0 | 36 | — | 19 | 43 |
| 44 | 0 | — | 59 | 0 | — | 90 | 0 |
| 45 | 9 | — | 77 | 0 | — | 68 | 0 |
| 46 | 0 | — | 86 | 0 | — | 68 | 13 |
| 47 | 30 | — | 95 | 57 | — | 98 | 0 |
| 48 | 98 | — | 68 | 71 | — | 89 | 0 |
| 49 | 40 | — | 98 | 0 | — | 98 | 0 |
| 50 | 38 | — | 0 | 0 | — | 74 | 0 |
| 51 | 82 | — | 100 | — | — | 99 | 55 |
| 52 | 99 | — | 100 | — | — | 99 | 96 |
| 53 | 95 | — | 100 | — | — | 100 | 81 |
| 54 | 0 | — | 97 | 92 | — | 95 | 0 |

What is claimed is:

1. A compound selected from Formula 1, N-oxides and salts thereof, 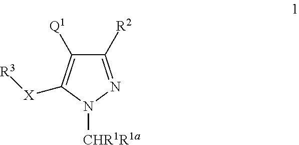
wherein
Q¹ is C₃-C₆ cycloalkyl or C₃-C₆ cycloalkenyl, wherein up to 3 carbon atoms are selected from C(═O), each optionally substituted with up to 2 substituents independently selected from halogen, cyano, nitro, hydroxy, C₁-C₃ alkyl, C₁-C₃ haloalkyl, C₁-C₃ alkoxy and C₁-C₃ haloalkoxy; or a phenyl ring or a naphthalenyl ring system, each ring or ring system optionally substituted with up to 5 substituents independently selected from R⁴; or a 5- to 6-membered fully unsaturated heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon ring members are independently selected from C(═O) and C(═S), and the sulfur atom ring members are independently selected from S(═O)ᵤ(═NR²⁸)ᵥ, each ring or ring system optionally substituted with up to 5 substituents independently selected from R⁴ on carbon atom ring members and selected from cyano, C₁-C₃ alkyl, C₂-C₃ alkenyl, C₂-C₃ alkynyl, cyclopropyl, C₂-C₃ alkoxyalkyl, C₁-C₃ alkoxy, C₂-C₃ alkylcarbonyl, C₂-C₃ alkoxycarbonyl, C₂-C₃ alkylaminoalkyl and C₃-C₄ dialkylaminoalkyl on nitrogen atom ring members;
X is O, S(═O)ₘ, NRS, CR^{6a}OR^{6b}, CR^{6a}SR^{6b} or CR^{6a}NR^{6b}R^{6c};
R¹ is H, cyano, halogen, C₁-C₆ alkyl, C₁-C₆ haloalkyl, C₂-C₆ alkenyl, C₂-C₆ alkynyl, C₃-C₆ cycloalkyl, C₂-C₆ alkoxyalkyl, C₁-C₆ alkoxy, C₁-C₆ haloalkoxy, C(═O)OR⁷ or C(═O)NR⁸R⁹;
R^{1a} is H; or
R^{1a} and R¹ are taken together with the carbon atom to which they are attached to form a cyclopropyl ring optionally substituted with up to 2 substituents independently selected from halogen and methyl;
R² is H, cyano, halogen, C₁-C₃ alkyl, C₁-C₃ haloalkyl, C₂-C₃ alkenyl, C₂-C₃ haloalkenyl, C₂-C₃ alkynyl, C₁-C₃ cyanoalkyl, C₁-C₃ hydroxyalkyl, C₁-C₃ alkoxy or C₁-C₃ alkylthio; or cyclopropyl optionally substituted with up to 2 substituents independently selected from halogen and methyl;
R³ is C₁-C₈ alkyl, C₁-C₈ haloalkyl, C₂-C₈ alkenyl, C₂-C₈ haloalkenyl, C₂-C₈ alkynyl, C₂-C₈ haloalkynyl, C₂-C₈ cyanoalkyl, C₁-C₈ hydroxyalkyl, C₁-C₈ nitroalkyl, C₃-C₈ cycloalkyl, C₃-C₈ halocycloalkyl, C₃-C₈ cycloalkenyl, C₄-C₁₀ alkylcycloalkyl, C₄-C₁₀ cycloalkylalkyl, C₄-C₁₀ halocycloalkylalkyl, C₅-C₁₀ alkylcycloalkylalkyl, C₂-C₈ alkoxyalkyl, C₂-C₈ haloalkoxyalkyl, C₄-C₁₀ cycloalkoxyalkyl, C₃-C₈ alkoxyalkoxyalkyl, C₂-C₈ alkylthioalkyl, C₂-C₈ haloalkylthioalkyl, C₂-C₈ alkylsulfinylalkyl, C₂-C₈ haloalkylsulfinylalkyl, C₂-C₈ alkylsulfonylalkyl, C₂-C₈ haloalkylsulfonylalkyl, C₃-C₈ alkylcarbonylalkyl, C₃-C₈ haloalkylcarbonylalkyl, C₃-C₈ alkoxycarbonylalkyl, C₃-C₈ haloalkoxycarbonylalkyl, C₂-C₈ alkylaminoalkyl, C₂-C₈ haloalkylaminoalkyl, C₃-C₈ dialkylaminoalkyl, C₃-C₈ alkylaminocarbonylalkyl, C₄-C₁₀ dialkylaminocarbonylalkyl, C₄-C₁₀ cycloalkylaminoalkyl or C(R^{10a}R^{10b})ₙW¹;
W¹ is a 5- to 6-membered fully unsaturated heterocyclic ring containing ring members selected from carbon atoms and 1 to 4 heteroatoms independently selected from up to 2 O, up to 2 S and up to 4 N atoms, the ring optionally substituted with up to 3 substituents independently selected from halogen, cyano, C₁-C₂ alkyl, C₁-C₂ haloalkyl, C₁-C₂ alkoxy and C₁-C₂ haloalkoxy on carbon atom ring members and cyano, C₁-C₂ alkyl and C₁-C₂ alkoxy on nitrogen atom ring members; or a 3- to 7-membered fully saturated ring containing ring members selected from carbon atoms and up to 4 heteroatoms independently selected from up to 2 O, up to 2 S and up to 4 N atoms, wherein up to 3 carbon atom ring members are independently selected from C(═O) and C(═S), the ring optionally substituted with up to 3 substituents independently selected from halogen, cyano, C₁-C₄ alkyl, C₁-C₄ haloalkyl, C₁-C₄ alkoxy and C₁-C₄ haloalkoxy on carbon atom ring members and cyano, C₁-C₄ alkyl and C₁-C₄ alkoxy on nitrogen atom ring members;
each R⁴ is independently amino, cyano, halogen, hydroxy, nitro, C₁-C₈ alkyl, C₁-C₈ haloalkyl, C₂-C₈ alkenyl, C₂-C₈ haloalkenyl, C₂-C₈ alkynyl, C₂-C₈ haloalkynyl, C₁-C₈ nitroalkyl, C₂-C₈ nitroalkenyl, C₃-C₈ cycloalkyl, C₃-C₈ halocycloalkyl, C₄-C₈ cycloalkylalkyl, C₅-C₈ cycloalkylalkenyl, C₅-C₁₂ cycloalkylalkynyl, C₄-C₈ alkylcycloalkyl, C₁-C₈ alkylthio, C₁-C₈ haloalkylthio, C₁-C₈ alkylsulfinyl, C₁-C₈ haloalkylsulfinyl, C₁-C₈ alkylsulfonyl, C₁-C₈ haloalkylsulfonyl, C₁-C₈ alkoxy, C₁-C₈ haloalkoxy, C₃-C₈ cycloalkoxy, C₁-C₈ alkylsulfonyloxy, C₁-C₄ haloalkylsulfonyloxy, C₂-C₈ alkenyloxy, C₂-C₈ haloalkenyloxy, C₂-C₈ alkynyloxy, C₃-C₈ haloalkynyloxy, C₄-C₈ cycloalkylalkoxy, C₃-C₁₂ halocycloalkoxy, C₅-C₁₂ cycloalkylalkenyloxy, C₅-C₁₂ cycloalkylalkynyloxy, C₆-C₁₂ cycloalkylcycloalkyl, C₂-C₈ alkylcarbonyloxy, C₂-C₈ alkylcarbonyl, C₁-C₈ alkylamino, C₂-C₈ dialkylamino, C₂-C₈ alkylcarbonylamino, C₃-C₁₂ trialkylsilyl, C₄-C₁₂ trialkylsilylalkoxy, C₄-C₁₂, trialkylsilylalkyl, —CH(═O), NHCH(═O), SF₅, SC≡N, —C(═S)NR^{11a}R^{11b}, —CR^{12a}═NOR^{12b}, —CR^{12c}═NNR^{11a}R^{11b}, —NR^{11a}N═CR^{13a}R^{13b}, —ON═CR^{13a}R^{13b} or —U—V-T; or
each R⁴ is independently -A(CR^{14a}R^{14b})ₙW²;
each A is independently O or a direct bond;
each W² is independently a 3- to 7-membered heterocyclic ring containing ring members selected from carbon atoms and 1 to 4 heteroatoms independently selected from up to 2 O, up to 2 S and up to 4 N atoms, wherein up to 3 carbon atom ring members are independently selected from C(═O) and C(═S), the ring optionally substituted with up to 3 substituents independently selected from R¹⁵ on carbon atom ring members and R¹⁶ on nitrogen atom ring members;
R⁵ is H, amino, C₂-C₆ alkenyl, C₃-C₆ alkynyl, C₃-C₆ cycloalkyl, —CH(═O), S(═O)ₘR¹⁷, S(═O)₂OM, C(═Z)R¹⁸ or OR¹⁹; or C₁-C₆ alkyl or C₁-C₆ haloalkyl, each optionally substituted with up to 2 substituents independently selected from R^{20a}; or
R³ and R⁵ are taken together with the nitrogen atom to which they are attached to form a 4- to 8-membered fully saturated heterocyclic ring containing ring members, in addition to the connecting nitrogen atom, selected from carbon atoms and up to 4 heteroatoms independently selected from up to 2 O, up to 2 S and up to 4 N atoms, wherein up to 3 carbon atom ring members are independently selected from C(═O) and C(═S), and the sulfur atom ring members are independently selected from S(═O)ᵤ(═NR²⁸)ᵥ, the ring optionally substituted with up to 4 substituents independently selected from halogen, cyano, C₁-C₃ alkyl, C₁-C₃ haloalkyl, C₁-C₃ alkoxy and C₁-C₃ haloalkoxy on carbon atom ring members and cyano, C₁-C₃ alkyl and C₁-C₃ alkoxy on nitrogen atom ring members;
R^{6a} is H or C₁-C₆ alkyl;
R^{6b} is H, —CH(═O), C₁-C₆ alkyl, C₂-C₆ alkenyl, C₃-C₆ alkynyl, C₁-C₆ haloalkyl, C₃-C₆ cycloalkyl, C₃-C₆ halocycloalkyl, C₂-C₆ alkoxyalkyl, C₂-C₆ cyanoalkyl, C₂-C₆ alkylcarbonyl, C₂-C₆ alkoxycarbonyl, C₂-C₆ (alkylthio)carbonyl, C₄-C₈ cycloalkylcarbonyl, C₄-C₈ cycloalkoxycarbonyl, C₄-C₈ (cycloalkylthio)carbonyl, C₂-C₆ alkoxy(thiocarbonyl) or C₄-C₈ cycloalkoxy(thiocarbonyl);
R^{6c} is H or C₁-C₄ alkyl;
R⁷ is H, C₁-C₆ alkyl or C₁-C₆ haloalkyl;
R⁸ and R⁹ are each independently H, C₁-C₆ alkyl, C₁-C₆ haloalkyl, C₃-C₈ cycloalkyl, C₄-C₈ cycloalkylalkyl or C₄-C₈ alkylcycloalkyl; or
R⁸ and R⁹ are taken together with the nitrogen atom to which they are attached to form a 4- to 7-membered nonaromatic heterocyclic ring containing ring members, in addition to the connecting ring nitrogen atom, selected from carbon atoms and up to 1 ring member selected from O, S(═O)ₘ and NR²¹;
R^{10a} is H, cyano or C₁-C₄ alkyl;
R^{10b} is H or C₁-C₄ alkyl;
each R^{11a} and R^{11b} is independently H or C₁-C₄ alkyl;
each R^{12a} is independently H, C₁-C₃ alkyl or C₁-C₃ haloalkyl;
each R^{12b} and R^{12c} is independently H, C₁-C₃ alkyl, C₁-C₃ haloalkyl, C₂-C₄ alkenyl, C₂-C₄ haloalkenyl, C₂-C₄ alkynyl, C₃-C₅ cycloalkyl, C₃-C₅ halocycloalkyl or C₄-C₈ cycloalkylalkyl;
each R^{13a} and R^{13b} is independently H, C₁-C₃ alkyl or C₁-C₃ haloalkyl;
each R^{14a} is independently H, halogen, cyano or C₁-C₄ alkyl;
each R^{14b} is independently H or C₁-C₄ alkyl;
each R¹⁵ is independently halogen, cyano, C₁-C₂ alkyl, C₁-C₂ haloalkyl, C₁-C₂ alkoxy or C₁-C₂ haloalkoxy;
each R¹⁶ is independently cyano, C₁-C₂ alkyl or C₁-C₂ alkoxy;
R¹⁷ is C₁-C₆ alkyl or C₁-C₆ haloalkyl;
R¹⁸ is C₁-C₆ alkyl, C₂-C₆ alkoxyalkyl, C₂-C₆ alkylaminoalkyl, C₂-C₆ dialkylaminoalkyl, C₁-C₆ alkoxy, C₁-C₆ alkylthio or C₂-C₆ alkylthioalkyl;
R¹⁹ is H, —CH(═O), C₃-C₆ cycloalkyl, S(═O)₂OM or C(═Z)R²²; or C₁-C₆ alkyl or C₁-C₆ haloalkyl, each optionally substituted with up to 2 substituents independently selected from R^{20b};
each R^{20a} and R^{20b} is independently cyano, C₃-C₆ cycloalkyl, C₁-C₆ alkoxy, C₁-C₆ haloalkoxy, C₁-C₆ alkylthio, C₁-C₆ alkylsulfinyl or C₁-C₆ alkylsulfonyl;
R²¹ is H, C₁-C₃ alkyl or C₂-C₃ haloalkyl;
R²² is C₁-C₆ alkyl, C₂-C₆ alkoxyalkyl, C₂-C₆ alkylaminoalkyl, C₂-C₆ dialkylaminoalkyl, C₁-C₆ alkoxy, C₁-C₆ alkylthio or C₂-C₆ alkylthioalkyl;
each U is independently O, S(═O)ₘ, NR²³ or a direct bond;
each V is independently C₁-C₆ alkylene, C₂-C₆ alkenylene, C₃-C₆ alkynylene, C₃-C₆ cycloalkylene or C₃-C₆ cycloalkenylene, wherein up to 3 carbon atoms are independently selected from C(═O), each optionally substituted with up to 5 substituents independently selected from halogen, cyano, nitro, hydroxy, C₁-C₆ alkyl, C₁-C₆ haloalkyl, C₁-C₆ alkoxy and C₁-C₆ haloalkoxy;
each T is independently cyano, NR^{24a}R^{24b}, OR²⁵ or S(═O)ₘR²⁶;
each R²³ is independently H, C₁-C₆ alkyl, C₁-C₆ haloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R^{24a} and R^{24b} is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl); or
a pair of R^{24a} and R^{24b} attached to the same nitrogen atom are taken together with the nitrogen atom to form a 3- to 6-membered heterocyclic ring, the ring optionally substituted with up to 5 substituents independently selected from R²⁷;
each R²⁵ and R²⁶ is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₄-C₈ cycloalkylcarbonyl, C₄-C₈ cycloalkoxycarbonyl, C₄-C₈ (cycloalkylthio)carbonyl, C₂-C₆ alkoxy(thiocarbonyl) or C₄-C₈ cycloalkoxy(thiocarbonyl);
each R²⁷ is independently halogen, C₁-C₆ alkyl, C₁-C₆ haloalkyl or C₁-C₆ alkoxy;
each R²⁸ is independently H, cyano, C₁-C₃ alkyl or C₁-C₃ haloalkyl;
Z is O or S;
M is K, Na or Li;
each m is independently 0, 1 or 2;
each n is 0, 1, 2 or 3; and
each u and v are independently 0, 1 or 2 in each instance of S(═O)ᵤ(═NR²⁸)ᵥ;
provided that:
(a) the sum of u and v is 0, 1 or 2; and
(b) when n is 1, 2, or 3, then W¹ is linked through a carbon atom to the remainder of Formula 1.

2. A compound of claim 1 wherein:
Q¹ is a phenyl ring substituted with 1 to 3 substituents independently selected from R⁴; or a pyridinyl, pyrimidinyl, pyrazinyl or pyridazinyl, each optionally substituted with up to 3 substituents independently selected from R⁴;
X is O, S, NR⁵, CR^{6a}OR^{6b}; CR^{6a}SR^{6b} or CR^{6a}NR^{6b}R^{6c};
R¹ is H, cyano, halogen, C₁-C₃ alkyl, C₁-C₃ haloalkyl, C₂-C₄ alkenyl, C₂-C₄ alkynyl, cyclopropyl, C₂-C₄ alkoxyalkyl, C₁-C₃ alkoxy, C₁-C₃ haloalkoxy, C(═O)OR⁷ or C(═O)NR⁸R⁹;
R^{1a} is H;
R² is Br, Cl, I or C₁-C₂ alkyl;
R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl, C₂-C₆ haloalkylthioalkyl, C₂-C₆ alkylsulfinylalkyl, C₂-C₆ alkylsulfonylalkyl, C₂-C₆ alkylaminoalkyl, C₃-C₆ is dialkylaminoalkyl or C(R^{10a}R^{10b})ₙW¹;
W¹ is a 5- to 6-membered fully unsaturated heterocyclic ring containing ring members selected from carbon atoms and 1 to 2 heteroatoms independently selected from up to 2 O, up to 2 S and up to 2 N atoms, the ring optionally substituted with up to 2 substituents independently selected from halogen, cyano, methyl, halomethyl, methoxy and halomethoxy on carbon atom ring members and cyano, methyl and methoxy on nitrogen atom ring members; or a 3- to 7-membered fully saturated ring containing ring members selected from carbon atoms and up to 2 heteroatoms independently selected from up to 2 O, up to 2 S and up to 2 N atoms, wherein up to 1 carbon atom ring member is selected from C(═O) and C(═S), the ring optionally substituted with up to 2 substituents independently selected from halogen, cyano, methyl, halomethyl, methoxy and halomethoxy on carbon atom ring members and cyano, methyl and methoxy on nitrogen atom ring members;
each R⁴ is independently cyano, halogen, methyl, halomethyl, cyclopropyl, methylthio, C₁-C₄ alkoxy, C₁-C₄ haloalkoxy, C₃-C₆ cycloalkoxy, C₁-C₄ alkylsulfonyloxy, C₁-C₄ haloalkylsulfonyloxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₂-C₆ alkylcarbonyloxy, C₃-C₉ trialkylsilyl, C₄-C₉ trialkylsilylalkoxy, C₄-C₉ trialkylsilylalkyl, —CR^{12a}═NOR^{12b}, —ON═CR^{13a}R^{13b} or —U—V-T; or each R⁴ is independently -A(CR^{14a}R^{14b})ₙW²;
W² is independently a 3- to 6-membered heterocyclic ring containing ring members selected from carbon atoms and 1 to 2 heteroatoms independently selected from up to 2 O, up to 2 S and up to 2 N atoms, the ring optionally substituted with up to 3 substituents independently selected from R¹⁵ on carbon atom ring members and R¹⁶ on nitrogen atom ring members;
R⁵ is H, cyclopropyl, —CH(═O), S(═O)ₘR¹⁷, S(═O)O₂M, C(═Z)R¹⁸, OR¹⁹, C₁-C₃ alkyl or C₁-C₃ haloalkyl; or
R³ and R⁵ are taken together with the nitrogen atom to which they are attached to form a pyrrolidinyl, piperidinyl, morpholinyl or piperazinyl, each optionally substituted with up to 3 substituents independently selected from halogen, cyano, C₁-C₂ alkyl, C₁-C₂ haloalkyl, C₁-C₂ alkoxy and C₁-C₂ haloalkoxy on carbon atom ring members and cyano, C₁-C₂ alkyl and C₁-C₂ alkoxy on the nitrogen atom ring member;
R^{6a} is H or methyl;
R^{6b} is H, —CH(═O), C₁-C₃ alkyl, C₁-C₂ haloalkyl, C₂-C₃ alkoxyalkyl, C₂-C₄ cyanoalkyl, C₂-C₄ alkylcarbonyl or C₂-C₄ alkoxycarbonyl;
R^{6c} is H or methyl;
R⁷ is H or methyl;
R⁸ is H or C₁-C₆ alkyl;
R⁹ is H, C₁-C₆ alkyl, C₁-C₆ haloalkyl or C₄-C₈ alkylcycloalkyl;
R^{10a} is H or methyl;
R^{10b} is H or methyl;
each R^{12a} is independently H, methyl or halomethyl;
each R^{12b} is independently H, methyl, halomethyl or cyclopropyl
each R^{13a} is independently H or methyl;
each R^{13b} is independently H, methyl or halomethyl;
each R^{14a} is independently H, halogen, cyano or methyl
each R^{14b} is independently H or methyl
each R¹⁵ is independently halogen, cyano, methyl, halomethyl or methoxy
each R¹⁶ is independently cyano, methyl or methoxy
R¹⁷ is methyl, ethyl, CF₃ or CF₂CF₃;
R¹⁸ is methyl, ethyl, methoxy, ethoxy, methylthio or ethylthio;
R¹⁹ is H, —CH(═O), cyclopropyl, S(═O)₂OM or C(═Z)R²²; or C₁-C₃ alkyl or C₁-C₃ haloalkyl, each optionally substituted with up to 2 substituents independently selected from R^{20b};
each R^{20b} independently cyano, C₃-C₆ cycloalkyl or C₁-C₃ alkoxy;
R²² is methyl, methoxy or methylthio;
each U is independently O or NR²³;
each V is C₂-C₄ alkylene;
each T is independently NR^{24a}R^{24b} or OR²⁵;
each R^{24a} and R^{24b} is independently H, C₁-C₆ alkyl or C₁-C₆ haloalkyl;
each R²⁵ is independently H, C₁-C₆ alkyl or C₁-C₆ haloalkyl; and
each n is independently 0 or 1.

3. A compound of claim 2 wherein
Q¹ is a phenyl ring substituted with 1 to 3 substituents independently selected from R⁴;
X is O, NH, CHOH, CHSCH₃, CHNH₂ or CHNHCH₃;
R¹ is H, halogen or C₁-C₃ alkyl;
R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl, C₂-C₆ haloalkylthioalkyl or C(R^{10a}R^{10b})ₙW¹;
each R⁴ is independently halogen, methyl, C₁-C₄ alkoxy, C₁-C₄ haloalkoxy, C₃-C₆ cycloalkoxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, C₃-C₉ trialkylsilyl, C₄-C₉ trialkylsilylalkoxy, C₄-C₉ trialkylsilylalkyl, —CR^{12a}═NOR^{12b}, —ON═CR^{13a}R^{13b} or —U—V-T; or each R⁴ is independently -A(CR^{14a}R^{14b})ₙW²;
W² is independently a 3- to 5-membered heterocyclic ring containing ring members selected from carbon atoms and 1 to 2 heteroatoms independently selected from up to 2 O and up to 2 N atoms, the ring optionally substituted with up to 2 substituents independently selected from R¹⁵ on carbon atom ring members and R¹⁶ on nitrogen atom ring members;
R^{10a} is H;
R^{10b} is H;
R^{14a} is independently H or methyl;
R^{14b} is independently H or methyl;
R¹⁵ is independently halogen, methyl, halomethyl or methoxy; and
each U is independently O or NH.

4. A compound of claim 3 wherein
R¹ is H;
R² is Br, Cl or methyl;
R³ is C₁-C₆ alkyl, C₁-C₆ haloalkyl, C₂-C₆ alkenyl, C₂-C₆ alkynyl, C₃-C₆ cycloalkyl, C₃-C₆ halocycloalkyl, C₃-C₆ cycloalkenyl, C₄-C₈ alkylcycloalkyl, C₄-C₈ cycloalkylalkyl, C₄-C₈ halocycloalkylalkyl, C₅-C₈ alkylcycloalkylalkyl, C₂-C₆ alkoxyalkyl, C₂-C₆ haloalkoxyalkyl, C₂-C₆ alkylthioalkyl or C₂-C₆ haloalkylthioalkyl; and
each R⁴ is independently halogen, methyl, C₁-C₄ alkoxy, C₁-C₄ haloalkoxy, C₃-C₆ cycloalkoxy, C₂-C₆ alkenyloxy, C₂-C₆ haloalkenyloxy, C₂-C₆ alkynyloxy, C₃-C₆ haloalkynyloxy, C₄-C₆ cycloalkylalkoxy, —CR^{12a}═NOR^{12b}, —ON═CR^{13a}R^{13b} or —U—V-T; or each R⁴ is independently -A(CR^{14a}R^{14b})ₙW².

5. A compound of claim 4 wherein
Q¹ is phenyl ring substituted with 2 to 3 substituents independently selected from R⁴;
R² is methyl;
R³ is C₁-C₆ alkyl, C₂-C₆ alkenyl, C₂-C₆ alkynyl, C₃-C₆ cycloalkyl, C₃-C₆ cycloalkenyl, C₂-C₆ alkoxyalkyl or C₂-C₆ alkylthioalkyl; and
each R⁴ is independently Br, Cl or F.

6. A compound of claim 1 which is selected from the group consisting of:
4-(2-chloro-4-fluorophenyl)-1,3-dimethyl-α-(1-methylpropyl)-1H-pyrazole-5-methanol,
4-(2-chloro-6-fluorophenyl)-α-cyclohexyl-1,3-dimethyl-1H-pyrazole-5-methanol,
4-(2-chloro-6-fluorophenyl)-1,3-dimethyl-α-(1-methylpropyl)-1H-pyrazole-5-methanol,
4-(2-chloro-4-fluorophenyl)-1,3-dimethyl-α-(1-methylethyl)-1H-pyrazole-5-methanol,
4-(2,4-dichlorophenyl)-1,3-dimethyl-N-(2-methylpropyl)-1H-pyrazol-5-amine,
N-butyl-4-(2,4-dichlorophenyl)-1,3-dimethyl-1H-pyrazol-5-amine,
4-(2-bromo-4-fluorophenyl)-1,3-dimethyl-5-(2-methylbutoxy)-1H-pyrazole,
4-(2-chloro-4-fluorophenyl)-5-(cyclopropylmethoxy)-1,3-dimethyl-1H-pyrazole,
4-(2-chloro-6-fluorophenyl)-N,1,3-trimethyl-α-(1-methylpropyl)-1H-pyrazole-5-methanamine,
4-(2-chloro-6-fluorophenyl)-1,3-dimethyl-α-(1-methylpropyl)-1H-pyrazole-5-methanamine,
4-(2-chloro-4-fluorophenyl)-5-(2-methoxyethoxy)-1,3-dimethyl-1H-pyrazole,
4-(2-chloro-4-fluorophenyl)-5-(cyclohexyloxy)-1,3-dimethyl-1H-pyrazole,
1-[4-(2-chloro-4-fluorophenyl)-1,3-dimethyl-1H-pyrazol-5-yl]-4-methylpiperidine,
4-[4-(2-chloro-4-fluorophenyl)-1,3-dimethyl-1H-pyrazol-5-yl]morpholine, and
4-(2-chloro-6-fluorophenyl)-1,3-dimethyl-5-[2-methyl-1-(methylthio)butyl]-1H-pyrazole.

7. A fungicidal composition comprising (a) a compound of claim 1; and (b) at least one other fungicide.

8. A fungicidal composition comprising (a) a compound of claim 1; and (b) at least one additional component selected from the group consisting of surfactants, solid diluents and liquid diluents.

9. A method for controlling plant diseases caused by fungal plant pathogens comprising applying to the plant or portion thereof, or to the plant seed, a fungicidally effective amount of a compound of claim 1.
